(19) United States
(12) Patent Application Publication
(10) Pub. No.: US 2024/0340385 A1
(43) Pub. Date: Oct. 10, 2024

(54) INFORMATION PROCESSING APPARATUS, METHOD, AND STORAGE MEDIUM

(71) Applicant: CANON KABUSHIKI KAISHA, Tokyo (JP)

(72) Inventors: YUKIHIRO SHINDO, Chiba (JP); YUKI NAKATANI, Chiba (JP); HIDEKI KUBO, Kanagawa (JP); OKINORI TSUCHIYA, Kanagawa (JP); TAKASHI NAKAMURA, Kanagawa (JP); TOHRU IKEDA, Kanagawa (JP); HIROMITSU YAMAGUCHI, Kanagawa (JP)

(21) Appl. No.: 18/625,038

(22) Filed: Apr. 2, 2024

(30) Foreign Application Priority Data
Apr. 5, 2023 (JP) 2023-061725
Sep. 8, 2023 (JP) 2023-146163

(51) Int. Cl. H04N 1/60; G06T 7/90; G06V 10/56

(52) U.S. Cl. CPC H04N 1/6019; G06T 7/90; G06V 10/56; H04N 1/6008; G06T 2207/10024

(57) ABSTRACT

Depending on a degree of color degeneracy of colors of an input image after absolute colorimetric mapping, an information processing apparatus synthesizes an absolute colorimetric mapping table and a perceptual mapping table. The information processing system can acquire a first color profile for performing colorimetric color conversion, a second color profile for performing perceptual color conversion, and a parameter for increasing a distance between colors mapped through gamut mapping, and generate, based on the first color profile and the second color profile and the parameter, a third color profile.

### BACKGROUND

### Field

The present disclosure generally relates to a color conversion technique.

### Description of the Related Art

In related art, color mapping is known as a color conversion technique for expressing colors by using an output device such as a printer or a display. Japanese Patent Laid-Open No. 2020-27948 discloses perceptual mapping and absolute colorimetric mapping as methods for color mapping.

However, a desired color cannot always be expressed if the color mapping disclosed in Japanese Patent Laid-Open No. 2020-27948 is used.

### SUMMARY

The present disclosure provides processing for expressing a desired color by using an output device.

An information processing apparatus according to some embodiments can include an acquisition unit configured to acquire a first color profile for performing colorimetric color conversion, a second color profile for performing perceptual color conversion, and a parameter for increasing a distance between colors mapped through gamut mapping; and a generation unit configured to, based on the first color profile and the second color profile and the parameter, generate a third color profile.

Further features of the present disclosure will become apparent from the following description of exemplary embodiments with reference to the attached drawings.

### BRIEF DESCRIPTION OF THE DRAWINGS

FIG. 1 is a diagram illustrating a configuration of a printing system.

FIG. 2 is a block diagram illustrating a hardware configuration of an information processing apparatus.

FIG. 3 is a block diagram illustrating a functional configuration of the information processing apparatus.

FIG. 4 is a diagram illustrating an example of an operation screen.

FIGS. 5A, 5B, 5C, and 5D are flowcharts illustrating flows of processing performed by the information processing apparatus.

FIG. 6 is a flowchart illustrating the flow of color profile generation processing.

FIG. 7 is a diagram illustrating access count information of grid points.

FIGS. 8A, 8B, and 8C are diagrams for explaining methods of calculating repulsive force intensity.

FIG. 9 is a flowchart illustrating the flow of color profile generation processing.

FIG. 10 is a diagram for explaining processing of distributing access grid points to hue areas.

FIG. 11 is a diagram illustrating an example of correspondences between hue components of the access grid points and the hue areas to which the access grid points are distributed.

FIG. 12 is a flowchart illustrating the flow of processing for calculating color differences.

FIG. 13 is a diagram for explaining interpolation processing of repulsive force intensity.

FIG. 14 is a flowchart illustrating the flow of color profile generation processing.

FIG. 15 is a diagram illustrating an example of gamut mapping.

FIG. 16 is a diagram illustrating an example of a grid-point access distribution of an input image in relation to a static extension rate.

FIG. 17 is a diagram illustrating an example of gamut mapping.

FIG. 18 is a flowchart illustrating the flow of color profile generation processing.

FIG. 19 is a diagram illustrating an example of gamut mapping.

FIG. 20 is a flowchart illustrating the flow of color profile generation processing.

FIG. 21 is a diagram for explaining a method for determination of gray block grid points.

FIG. 22A is a diagram for explaining a method of projecting a cube in a color space onto a hue plane.

FIG. 22B is another diagram for explaining a method of projecting a cube in a color space onto a hue plane.

FIG. 23A is a diagram for explaining a method of dividing a hue block in a brightness radial direction.

FIG. 23B is another diagram for explaining a method of dividing a hue block in a brightness radial direction.

FIG. 23C is another diagram for explaining a method of dividing a hue block in a brightness radial direction.

FIG. 24A is a diagram for explaining an interpolation method using block control points.

FIG. 24B is another diagram for explaining an interpolation method using block control points.

FIG. 25 is a diagram for explaining a method of calculating a dynamic extension rate.

FIG. 26 is a diagram for explaining how objects are treated in color profile generation.

FIG. 27 is a diagram for explaining a relationship between target colors and mapping destinations.

FIG. 28 is a flowchart illustrating the flow of color profile generation processing.

FIG. 29 is a diagram illustrating an example of a data format of target color data.

FIG. 30 is a diagram for explaining within/not-within color-gamut determination using a tetrahedron.

FIG. 31 is a diagram for explaining data corresponding to a surface of an output color gamut.

FIG. 32 is a diagram for explaining generation processing of surface L*a*b* data.

FIG. 33 is a diagram for explaining color-difference formulae.

FIG. 34 is a diagram illustrating an example of a parameter table.

FIGS. 35A, 35B, and 35C are diagrams illustrating features of a mapping table.

FIGS. 36A and 36B are diagrams illustrating measurement of gonio-photometric reflection characteristics.

FIG. 37 is a diagram for explaining light received by an eye of an observer from a printed matter.

FIG. 38 is a diagram illustrating measurement of spectral reflectivity.

FIG. 39 is a diagram illustrating an example of a spectrum.

FIG. 40 is a diagram illustrating a difference between an appearance spectrum and a diffused reflection spectrum.

FIG. 41 is a diagram illustrating a relationship between an illumination ratio and a spectrum shift amount.

FIGS. 42A and 42B are block diagrams illustrating functional configurations of an information processing apparatus.

FIGS. 43 and 44 are flowcharts illustrating the flow of color profile generation processing.

FIGS. 45 and 46 are diagrams illustrating examples of gamut mapping.

FIGS. 47A, 47B, and 47C are diagrams illustrating an example of gamut mapping.

FIGS. 48 and 49 are flowcharts illustrating the flow of color profile generation processing.

FIGS. 50A and 50B are diagrams for explaining control for reflecting a tolerable amount of color loss to a dynamic extension rate.

FIGS. 51 and 52 are flowcharts illustrating the flow of color profile generation processing.

### DESCRIPTION OF THE EMBODIMENTS

We often see that a unified design is applied to a plurality of different items, etc. such as advertising media, sales-promotional goods, and commercial products for the purpose of projecting a conceptual image of a brand, etc. Such a plurality of commercial goods/media having the same design is called “brand collateral”. In creation of brand collateral, in some instances printing is performed on various kinds of medium using a plurality of types of printers. In such instances, one of important factors of quality is to ensure a match in color impression, irrespective of differences in printers and media.

When it is attempted to match colors expressed by a plurality of printers having different gamuts of colors, it is possible to reproduce a color that is a colorimetric match among a plurality of output devices, if targeted to be within a narrowly limited color gamut that is a logical product (AND) of color gamuts of all of the output devices. However, in such a case, in an output device having a wide color gamut, it is inevitable that vivid colors that are otherwise reproducible have to be restricted, resulting in outputting an image of lower quality.

On the other hand, if, for example, the target color is within a wider limited color gamut that is a logical sum (OR) of the color gamuts of all of the output devices, there is a need to perform color expression with replacement of not-within-gamut colors with within-gamut colors of each output device by performing color mapping. In view of the above necessity, related art receives a digital original document described in a predetermined color space and performs mapping into a color gamut reproducible by a printer for each color in the color space.

When absolute colorimetric mapping mentioned earlier is performed, it is possible to achieve a colorimetric match between a color within the color gamut of each output device and the target color. However, since a color that is not within the color gamut of the output device clings to the surface of the color gamut of the output device, so-called color loss occurs, which might cause a decrease in gradation property and/or a decrease in color discriminability. If a color that is discriminable by a certain output device is not discriminable by another output device, it is difficult to recognize two designs as identical one.

If perceptual mapping is performed, although gradation property and color discriminability are guaranteed to some extent, the degree of colorimetric matching with the target color decreases. Moreover, since the degree of color compression is relevant also to the size of the color gamut of the output device, the way of deviation from the target color is not uniform among the output devices. This also makes it difficult to recognize two designs as identical one.

For a solution, processing will be described in embodiments below for performing printing with an importance placed on an impression match in colors by means of a plurality of different printing systems for pieces of content having the same design. Each embodiment will be described below with reference to the drawings. Note that the embodiments described below shall not be construed to necessarily limit the present disclosure. Combining all of features described in each embodiment is not necessarily indispensable to the solution proposed in the present disclosure. Prior to description of each embodiment, a definition of each term used in the embodiments below is given first here.

### <Color Gamut>

“Color gamut” means a range of colors reproducible in a given color space. Another name for this term includes “color reproduction range”, “color reproduction region”, and “gamut”. A gamut volume is known as an index that indicates wideness of a color gamut. A gamut volume is a three-dimensional volume in a given color space. For example, in some instances, a particular color gamut is defined by 729 points in a CIE-L*a*b* space, and other points are obtained by using a known interpolation calculation such as tetrahedral interpolation or cubic interpolation. In a case where chromaticity points constituting a color gamut are discrete as in such instances, a result of cumulative calculation of a volume in a CIE-L*a*b* space of a tetrahedron, a cube, or the like constituting the color gamut can be used as the gamut volume, correspondingly to a method of interpolation calculation.

The color gamut in the embodiments described below is assumed to be a color gamut in a CIE-L*a*b* space, but is not limited to a color gamut in any particular color space. The gamut volume in the embodiments described below represents a volume in a case of cumulative calculation in a CIE-L*a*b* space, based on the premise of tetrahedral interpolation; however, it may be a volume in a color space derived using any other method.

### <Gamut Mapping>

“Gamut mapping” is processing of converting a color in a certain color gamut into a color in another color gamut. For example, it means mapping a color in an input color gamut into a color in an output color gamut. General examples of gamut mapping are: “Perceptual”, “Saturation”, and “Colorimetric”, etc. of an international color consortium (ICC) profile. Gamut-mapping processing may be conversion performed at one time by using a 3DLUT (three-dimensional lookup table) or a conversion formula, etc. or may be mapping conversion performed after applying color-space conversion to a standard color space. For example, in a case where an input color space is a sRGB space, color values in the sRGB space are converted into color values in a CIE-L*a*b* color space. The color values are mapped into an output color gamut in the CIE-L*a*b* color space. Conversion may be performed from RGB (red, green, blue) values in an input color space into RGB values or CMYK (cyan, magenta, yellow, black) values unique to the output device.

### Original Document Data>

“Original document data” means the entire input digital data of the target of processing, and is also called “content”. Original document data is made up of a single page or a plurality of pages. Each page may be stored as image data or may be expressed as a drawing command. In a case where each page is expressed as a drawing command, processing may be performed after conversion into image data by performing rendering based on a drawing command. Instead of image data after rendering, processing may be performed on color information included in a drawing command. Image data is configured by arranging a plurality of pixels in a two-dimensional layout. Each pixel stores information that represents a color in a color space. Examples of the information that represents a color is an RGB value, a CMYK value, a K value, a CIE-L*a*b* (CIELAB color space) value, an LCH (lightness, chroma, hue) value, an HSV (hue, saturation, lightness) value, an HLS (hue, lightness, saturation) value, and the like.

### <Color Degeneracy>

In the embodiments described below, when gamut mapping is performed on given two colors, a phenomenon that a distance between the colors after the mapping is shorter than a distance between the colors before the mapping in a predetermined color space will be referred to as “color degeneracy”. Specifically, suppose that a digital original document contains a color A and a color B and that, as a result of mapping into a color gamut of a printer, the color A is converted into a color C, and the color B is converted into a color D. In this case, a phenomenon that the distance between the colors C and D is shorter than the distance between the colors A and B is called color degeneracy. When color degeneracy occurs, colors supposed to be recognized as different colors on a digital original document could be recognized as the same color when printed out. For example, in a graph used in an explanatory material, it is possible to make different items recognizable as different items by using different colors for painting them. If color degeneracy occurs, since different colors could be recognized as the same color, there is a possibility that the different items on the graph might be misunderstood as the same item. A predetermined color space for calculating a distance between colors may be any color space. Examples are: an sRGB color space, an AdobeRGB color space, a CIE-L*a*b* color space, a CIE-LUV (brightness, color) color space, an XYZ color specification system color space, an xyY color specification system color space, an LCH color space, an HSV color space, an HLS color space, and the like.

### First Embodiment

### Printing System

In order to perform printing with an importance placed on an impression match in colors by means of a plurality of different printing systems (applications, printers, media) for pieces of content having the same design, there is a need to perform appropriate color settings and appropriate printer color adjustments for each of printer conditions whose color gamuts differ from one to another. That is, expert knowledge and skills about colors and each printing system are normally required. Moreover, when pieces of content having the same design are to be printed onto a plurality of commercial materials, in general, a plurality of print service providers is used because it is difficult for a single print service provider to get all print jobs done alone. In this case, printing is performed after color adjustments that are based on quality control of each print service provider are made and, therefore, it is difficult for a print client to request for printing with an importance placed on a color match. In view of the above circumstances, the present embodiment provides a printing system capable of accepting print instructions with an importance placed on an impression match in colors, without requiring expert knowledge and skills about each individual printing system.

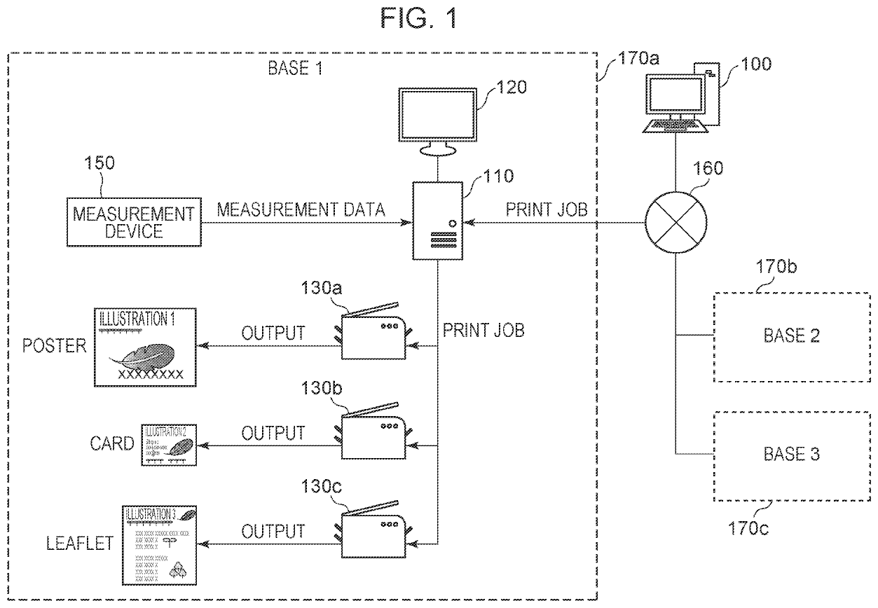

FIG. 1 is a diagram illustrating an overall configuration of a printing system according to the present embodiment. In the printing system according to the present embodiment, a job issuance apparatus 100, a system located at a base 170a, a system located at a base 170b, and a system located at a base 170c are interconnected via a network 160. The system located at the base 170a includes a control apparatus 110, a monitor 120, a printer 130a, a printer 130b, and a printer 130c. Each of the system located at the base 170b and the system located at the base 170c also includes a control apparatus, a monitor, and printers. A relationship between the system located at the base 170a and the job issuance apparatus 100 will be described as an example below.

The job issuance apparatus 100 is connected to the control apparatus 110 via the network 160 such that communication can be performed interactively therebetween. The job issuance apparatus 100 performs color settings such as setting a target color, setting of placing an importance on an impression match in colors, and the like, for one or more pieces of content or one or more jobs, and issues a job to the control apparatus 110. The job issuance apparatus 100 is capable of generating various jobs such as a job for design creation by an application, a job for original manuscript submission to a print service provider, a job for monitor color calibration to a print service provider, a print job to a printer, and the like. The generation of a job described below is assumed to be the generation of a print job to a printer, unless otherwise described.

In a case where a mode for placing an importance on an impression match in colors is set, the control apparatus 110 generates an importance-on-color-impression-match color profile from any two or more kinds of information among content, target color, and printer profile corresponding to the received job information. The control apparatus 110 puts the generated importance-on-color-impression-match profile into the content or the job information. The control apparatus 110 is configured to be able to communicate with the printers 130a to 130c in the system located at the base 170a interactively via a communication network such as an intranet, acquires device information of each printer, and gives content print instructions to each printer. The device information of the printer includes sheet information, printer profile information, and the like. The control apparatus 110 is connected to a measurement device 150 in the system located at the base 170a such that communication can be performed interactively therebetween via a universal serial bus (USB) cable or a communication network such as an intranet, controls the measurement device, and acquires measurement data.

The monitor 120 is connected to the control apparatus 110 and displays various user interface screens (UI screens). Based on the print job received from the control apparatus 110, the printer 130a to 130c prints a color image on a sheet by using, for example, an electrophotographic process technology. The printer 130a to 130c may be a monochrome printer, or a printer that is based on any other kind of image forming technologies such as ink-jet printing. The printer 130a to 130c may be a multifunction peripheral having a copy function and a FAX function in addition to a print function.

The measurement device 150 is a spectrometer configured to measure a color value of a target object on the basis of reflectance or transmittance of visible light having a wavelength range from 400 nm (nanometer) to 700 nm or so. The measurement device 150 is, for example, provided at each base individually, and obtains measurement data by converting a wavelength obtained for each patch of a chart outputted from the printer 130a to 130c into a value in a CIE-L*a*b* color space, an XYZ color space, or the like. The network 160 is, for example, a local area network (LAN), the Internet, an intranet, or the like. The network 160 may be a wired network or a wireless network. The bases 170a to 170c correspond to the locations, etc. of a printing company where the printers are installed. For example, the base 170a is a print base at Tokyo, the base 170b is a print base at Osaka, and the base 170c is a print base at Fukuoka.

Note that the configuration of the printing system illustrated in FIG. 1 is just an example. The number of bases, the system configuration at each base, and the like may be modified as needed. For example, in a case where the job issuance apparatus 100 is installed at each of the bases 170a to 170c individually, the job issuance apparatus 100 is connected directly to the printers and the measurement device, and the job issuance apparatus 100 generates an importance-on-color-impression-match profile directly, not via the control apparatus 110. Then, print instructions may be given to the printer, with the generated profile included in a job.

The job issuance apparatus 100 may be configured to issue a job to the control apparatus 110, and the control apparatus 110 may be configured to, upon receiving the job, perform color settings such as setting a target color, setting of placing an importance on an impression match in colors, and the like for the job. In a case where the control apparatus 110 receiving the job is configured to perform color setting, the color setting can be performed at least in accordance with printers and media or printer types and media types. In a case where the control apparatus 110 receiving the job includes non-illustrated printer drivers corresponding respectively to the printers 130a to 130c, the color setting may be performed for each of the printer drivers individually. An information processing apparatus that has both functions of the job issuance apparatus 100 and functions of the control apparatus 110 may be provided at each of the bases individually.

As described above, the printing system according to the present embodiment is capable of applying color settings such as a target color, placing an importance on an impression match in colors, and the like to jobs for design creation, original manuscript submission, printing, monitor color calibration, and the like. Then, the control apparatus 110 having received the importance-on-color-impression-match setting generates the importance-on-color-impression-match profile and puts the generated profile into the job. By this means, when the base is equipped with the control apparatus configured to receive the importance-on-color-impression-match setting and generate the importance-on-color-impression-match profile, the print client is able to request for printing with an importance placed on an impression match in colors, without being influenced by each individual printing system and/or each individual print service provider.

### Hardware Configuration of Job Issuance Apparatus and Control Apparatus

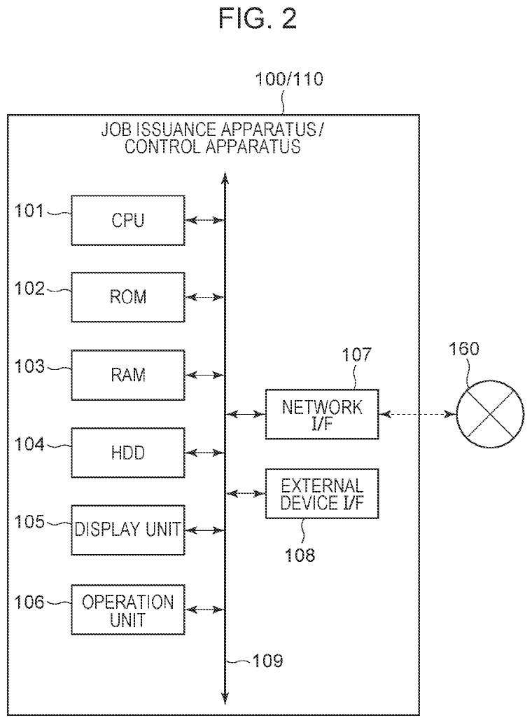

Both the job issuance apparatus 100 and the control apparatus 110 described above are information processing apparatuses, and are embodied by, for example, a general-purpose notebook-type or desktop-type personal computer, a server terminal, a tablet terminal, or the like, or combinations thereof. FIG. 2 is a block diagram illustrating a hardware configuration of the job issuance apparatus 100, and of the control apparatus 110. Each of the job issuance apparatus 100 and the control apparatus 110 includes a central processing unit (CPU) 101, a read-only memory (ROM) 102, a random access memory (RAM) 103, a hard disk drive (HDD) 104, a display unit 105, an operation unit 106, a network I/F 107, and an external device I/F 108. The components 101 to 108 illustrated in FIG. 2 are connected to one another via a system bus 109.

The CPU 101 is an arithmetic processor configured to control the entire apparatus. The CPU 101 can include one or more processors, circuitry, or combinations thereof and can perform each image processing to be described later and various kinds of processing on the basis of programs stored in the ROM 102. The ROM 102 is a read-only memory, and stores a boot program, processing programs, character data, character code information, and the like. The RAM 103 is a random access memory, and is used as a work memory when the CPU 101 runs various kinds of program. In addition, the RAM 103 is used as a data storage area for image files, setting information, and the like received from the network interface (I/F) 107. The HDD 104 is used for storing the results of arithmetic processing executed by the CPU 101, various kinds of program, information files, setting information, device information of printers, and the like. The display unit 105 is, for example, a liquid crystal display or the like, and displays UI screens for making various settings, for confirmation of apparatus status, and the like. The operation unit 106 includes a keyboard, a pointing device, and the like, and is used by the user for inputting various setting values, resetting the settings, and the like. The network I/F 107 is an interface configured to connect the apparatus to the network 160. Each of the job issuance apparatus 100 and the control apparatus 110 is capable of transmitting various kinds of information to, and receiving various kinds of information from, external devices via the network I/F 107. The external device I/F 108 is an interface for connection to external devices such as, for example, the printers 130a to 130c and the measurement device 150 via a communication bus such as, for example, USB (universal Serial Bus). The hardware configuration of the job issuance apparatus 100 and the control apparatus 110 is not limited to the above example. For example, the HDD 104, the display unit 105, the operation unit 106, and the like may be embodied as components of another apparatus connected to the job issuance apparatus 100 and the control apparatus 110.

### Functional Configuration of Job Issuance Apparatus and Control Apparatus

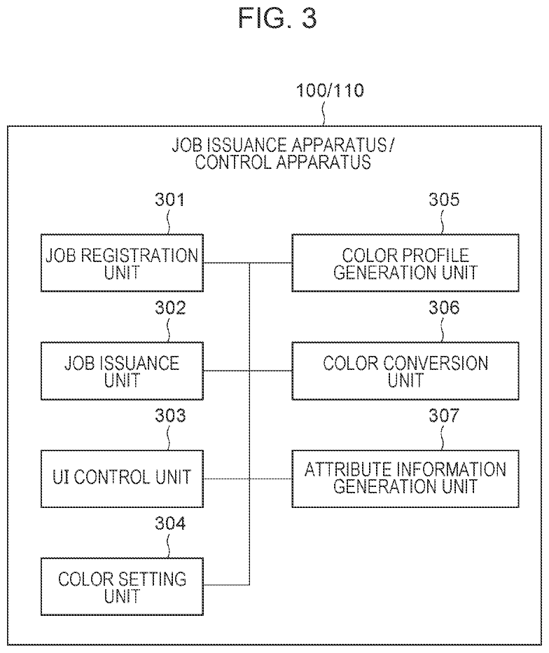

Next, a functional configuration of the job issuance apparatus 100 and the control apparatus 110 will now be described. FIG. 3 is a block diagram illustrating a functional configuration of the job issuance apparatus 100 and the control apparatus 110 according to the present embodiment. The job issuance apparatus 100 and the control apparatus 110 include a job registration unit 301, a job issuance unit 302, a UI control unit 303, a color setting unit 304, a color profile generation unit 305, a color conversion unit 306, and an attribute information generation unit 307. Each of these functional units is embodied by running a predetermined program by the CPU 101. Each of these functional units will now be described.

Note that it is sufficient as long as each of these functional units is included in at least one of the job issuance apparatus 100 and the control apparatus 110; each of the job issuance apparatus 100 and the control apparatus 110 does not have to include all of these functional units.

The job registration unit 301, when registering a print job or a monitor color calibration job, performs job settings of information for printing or monitor color calibration such as print content, a printer, a medium, and the like by means of the UI control unit 303, and adds the job. The job registration unit 301, when registering a job for design creation by an application, performs job settings of information for design creation, and the like. The job registration unit 301, when registering a job for original manuscript submission to a print service provider, performs job settings of information for placing an order to the print service provider such as print content, a medium type, and the like. The job issuance unit 302 receives a selection of one or more jobs and a job start instruction via the UI control unit 303, and performs job issuance to the control apparatus 110. The UI control unit 303 performs display control of UI screens for confirming the status of each device in the printing system, for inputting and selecting various settings, and for receiving a start instruction of various kinds of processing, and the like. A detailed description of the UI screens displayed will be given later.

The color setting unit 304 receives a selection of one or more jobs and a color setting instruction via the UI control unit 303, and adds a color setting set such as settings of a target color and of placing an importance on an impression match in colors, and the like for the selected job(s). A detailed description of the color setting set will be given later. Based on two or more kinds of information among content, target color, and printer profile, the color profile generation unit 305 generates an importance-on-color-impression-match color profile. A detailed description of color profile generation processing will be given later.

The color conversion unit 306 performs gamut mapping described above. In accordance with color intent settings to be described later, it is possible to change a method of color-gamut compression. In the present embodiment, in a case where a color profile generated by the color profile generation unit 305 exists, color conversion is performed using the generated color profile and the printer profile of the printer 130a.

The color conversion unit 306 may be called up more than once to execute color conversion more than once. For example, if input data contained in the content is data of various numbers of dimensions such as Gray data, RGB data, CMYK data, and the like, processing performed by the color profile generation unit 305 will become complex in accordance with the numbers of dimensions. To avoid this complexity, for the purpose of rendering the number of dimensions of the input data into the color profile generation unit 305 common, the color conversion unit 306 may perform pre-processing for conversion of the input data contained in the content into a work color space (for example, an AdobeRGB space) in accordance with the color setting.

In the present embodiment, it is assumed that the input data is rendered common into a three-dimensional work RGB space. For example, if a Japan Color 2011 color space has been designated for a color space of CMYK data in color setting, conversion from a CMYK (Japan Color 2011) space into a work RGB space (AdobeRGB space) is performed using a known profile.

The attribute information generation unit 307 acquires PDL (Page Description Language) data contained in the received content, and generates object-by-object or pixel-by-pixel attribute information. The attribute information is, for example, information that indicates a data type (Gray, RGB, K, CMYK) and object attribute (Graphics (figure), Text (characters), Image (photo)). Another kind of the attribute information is information that indicates an exception (logo (an object in which a profile for designating exception processing to be described later is embedded)). In the present embodiment, it is assumed that color setting corresponding to attribute information can be performed at the color setting unit 304. In accordance with color setting configured on an attribute-information-by-attribute-information basis, the color profile generation unit 305 generates an importance-on-color-impression-match color profile, and the color conversion unit 306 performs color conversion while referring to the generated color profile. Though processing using attribute information will be described in the present embodiment, the processing may be performed without using attribute information.

### Operation Screen of Job Management Application

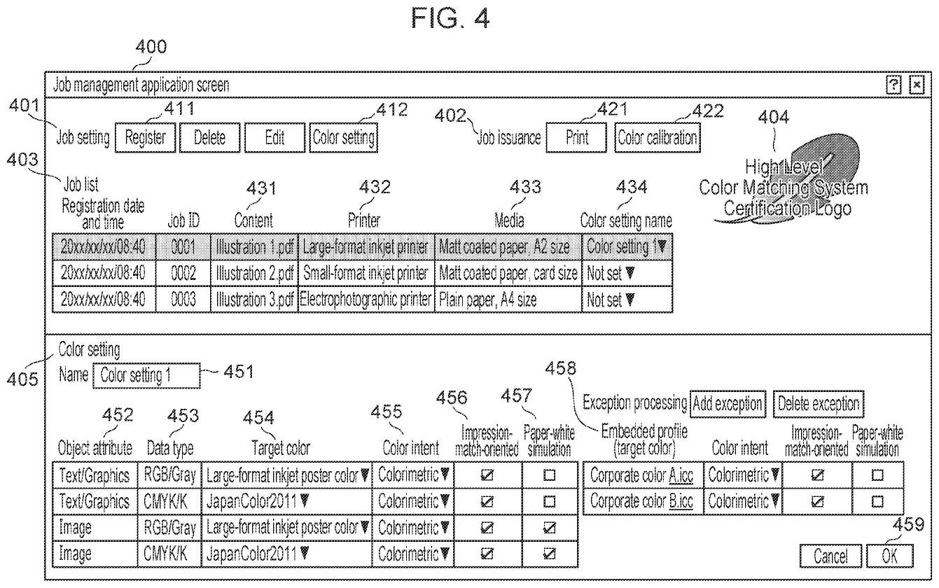

FIG. 4 is a diagram illustrating an example of an operation screen displayed on the display unit 105 by the job issuance apparatus 100 according to a first embodiment. An operation screen 400 includes a job setting area 401, a job issuance area 402, a job list area 403, and a certification logo area 404 indicating that an importance-on-color-impression-match printing system is supported. FIG. 4 illustrates a state in which a job ID: 0001 is selected in the job list area 403. For the job ID: 0001 that is currently in a selected state in the job list area 403, a color setting set “color setting 1” is set in a color setting name area 434, and detailed information on the color setting set “color setting 1” is displayed in a color setting area 405. In the present embodiment, the certification logo area 404 is included in a non-illustrated application screen for making a request for original manuscript submission acceptance or color calibration to a print service provider and in an application screen for managing a print job as in FIG. 4. The certification logo area 404 may be displayed automatically by performing communication between the job issuance apparatus 100 and the control apparatus 110 and thereby sharing information indicating that either one of the job issuance apparatus 100 and the control apparatus 110 includes the color profile generation unit 305. The print client who sees display of the certification logo area 404 can know that an importance-on-color-impression-match printing system is supported by the print service provider and the printing system and make a request for original manuscript submission acceptance, printing, or color calibration.

The job setting area 401 includes a register button 411, a delete button, an edit button, and a color setting button 412. Job addition, deletion, editing, and color setting to the job list area 403 can be instructed therein. Upon receiving a pressing of the register button 411 via the operation unit 106, the display unit 105 displays a non-illustrated job registration screen. The operation unit 106 receives settings that include content 431 that is the target of printing, a printer 432 that is available for use on an importance-on-color-impression-match printing system, and a medium 433 that is available for use on the printer 432 to add a job to the job list area 403. When a selection of a job displayed at the job list area 403 and a pressing of the color setting button 412 are received via the operation unit 106, the color setting area 405 for the job that is currently in a selected state is displayed. When a pressing of an OK button 459 is received via the operation unit 106, color setting is performed for the job, and display at the color setting name area 434 is updated. With regard to the color setting for the job, the color setting name area 434 of each job in the job list area 403 is configured as a list box, and the user is also able to select one from preset color settings.

The job issuance area 402 includes a print button 421 and a color calibration button 422. When a selection of a job displayed at the job list area 403 and a pressing of a job issuance button are received via the operation unit 106, a print job or a monitor color calibration job for the job that is currently in a selected state is issued to the control apparatus 110. The color setting area 405 includes a color setting name text box 451, an object attribute area 452, a data type area 453, a target color area 454, a color intent area 455, an importance-on-color-impression-match setting area 456, and a paper-white simulation area 457. The color setting area 405 further includes an exception processing addition button and an exception processing deletion button, and includes the color intent area 455, the importance-on-color-impression-match setting area 456, and the paper-white simulation area 457 for an exception embedded profile area 458. Setting in the object attribute area 452 and the data type area 453 is just an example, and this does not imply any limitation. The object attribute area 452 may be configured such that Text and Graphics are settable individually. The data type area 453 may be configured such that Gray and K are settable individually.

In the color setting name text box 451, a color setting with a new name can be registered for a job whose color setting name has not been set yet in the job list area 403. When a pressing of the OK button 459 is received via the operation unit 106 in a state in which a new name has been inputted for the job whose color setting has not been set yet, the color setting with the new name is stored into the HDD 104 and is made viewable in the list box of the color setting name area 434. An input color profile can be designated at the target color area 454. The operation unit 106 is operable to designate color profile generation processing of the color profile generation unit 305 and a target color in gamut mapping of the color conversion unit 306 by selection out of a list box at the target color area 454. For RGB data and Gray data, an RGB printer profile provided by the printers 130a to 130c and the like can be designated, besides a standard sRGB profile and a standard AdobeRGB profile. For CMYK data and K data, Japan Color 2011 used in a print standard certification system, a CMYK printer profile provided by the printers 130a to 130c, and the like can be designated.

The color intent area 455 is an area for setting a compression method of gamut mapping for an output profile (printer profile) used in the color conversion unit 306.

At the color intent area 455, as rendering intent, “Perceptual”, “Saturation”, and “Colorimetric” can be designated. At the importance-on-color-impression-match setting area 456, it is possible to individually set whether or not to place an importance on an impression match in colors, according to attribute information of the object attribute area 452, the data type area 453, the exception embedded profile area 458, and the like. As will be described in detail later, it is possible to switch whether or not to perform generation of an importance-on-color-impression-match color profile by the color profile generation unit 305.

At the paper-white simulation area 457, it is possible to switch whether to output a simulated color of “paper white” designated at the target color area 454 for an input white signal in an importance-on-color-impression-match color profile or to perform a colorless output (white of the sheet used). Instead of controlling a 3DLUT of an importance-on-color-impression-match color profile, at the color conversion unit 306, switching of a paper-white simulation by a known method may be performed using White Point Tag of an ICC profile.

Next, setting of exception processing will now be described. An embedded profile added by pressing the exception processing addition button is a kind of target color. For each exception-added embedded profile (target color), it is possible to perform setting of color intent, setting of placing an importance on an impression match in colors, and setting of a paper-white simulation.

As described above, on the operation screen illustrated in FIG. 4, designation of a target color and setting of placing an importance on an impression match in colors can be performed according to the object attribute area 452 and the data type area 453. In addition, setting of placing an importance on an impression match in colors can be performed for the embedded profile of exception processing. Some content contains an RGB image designed for a Web, a CMYK image designed for printing, an RGB image that is a raw image captured using a camera, a CMYK image adjusted by performing CMYK conversion with printing in mind, a corporate logo, or the like. Providing the above-described operation screen makes it possible to deal with differences in target color demanded by the print client for each image.

The importance-on-color-impression-match setting area 456 may be omitted from the operation screen. In a case where the control apparatus 110 includes the color profile generation unit 305, control may be performed such that an importance-on-color-impression-match color profile is generated when Colorimetric is designated at the color intent area 455.

As described above, on the operation screen illustrated in FIG. 4, paper-white simulation setting can be performed individually for the object attribute area 452, the data type area 453, and the exception embedded profile area 458. In a case where the media of the printers 130a to 130c differ, if printing is performed while simulating paper white of a target color for a graphic design or a corporate logo, it could happen that a difference arises between simulated paper white and actual paper white, resulting in a change in design. In a case of a photo image, simulating paper white of a target color brings a gray balance closer irrespective of whether the paper is warm-color paper or cold-color paper and, therefore, it is possible to achieve a match in color impression. Providing the above-described operation screen makes it possible to perform paper-white simulation setting individually and thus possible to deal with various situations such as those described above.

### Flow of Processing Performed by Job Issuance Apparatus and Control Apparatus

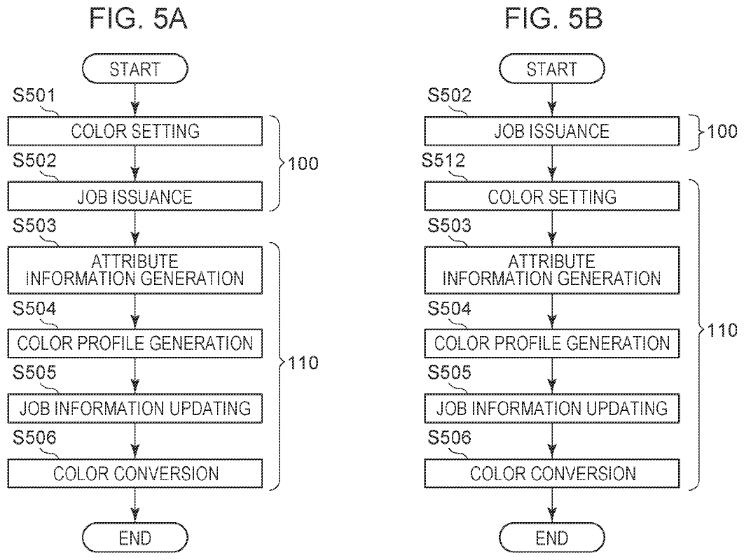

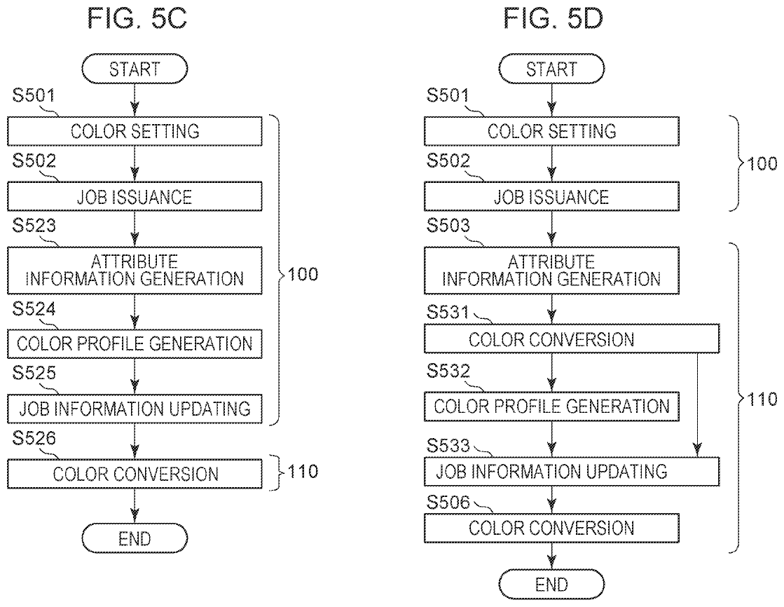

FIGS. 5A to 5D are flowcharts for explaining the flow of importance-on-color-impression-match processing according to the present embodiment. The processing illustrated in FIGS. 5A to 5D is implemented by reading a program out of the ROM 102 into the RAM 103 and running the read program by the CPU 101.

FIG. 5A illustrates the flow of processing in a first case. In the first case, the job issuance apparatus 100 that is at a location different from the locations of the bases 170a to 170c performs color setting including setting of placing an importance on an impression match in colors and performs job issuance. Upon receiving them, the control apparatus 110 in the base 170a to 170c generates an importance-on-color-impression-match color profile and performs color conversion. In the first case, upon receiving an importance-on-color-impression-match designation by the print client who is not located at the base, it is possible to perform printing at the base, with an importance placed on an impression match in colors, regardless of which one among the bases is designated.

A specific flow of processing illustrated in FIG. 5A will now be described. In the description below, a prefix S is affixed to the reference numeral of each step (process). In S501, the UI control unit 303 of the job issuance apparatus 100 displays the operation screen 400 on the display unit 105. The color setting unit 304 of the job issuance apparatus 100 receives color setting of the color setting area 405 for the job that is currently in a selected state via the operation unit 106.

In S502, the job issuance unit 302 of the job issuance apparatus 100 receives a pressing of the print button 421 via the operation unit 106 and issues a print job for the job that is currently in a selected state to the control apparatus 110. In S503, the attribute information generation unit 307 of the control apparatus 110 acquires PDL data contained in the content of the job information received from the job issuance apparatus 100 and generates object-by-object or pixel-by-pixel attribute information. The generated attribute information is stored into the RAM 103 so that it can be looked up in steps described below.

In S504, in a case where setting of placing an importance on an impression match in colors is included in the job information received from the job issuance apparatus 100, the color profile generation unit 305 of the control apparatus 110 generates a color profile under conditions of attribute information with an importance placed on an impression match in colors. Based on two or more kinds of information among content, target color, and printer profile, the color profile generation unit 305 generates an importance-on-color-impression-match color profile. In a case where placing an importance on an impression match in colors is set according to the object attribute area 452, the data type area 453, and the exception embedded profile area 458, the color profile generation unit 305 generates an importance-on-color-impression-match color profile for each condition. In a case where it is set to perform a paper-white simulation at the paper-white simulation area 457, the color profile generation unit 305 generates an importance-on-color-impression-match color profile corresponding to the setting. A detailed description of the processing for generating an importance-on-color-impression-match color profile will be given later.

In S505, the color profile generation unit 305 of the control apparatus 110 updates the job information by using the generated importance-on-color-impression-match color profile. Specifically, the color profile generation unit 305 changes the input profile from the ICC profile designated as the target color to the generated importance-on-color-impression-match color profile. This replacement of the input profile makes it unnecessary to directly change the color signal of the content. Therefore, it is possible to incorporate importance-on-color-impression-match processing without affecting black-plate processing and the like of an existing system functioning in accordance with the color signal.

In S506, by using the input profile and the output profile of the updated job information, the color conversion unit 306 of the control apparatus 110 performs color conversion in accordance with the attribute information for the content included in the print job. The color conversion unit 306 transmits the print job including the color-converted content to the printer 130a to 130c. In a case where the job issued by the job issuance unit 302 of the job issuance apparatus 100 in S502 is not a print job but a monitor color calibration job, the color conversion unit 306 embeds the input profile and the output profile of the updated job information into the content. Embedding the input profile and the output profile into the content makes it possible to perform a simulation of colors at the printer of the own base and perform display on the monitor owned by the print client. By sending the content in which the input profile and the output profile are embedded to the print client via the job issuance apparatus 100, the control apparatus 110 is able to make a request to the print client for monitor color calibration for the content that is scheduled to be printed. Upon receiving the print job, the printer 130a to 130c outputs the content to a medium on the basis of the print job.

FIG. 5B illustrates the flow of processing in a second case. In the second case, the job issuance apparatus 100 that is at a location different from the locations of the bases 170a to 170c performs job issuance only. Upon receiving the job, the control apparatus 110 in the base 170a to 170c performs color settings including setting of placing an importance on an impression match in colors, color profile generation, and color conversion. In the second case, it is possible to perform printing with an importance placed on an impression match in colors by adding a novel configuration for performing importance-on-color-impression-match color conversion to the control apparatus 110 serving as an intermediate buffer to the printer, without affecting an existing system such as the job issuance apparatus.

Only differences from FIG. 5A will now be described about a specific flow of processing illustrated in FIG. 5B. In S512, the UI control unit 303 of the control apparatus 110 displays the operation screen 400 on the display unit 105. The color setting unit 304 of the control apparatus 110 performs color setting of the color setting area 405 to be applied to the job received from the job issuance apparatus 100.

FIG. 5C illustrates the flow of processing in a third case. In the third case, the job issuance apparatus 100 that is at a location different from the locations of the bases 170a to 170c performs color setting, job issuance, attribute information generation, color profile generation, and job information updating. Upon receiving the job, the control apparatus 110 in the base 170a to 170c performs color conversion. In the third case, an importance-on-color-impression-match color profile is generated on the basis of a typical printer model profile of a printer supplied from a printer manufacturer or on the basis of a printer profile generated for a virtual printer gamut corresponding to the color setting. The color conversion unit 306 of the control apparatus 110 in the base 170a to 170c performs colorimetric color conversion while using an importance-on-color-impression-match color profile as an input profile and using a printer profile of a printer that performs printing finally as an output profile. As described above, in the third case, the job issuance apparatus 100 that is not located at the base generates an importance-on-color-impression-match color profile for a standard printer gamut, and the control apparatus 110 that is located at the base performs fine adjustments to the printer. By this means, it is possible to perform printing with an importance placed on an impression match in colors by adding a novel configuration for performing importance-on-color-impression-match color conversion to the job issuance apparatus 100 that is not located at the base, without affecting an existing system that is located at the base. The job issuance apparatus 100, when generating an importance-on-color-impression-match color profile, may acquire the printer profile of the printer located at the base via the control apparatus 110. It is also possible to incorporate, into other cases such as the first case and the second case, the above stepped scheme of generating an importance-on-color-impression-match color profile for a standard printer gamut and performing fine adjustments to the printer located at the base.

Only differences from FIG. 5A will now be described about a specific flow of processing illustrated in FIG. 5C. In S523, the attribute information generation unit 307 of the job issuance apparatus 100 acquires PDL data contained in the content of the job information issued in S502 and generates object-by-object or pixel-by-pixel attribute information. The generated attribute information is stored into the RAM 103 so that it can be looked up in steps described below. In S524, in a case where setting of placing an importance on an impression match in colors is included in the job information, the color profile generation unit 305 of the job issuance apparatus 100 generates an importance-on-color-impression-match color profile on the basis of any two or more kinds of information among content, target color, and printer profile. A typical printer model profile is used as the printer profile. In a case where placing an importance on an impression match in colors is set according to the object attribute area 452, the data type area 453, and the exception embedded profile area 458, the color profile generation unit 305 generates an importance-on-color-impression-match color profile for each condition.

In a case where it is set to perform a paper-white simulation at the paper-white simulation area 457, the color profile generation unit 305 generates an importance-on-color-impression-match color profile corresponding to the setting. A detailed description of the processing for generating an importance-on-color-impression-match color profile will be given later.

In S525, the color profile generation unit 305 of the job issuance apparatus 100 updates the job information by using the generated importance-on-color-impression-match color profile. Specifically, the color profile generation unit 305 changes the input profile from the ICC profile designated as the target color to the generated importance-on-color-impression-match color profile. In S526, by using the input profile and the output profile of the updated job information, the color conversion unit 306 of the control apparatus 110 performs color conversion in accordance with the attribute information for the content included in the print job. The color conversion unit 306 transmits the print job including the color-converted content to the printer 130a to 130c.

FIG. 5D illustrates the flow of processing in a fourth case. In the fourth case, color conversion for rendering the number of dimensions of input data and a color space common is performed after generating attribute information in S503. In the fourth case, it is possible to execute the generation of an importance-on-color-impression-match color profile by using a common processing logic for data of various numbers of dimensions used in an existing system such as CMYK data, RGB data, and the like and for various color spaces such as Japan Color, sRGB, and the like.

Only differences from FIG. 5A will now be described about a specific flow of processing illustrated in FIG. 5D. In S531, based on the color information and the color setting information included in the job received from the job issuance apparatus 100 and based on the attribute information generated in S503, the color conversion unit 306 of the control apparatus 110 performs color conversion into a work color space. In the present embodiment, for example, it is assumed that CMYK (Japan Color 2011) input data is color-converted into three-dimensional RGB data and AdobeRGB work color space. Also for the target color, the numbers of dimensions of the input is rendered common into three dimensions by performing conversion from a target color table for CMYK data into a target color table for work RGB data. For use in later steps, the information before the color conversion is temporarily stored into the RAM 103. In S532, the color profile generation unit 305 of the control apparatus 110 generates an importance-on-color-impression-match color profile on the basis of any two or more kinds of information among color signal of content after conversion into the work color space, target color, and printer profile.

Specifically, first, the color profile generation unit 305 generates an importance-on-color-impression-match color profile for work. The importance-on-color-impression-match color profile for work is a color profile for conversion from a work RGB value into an importance-on-color-impression-match L*a*b* value. Then, the color profile generation unit 305 synthesizes the color profile used for the conversion from the CMYK value into the work RGB value in S531 with the importance-on-color-impression-match color profile for work. By performing this synthesis, a color profile for conversion from the CMYK value into the importance-on-color-impression-match L*a*b* value can be obtained.

In S533, the color profile generation unit 305 of the control apparatus 110 updates the job information that is before the conversion into the work color space in S531 by using the generated importance-on-color-impression-match color profile. Specifically, the color profile generation unit 305 changes the input profile information for the job information that is before the conversion into the work color space in S531 from the ICC profile designated as the target color to the generated importance-on-color-impression-match color profile.

As explained above, since the importance-on-color-impression-match color profile is generated by way of the work color space and since the input profile is replaced for the job that is before the conversion into the work color space, there is no need to directly change the color signal of the content. Therefore, it is possible to incorporate importance-on-color-impression-match processing without affecting black-plate processing and the like of an existing system functioning in accordance with the color signal. It is also possible to incorporate, into other cases such as the first case and the second case, the above scheme of performing common processing using the work color space and generating the importance-on-color-impression-match color profile.

Though the flow of processing in the first to fourth cases have been described above, the flow of processing is not limited to the above examples. Four example, processes that can be executed concurrently may be executed concurrently. Processes whose order of execution can be changed may be changed. Instead of performing color conversion at the control apparatus 110, color conversion may be performed at a non-illustrated color converter of the printer 130a to 130c.

### Color Profile Generation Processing

Next, the flow of processing for generating an importance-on-color-impression-match color profile by the color profile generation unit 305 will now be described. When it is attempted to match colors among a plurality of printers having different gamuts of colors, aiming at a color gamut that is as wide as possible as target colors (hereinafter will be referred to also as “target”) makes it possible to perform vivid color expression while taking advantage of the respective color gamuts of output devices. For example, a case where a color gamut that is the logical sum (OR) of the color gamuts of the output devices is aimed at as the target is conceivable. In this case, there is a need to replace not-within-gamut colors with within-gamut colors of each output device by performing color mapping. As described earlier, accordingly, the occurrence of color loss due to performing absolute colorimetric mapping, and a decrease in the degree of colorimetric matching due to performing perceptual mapping, are issues that need to be addressed.

To address these issues, in the present embodiment, in a case where color degeneracy occurs when absolute colorimetric mapping is performed, color mapping that achieves both color matching and color discriminability is performed by increasing a distance between colors in accordance with a degree of color degeneracy. In the present embodiment, an input original document is an RGB image, and gamut mapping is performed using a 3DLUT for converting an RGB value into an L*a*b* value as a color profile.

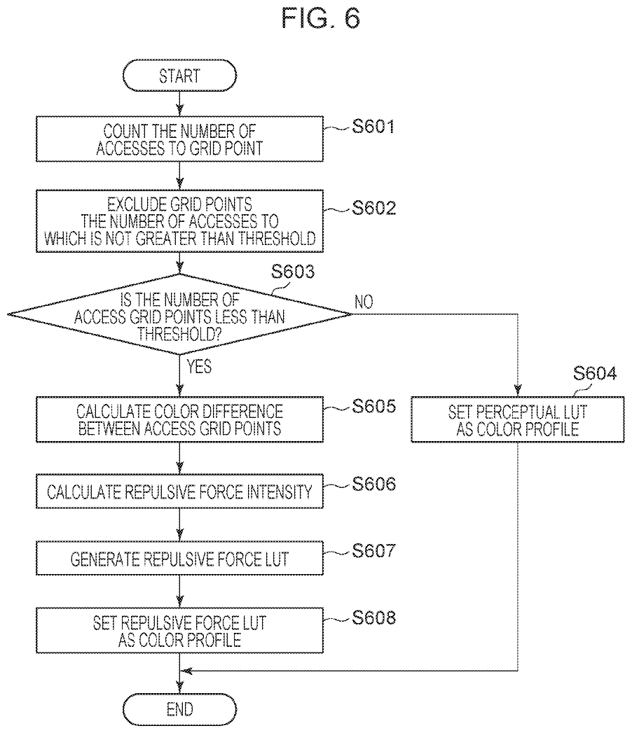

FIG. 6 is a flowchart illustrating the flow of dynamic generation processing of a 3DLUT according to the present embodiment. In the present embodiment, an absolute colorimetric mapping table and a perceptual mapping table are synthesized in accordance with a degree of color degeneracy. The processing illustrated in FIG. 6 is implemented by reading a program out of the ROM 102 into the RAM 103 and running the read program by the CPU 101.

In S601, the color profile generation unit 305 performs counting for grid points used when performing color conversion on an input image by using a mapping table. In color conversion using a 3DLUT, interpolation processing is performed when deriving an L*a*b* value corresponding to an input RGB value. Grid points near the input RGB value are used for the interpolation processing. The color profile generation unit 305 acquires, as an access counter, for each grid point, the number of times each grid point is used in the interpolation processing when the gamut mapping is performed on the input image. The method of grid point access counting is not limited to the above example. The counting may be performed for nearest grid point only, or weighted counting based on grid-point distance may be performed. In the description below, grid points that are accessed will be referred to as “access grid points”.

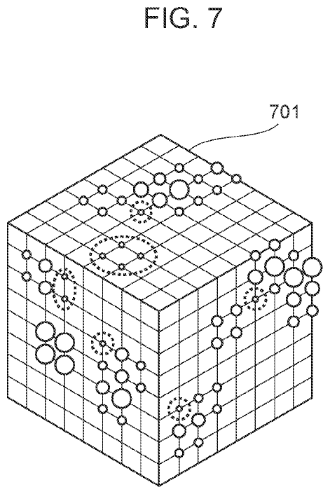

In S602, based on the grid point access count acquired in S601, the color profile generation unit 305 excludes, from the access grid points, grid points whose number of accesses is less than or equal to a threshold, by regarding them as grid points that are not used in the interpolation processing. FIG. 7 is a schematic view of access count information of grid points. A grid 701 indicates a 3DLUT used for gamut mapping. Each grid-point circle represents a grid-point access counter, where the size of the circle indicates the number of accesses. The access counters encircled by dotted-line illustration represent grid points whose number of accesses is less than or equal to the threshold. These less-than-threshold grid points are excluded from the access grid points.

In S603, the color profile generation unit 305 determines whether or not the number of the access grid points is less than the maximum number of colors Cmax. In a case where a graphic image, a natural image, or the like including areas of high gradation property such as a gradation is inputted, perceptual mapping is suited as gamut mapping. Therefore, in a case where the number of the access grid points is greater than or equal to the maximum number of colors Cmax, the color profile generation unit 305 determines that the input image has many colors and high gradation property and thus advances the process to S604 so as to perform perceptual mapping. In S604, the color profile generation unit 305 sets a perceptual mapping table as a color profile. In a case where it is determined in S603 that the number of the access grid points is less than the maximum number of colors Cmax, the process proceeds to S605.

In S605, the color profile generation unit 305 calculates a color difference between access grid points. Specifically, first, the color profile generation unit 305 acquires a target color L*a*b* value of each access grid point and an L*a*b* value after absolute colorimetric mapping (hereinafter referred to also as “colorimetric L*a*b* value”) thereof. Then, the color profile generation unit 305 calculates a color difference between access grid points for every access grid point combination for each of the target color L*a*b* value and the colorimetric L*a*b* value. For the calculation of the color difference, for example, a Euclidean distance in an L*a*b* color space can be used.

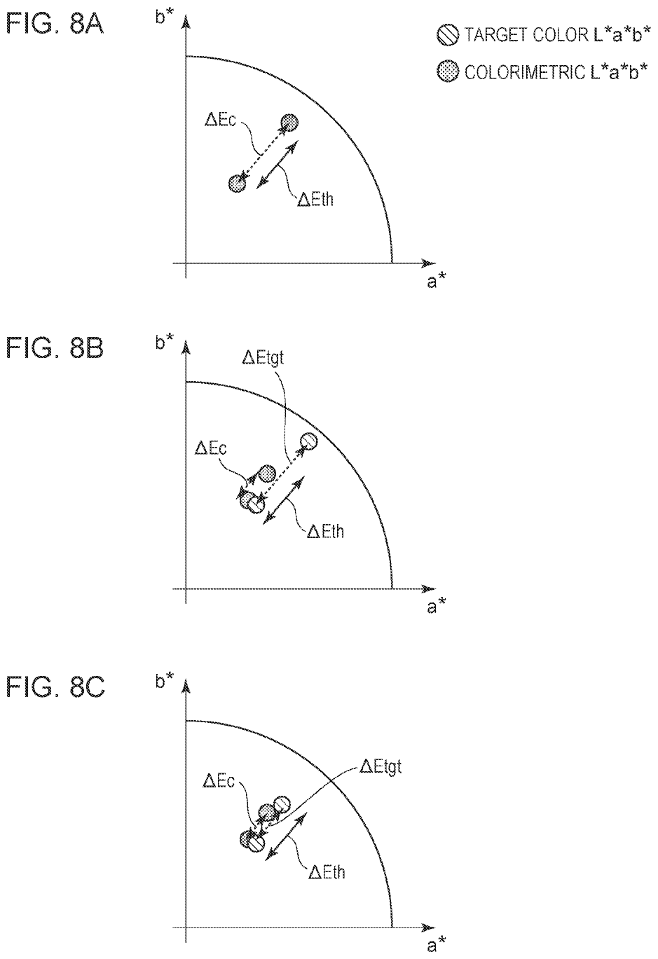

In S606, the color profile generation unit 305 calculates repulsive force intensity. The repulsive force intensity is a parameter for increasing a distance between colors for the purpose of guaranteeing minimum color discriminability in a case where a color difference between colors after absolute colorimetric mapping is less than a color difference between colors in the target color. FIGS. 8A, 8B, and 8C are schematic views for explaining a method of calculating repulsive force intensity. First, the color profile generation unit 305 determines whether or not a color difference ΔEc between grid points after absolute colorimetric mapping is greater than or equal to a color difference threshold ΔEth. The color difference threshold ΔEth is a threshold that specifies the minimum color difference for guaranteeing color discriminability.

FIG. 8A is a diagram illustrating a case where ΔEc is greater than or equal to ΔEth. In this case, since there is sufficient color discriminability after absolute colorimetric mapping, the color profile generation unit 305 determines that there is no need to apply a repulsive force, and the repulsive force intensity is thus the minimum (zero). In a case where ΔEc is less than ΔEth, the color profile generation unit 305 determines whether or not a color difference ΔEtgt between grid points of the target is greater than or equal to ΔEth.

FIG. 8B is a diagram illustrating a case where ΔEtgt is greater than or equal to ΔEth. In this case, the color profile generation unit 305 sets the repulsive force intensity in such a way as to make the color difference ΔEc equivalent to ΔEth. FIG. 8C is a diagram illustrating a case where ΔEtgt is less than ΔEth. In this case, if a repulsive force is applied in such a way as to make the color difference ΔEc equivalent to ΔEth, there is a possibility that a degree of color matching with ΔEtgt might decreases; therefore, the color profile generation unit 305 sets the repulsive force intensity in such a way as to make the color difference ΔEc equivalent to ΔEtgt. The color profile generation unit 305 calculates the repulsive force intensity for every color combination, and stores the maximum repulsive force intensity as repulsive force intensity to be used in subsequent processing. Repulsive force intensity R can be calculated using the following formula (1).

$$R = \{ \begin{matrix}0 & ( Δ Ec \geq Δ Eth ) \\ 1 - Δ Ec / Δ Eth & ( Δ Ec < Δ Eth , Δ Etgt \geq Δ Eth ) \\ 1 - Δ Ec / Δ Etgt & ( Δ Ec < Δ Eth , Δ Etgt < Δ Eth )\end{matrix} \qquad ( 1 )$$

In S607, the color profile generation unit 305 generates a repulsive force LUT. Specifically, by using the repulsive force intensity R calculated in S605, the color profile generation unit 305 generates the repulsive force LUT by performing interpolation of the absolute colorimetric mapping table and the perceptual mapping table. It is possible to mitigate color degeneracy and guarantee color discriminability by performing interpolation of the absolute colorimetric mapping table and the perceptual mapping table. The interpolation processing is performed using an L*a*b* value of each grid point of each mapping table and using the following formulas (2).

$$L *= ( 1 - R ) \times L * colorimetric + R \times L * perceptual \qquad ( 2 )$$

$$a *= ( 1 - R ) \times a * colorimetric + R \times a * perceptual$$

$$b *= ( 1 - R ) \times b * colorimetric + R \times b * perceptual$$

In S608, the color profile generation unit 305 sets the repulsive force LUT generated in S607 as a color profile.

As explained above, an information processing apparatus according to the present embodiment performs processing of synthesizing two color mapping tables together, in accordance with a degree of color degeneracy after absolute colorimetric mapping of colors of an input image. By this means, it is possible to perform color mapping that achieves both color matching and color discriminability.

### Second Embodiment

In the first embodiment described above, single repulsive force intensity is calculated for an image as a whole to generate a repulsive force LUT. In the present embodiment, a table is divided into a plurality of areas in a hue direction, and a repulsive force LUT is generated by calculating repulsive force intensity for each hue area. By this means, it is possible to perform dynamic processing that achieves both color matching and color discriminability in accordance with a distribution of signal values of an input image. The hardware configuration and functional configuration of an information processing apparatus according to the present embodiment are the same as those of the first embodiment; therefore, an explanation thereof is omitted. Differences between the present embodiment and the first embodiment will be mainly described below. The same reference signs will be assigned to the same components as those of the first embodiment in the description below.

### Color Profile Generation Processing

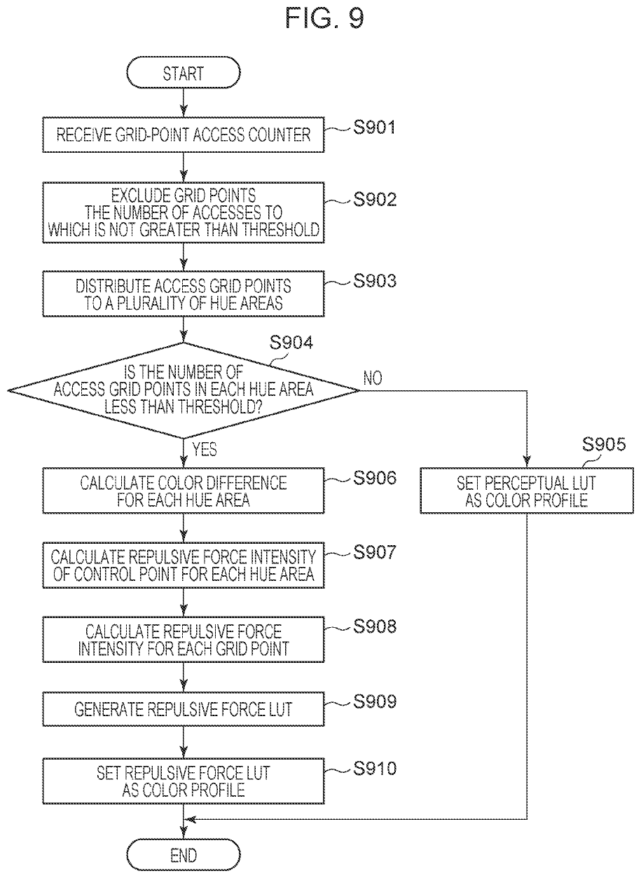

FIG. 9 is a flowchart illustrating the flow of dynamic generation processing of a 3DLUT according to the present embodiment. The processing illustrated in FIG. 9 is implemented by reading a program out of the ROM 102 into the RAM 103 and running the read program by the CPU 101. In S901, the color profile generation unit 305 acquires grid-point access counter information stored in the HDD 104. In S902, the color profile generation unit 305 excludes grid points whose number of accesses is less than or equal to a threshold from the grid-point access counter information acquired in S901.

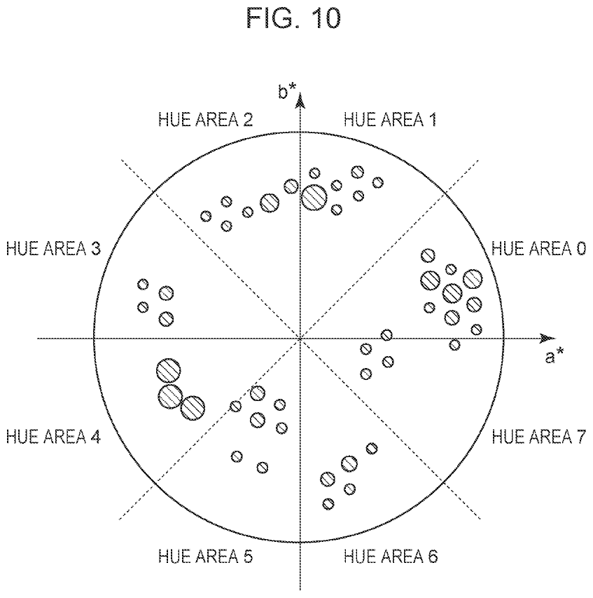

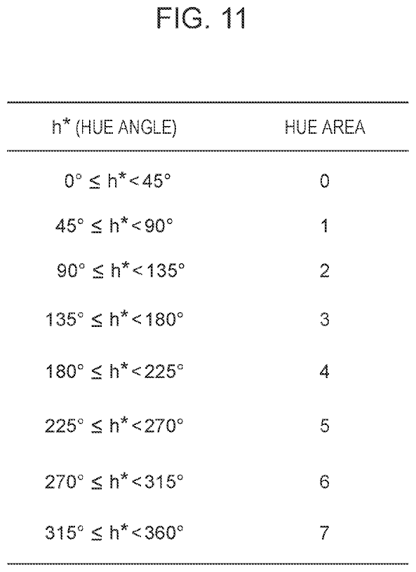

In S903, the color profile generation unit 305 distributes access grid points to a plurality of hue areas. FIG. 10 is a schematic view for explaining processing of distributing access grid points to a plurality of hue areas. Though processing of equally dividing hue into eight areas on a color space will be described below, the method of area division is not limited to this example. These eight hue areas will be referred to as hue areas 0 to 7 in a counterclockwise sequential order from the a*-axis direction. Specifically, first, the color profile generation unit 305 acquires the target color L*a*b* value of each access grid point. Next, the color profile generation unit 305 converts the target color L*a*b* value into a target color L*c*h* value. The color profile generation unit 305 distributes the access grid points to the hue areas by using h* (hue) components. FIG. 11 is a diagram illustrating an example of correspondences between the h* components of the access grid points and the hue areas to which the access grid points are distributed.

In S904, the color profile generation unit 305 determines whether or not the number of the access grid points in each hue area is less than the maximum number of colors Cmax. In a case where the number of the access grid points in the same hue area is greater than or equal to the maximum number of colors Cmax, the color profile generation unit 305 determines that the input image has many colors and high gradation property and thus advances the process to S905 so as to perform perceptual mapping. In S905, the color profile generation unit 305 sets a perceptual mapping table as a color profile. In a case where it is determined in S904 that the number of the access grid points in each hue area is less than the maximum number of colors Cmax, the process proceeds to S906.

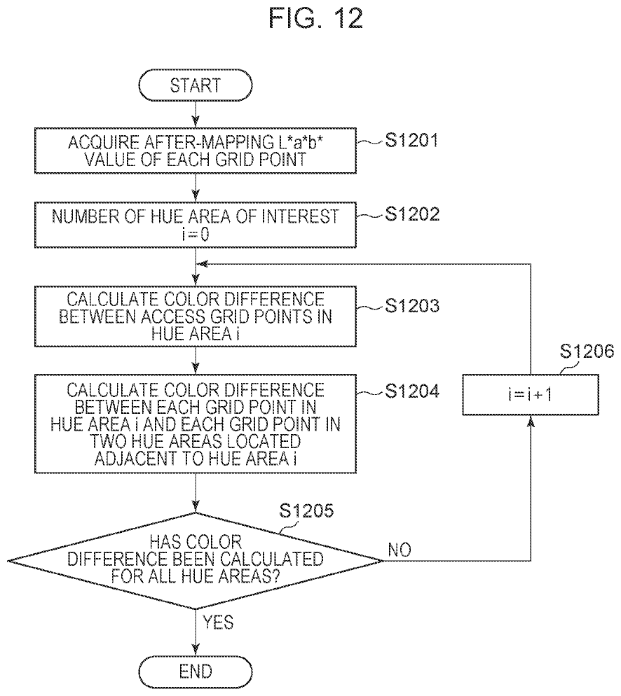

In S906, the color profile generation unit 305 calculates, for each hue area, a color difference between access grid points. FIG. 12 is a flowchart illustrating the flow of processing of calculating a color difference according to the present embodiment. The processing illustrated in FIG. 12 is implemented by reading a program out of the ROM 102 into the RAM 103 and running the read program by the CPU 101. In S1201, the color profile generation unit 305 acquires a colorimetric L*a*b* value of each access grid point. In S1202, the color profile generation unit 305 initializes the number i of the hue area of interest by zero. In S1203, the color profile generation unit 305 calculates a color difference between access grid points in the hue area of interest i. Specifically, the color profile generation unit 305 calculates a color difference for every access grid point combination for each of the target color L*a*b* value acquired in S903 and the colorimetric L*a*b* value acquired in S1201.

In S1204, the color profile generation unit 305 calculates a color difference between each grid point in the hue area of interest i and each grid point in two hue areas located adjacent to the hue area of interest i.

Specifically, the color profile generation unit 305 calculates a color difference for every access grid point combination for each of the target color L*a*b* value and the colorimetric L*a*b* value. In S1205, the color profile generation unit 305 determines whether or not the calculation of the color difference has been performed for all of the hue areas. In a case where the calculation of the color difference has not been completed for all of the hue areas yet, the process proceeds to S1206. In S1206, the color profile generation unit 305 increments the number i of the hue area of interest by one. In a case where the calculation of the color difference has been completed for all of the hue areas, S906 is terminated, and the process proceeds to S907.

In S907, the color profile generation unit 305 calculates, for each hue area, repulsive force intensity on the basis of the color difference calculated in S906. The repulsive force intensity is calculated for every color difference in each hue area, and the maximum repulsive force intensity in each hue area is stored as repulsive force intensity to be used in subsequent processing. The repulsive force intensity calculated here is stored with a position on a bisector of a center angle taken as a control position for each hue area. The formula (1) can be used for calculating the repulsive force intensity based on the color difference.

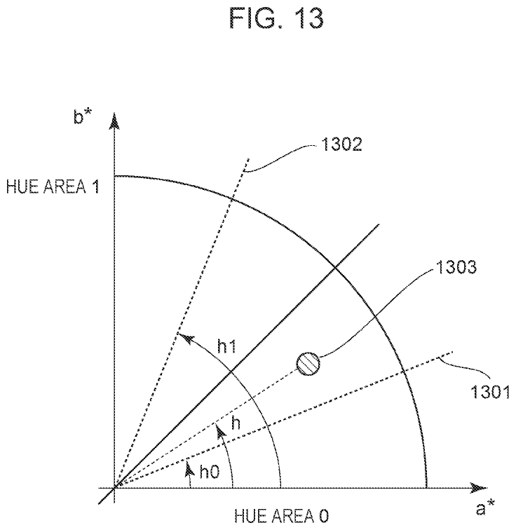

In S908, the color profile generation unit 305 calculates the repulsive force intensity for each grid point through interpolation processing. FIG. 13 is a schematic view for explaining the interpolation processing of the repulsive force intensity. The dotted line 1301 represents the control position of the repulsive force intensity in the hue area 0. The dotted line 1302 represents the control position of the repulsive force intensity in the hue area 1. The repulsive force intensity at the position of a grid point 1303 is calculated on the basis of the following formula (3) by using repulsive force intensity R0 of the hue area 0, a hue angle h0 of the control position, repulsive force intensity R1 of the hue area 1, a hue angle h1 of the control position, and a hue angle h of the grid point 1303.

R=((h1−h)×R0+(h−h0)×R1)/(h1−h0) (3)

In S909, the color profile generation unit 305 generates a repulsive force LUT. Specifically, by using the repulsive force intensity R calculated in S908, the color profile generation unit 305 generates the repulsive force LUT by performing interpolation of the absolute colorimetric mapping table and the perceptual mapping table. Since the method of generating the repulsive force LUT is the same as that of S607, an explanation thereof is omitted. In S910, the color profile generation unit 305 sets the repulsive force LUT generated in S909 as a color profile.

As explained above, an information processing apparatus according to the present embodiment performs processing of calculating repulsive force intensity for each hue area and synthesizing the absolute colorimetric mapping table with the perceptual mapping table. By this means, it is possible to perform color mapping that achieves both color matching and color discriminability while taking color degeneracy of each hue into consideration.

### Third Embodiment

In the first and second embodiments described above, in a case where a graphic image, a natural image, or the like including areas of high gradation property such as a gradation is inputted, perceptual mapping is performed. Usually, a mapping table used for color conversion is defined in a static manner based on a corresponding relationship between a target color gamut and a printer color gamut irrespective of the color of input content. Moreover, in perceptual mapping, in mapping from a target color gamut onto a printer color gamut, a greater importance is placed on gradation property and color discriminability of colors that are continuous from the outside of a color gamut to the inside of the color gamut than absolute colorimetric color matching. That is, a static perceptual mapping table is generated in such a way as to, basically, retain gradation property and color discriminability in a printer color gamut for input colors of a target color space as a whole. For this reason, this mapping table applies color degeneracy intensely while sacrificing color matching irrespective of the color gamut of colors of content (content gamut).

In the present embodiment, an amount of color degeneracy is suppressed in accordance with an input content gamut; that is, a perceptual mapping color is extended in a color impression match direction. By this means, it is possible to generate a dynamic mapping table that achieves both color matching and gradation property of colors that are continuous from the outside of a color gamut to the inside of the color gamut. The hardware configuration and functional configuration of an information processing apparatus according to the present embodiment are the same as those of the first embodiment; therefore, an explanation thereof is omitted. Differences between the present embodiment and the first embodiment will be mainly described below. The same reference signs will be assigned to the same components as those of the first embodiment in the description below. In the present embodiment, input content is an RGB image, and gamut mapping is performed using a 3DLUT for converting an RGB value into an L*a*b* value.

### Color Profile Generation Processing

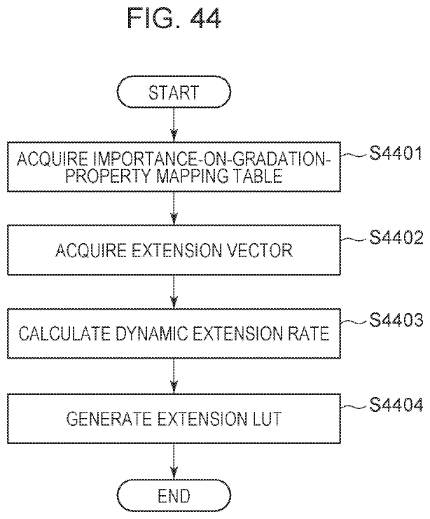

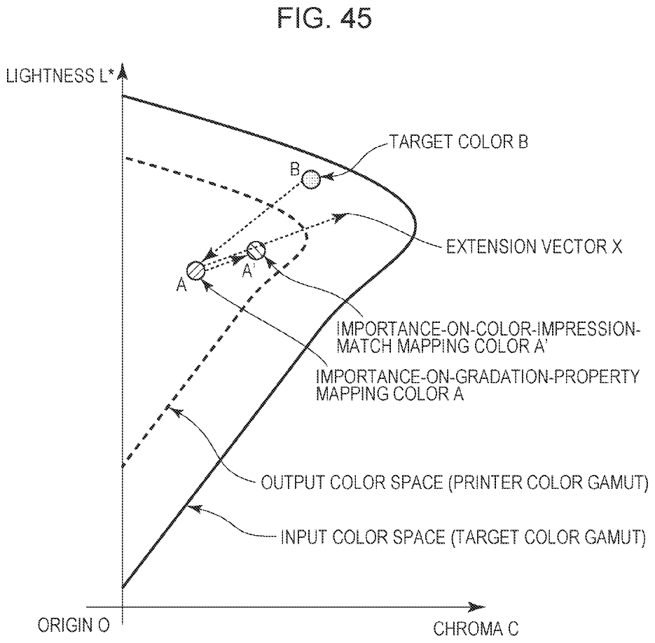

FIG. 44 is a flowchart illustrating the flow of dynamic generation processing of a 3DLUT according to the present embodiment. The processing illustrated in FIG. 44 is implemented by reading a program out of the ROM 102 into the RAM 103 and running the read program by the CPU 101. In S4401, the color profile generation unit 305 acquires an importance-on-gradation-property mapping table. In S4402, the color profile generation unit 305 acquires one or more extension vectors. FIG. 45 illustrates an LC plane at a certain hue in an LCH space. The vertical axis of the graph represents lightness L*, and the horizontal axis thereof represents chroma C. FIG. 45 illustrates an example of gamut mapping from an input color space of a wide color gamut (target color gamut) onto an output color space of a narrow color gamut (printer color gamut).

In FIG. 45, a point B of a target color is degenerated intensely not to any of surface colors of the printer color gamut but to a point A located inside the color gamut by gamut mapping using the importance-on-gradation-property mapping table. The extension vector points to any direction going outward from any point located inside the printer color gamut, not toward the center of the printer color gamut. In FIG. 45, the extension vector of the point A is an extension vector X. It is assumed that the extension vector X according to the present embodiment has been preset for each grid point of the importance-on-gradation-property mapping table; however, this does not imply any limitation. Color information may be acquired from the image for each pixel, a mapping point A generated by color conversion using the importance-on-gradation-property mapping table and a mapping point X′ (not illustrated) based on minimum color difference calculation to the target color of the pixel may be calculated for the color information of the pixel, and AX′ may be set as the extension vector. In the present embodiment, the extension vector X points to a direction in which the degree of color impression match with the target-color point B increases. The extension vector X does not necessarily have to point to the target-color point B perfectly. It is sufficient as long as the extension vector X points to a direction of coming closer to the target-color point B.

In S4403, based on the color information of the image, the color profile generation unit 305 determines a dynamic extension rate. Specifically, first, by using a known method, the color profile generation unit 305 performs within/not-within printer-color-gamut determination for the color information of all of the pixels of the image to count the number of pixels that are within the printer color gamut. Then, the color profile generation unit 305 calculates the dynamic extension rate on the basis of the following formula (4).

$$Dynamic extension rate = the number of pixels that are within the printer color gamut / the number of all pixels \qquad ( 4 )$$

In S4404, the color profile generation unit 305 generates an extension LUT on the basis of the importance-on-gradation-property mapping table acquired in S4401, the extension vector acquired in S4402, and the dynamic extension rate determined in S4403. The extension LUT is generated using the following formula (5).

$$\vec{O {A}^{′}} = \vec{OA} + dynamic extension rate \times \vec{X} \qquad ( 5 )$$

In the above formula, O denotes the coordinate origin, A denotes an importance-on-gradation-property mapping color of each grid point, A′ denotes an extended mapping color of each grid point, and X denotes an extension vector of each grid point. The generated extension LUT is set as a color profile.

As explained above, an information processing apparatus according to the present embodiment generates an extension LUT for extending a color that is degenerated when an importance-on-gradation-property mapping table is used outward of the printer color gamut in a direction of coming closer to the target color, depending on the image. By this means, it is possible to generate a dynamic mapping table that achieves both color matching and gradation property of colors that are continuous from the outside of a color gamut to the inside of the color gamut.

### Variation Example

A method of determining an extension rate that makes it possible to make the maximum use of a printer color gamut, more efficiently than the method described above, will now be described. In this variation example, static extension information for a color is calculated for each grid point. The static extension information for an importance-on-gradation-property mapping color contains information for extending a mapping color degenerated from the target color due to placing an importance on gradation property in a direction of increasing a degree of color impression match with the target color. Specifically, the extension information indicates an extension vector and an extension rate by which extension can be performed in the printer color gamut in the direction of the extension vector (available extra extension margin). Note that, usually, an input color space and an output color space are not spheres, and an amount of color degeneracy differs depending on a coordinate position in the color space because mapping according to hue, lightness, and chroma is performed. For this reason, it is difficult to uniquely determine an extension amount that strikes a good balance between gradation property and color matching at various positions in the color space. In view of the above, in this variation example, extension vectors at various positions in a color space and the ratio thereof (extension rate or degeneracy rate), not the magnitude thereof, are calculated.

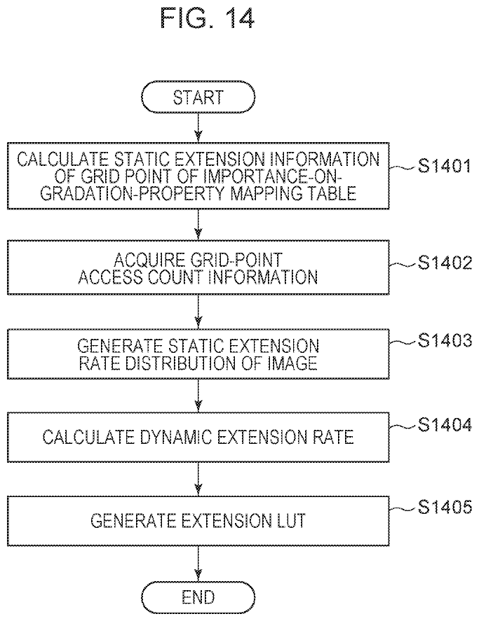

FIG. 14 is a flowchart illustrating the flow of dynamic generation processing of a 3DLUT according to this variation example. The processing illustrated in FIG. 14 is implemented by reading a program out of the ROM 102 into the RAM 103 and running the read program by the CPU 101. In S1401, the color profile generation unit 305 calculates, for each grid point, static extension information for an importance-on-gradation-property mapping color.

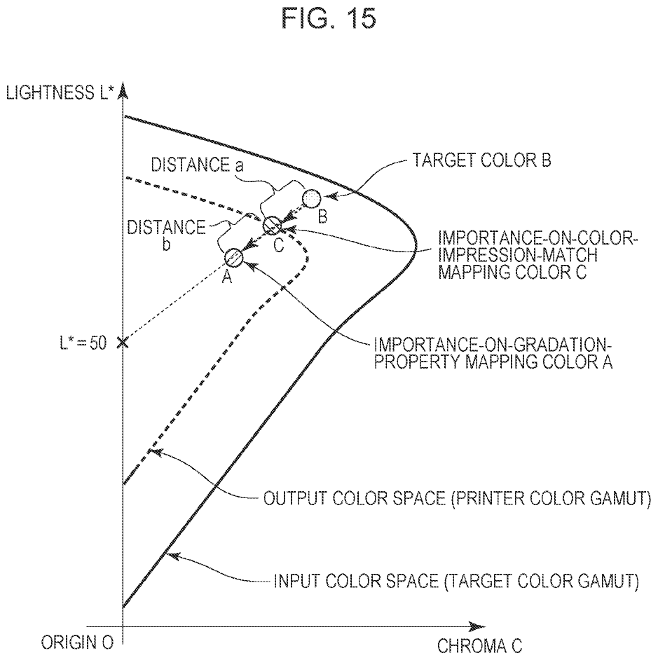

The static extension information for an importance-on-gradation-property mapping color contains information for extending a mapping color degenerated from the target color due to placing an importance on gradation property in a direction of increasing a degree of color impression match with the target color. FIG. 15 illustrates an LC plane at a certain hue in an LCH space. The vertical axis of the graph represents lightness L*, and the horizontal axis thereof represents chroma C. FIG. 15 illustrates an example of a case where, in gamut mapping from an input color space of a wide color gamut (target color gamut) onto an output color space of a narrow color gamut (printer color gamut), a mapping destination is determined for a certain target color in a direction of L*=50.

First, in order to calculate static extension information for an importance-on-gradation-property mapping color, the color profile generation unit 305 calculates a color for a case where the target color is mapped with an importance placed on gradation property and a color for a case where the target color is mapped with an importance placed on an impression match in colors. In the case of importance-on-gradation-property mapping, the point of a target color B (“target-color point B”) is degenerated to the point of an importance-on-gradation-property mapping color A (“importance-on-gradation-property mapping color point A”) located inward of the printer color gamut. In the case of importance-on-color-impression-match mapping, the target-color point B is degenerated to the point of an importance-on-color-impression-match mapping color C (“importance-on-color-impression-match mapping color point C”) that makes the maximum use of the printer color gamut.

Next, the color profile generation unit 305 calculates an extension vector from the importance-on-gradation-property mapping color point A to the importance-on-color-impression-match mapping color point C and an extension rate thereof. The extension vector is AB or AC, and is calculated using the following formula (6).

$$\vec{AB} = \vec{OB} - \vec{OA} \qquad ( 6 )$$

$$or$$

$$\vec{AC} = \vec{OC} - \vec{OA}$$

The extension rate (0.0 to 1.0) is calculated using the following formula (7).

$$Extension rate = distance b / ( distance a + distance b ) \qquad ( 7 )$$

In the above formula, the distance a is a color difference ΔE between the target-color point B and the importance-on-color-impression-match mapping color point C, and the distance b is a color difference ΔE between the importance-on-gradation-property mapping color point A and the importance-on-color-impression-match mapping color point C. “Distance a=0 and distance b≠0” represents a mapping color that is, though within the printer color gamut, degenerated while taking mapping of a color that is not within the printer color gamut in importance-on-gradation-property mapping into consideration, and its extension rate is 1.0 according to the formula (7). “Distance a=0 and distance b=0” means a mapping color of a maintaining area where the target color is maintained without any occurrence of color degeneracy, in addition to being zero division, and is treated as an exception. In the present embodiment, since the target color is maintained, this exceptional mapping color is treated as an extension rate of 1.0 with an importance placed on an impression match in colors; however, this does not imply any limitation. It may be excluded from the scope of extension rate calculation.

By using the calculated extension information (extension vector and extension rate), it is possible to extend the importance-on-gradation-property mapping color point A to the importance-on-color-impression-match mapping color point C on the basis of the following formula (8).

$$\vec{OC} = \vec{OA} + \vec{AC} = \vec{OA} + extension rate \times \vec{AB} \qquad ( 8 )$$

The vector calculation may be performing while taking the target-color point B as a reference. In this case, it follows that a degeneracy direction vector in a direction from the target color toward the importance-on-color-impression-match mapping color point C and a degeneracy rate are calculated. The importance-on-color-impression-match mapping color point C that makes the maximum use of the printer color gamut may be calculated by performing internally-dividing-point calculation of, based on the distance a and the distance b, two coordinate points that are the importance-on-gradation-property mapping color point A and the target-color point B. In this case, an internally-dividing-point ratio is defined as a static extension rate for an importance-on-gradation-property mapping color. The importance-on-color-impression-match mapping color point C is calculated through internally-dividing-point calculation of the two points by using the following formula (9).

$$\vec{OC} = ( 1. - extension rate ) \times \vec{OA} + extension rate \times \vec{OB} \qquad ( 9 )$$

Through the above processing, in S1401, the color profile generation unit 305 calculates, for each grid point, static extension information (extension vector and extension rate) for the importance-on-gradation-property mapping color.

In this variation example, it is assumed that three 3DLUTs for converting an RGB value into an L*a*b* value have been prepared in advance. Each of these 3DLUTs represents a target color, a color obtained by applying importance-on-gradation-property mapping to the target color, and a color obtained by applying importance-on-color-impression-match mapping to the target color for each grid point in an RGB space. It is assumed that three 3DLUTs have been prepared in advance based on a combination of a printer profile determined on the basis of the settings of the printer 432 and the settings of the medium 433, and a target color determined on the basis of the settings of a target color 454. Alternatively, two mapping tables, specifically, the perceptual mapping table and the colorimetric mapping table, are generated by using a known method on the basis of the ICC profile of the target color and the ICC profile of the printer. The static extension information is not extension information considering that color gradation property is retained when a plurality of grid points is used. As will be described in detail later, a dynamic extension rate considering a balance between gradation property and color matching is determined while referring to a distribution of grid points used by an image in steps to be described later.

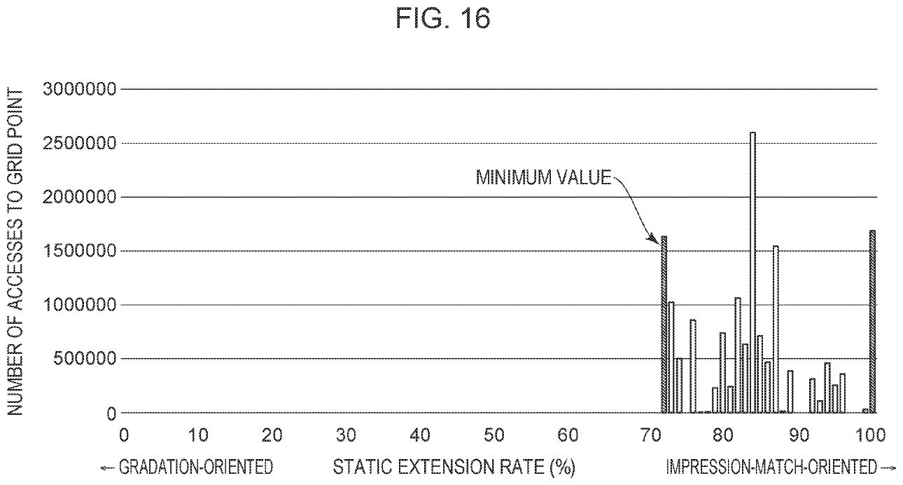

In S1402, the color profile generation unit 305 acquires grid-point access count information by counting grid points used when performing color conversion on an input image by using a mapping table. In S1403, based on the static extension rate of the grid points calculated in S1401 and based on the grid-point access count information acquired in S1402, the color profile generation unit 305 generates a grid-point access distribution of the input image in relation to the static extension rate. FIG. 16 illustrates an example of the grid-point access distribution of the input image in relation to the static extension rate. The horizontal axis of the graph represents the static extension rate (%), and the vertical axis of the graph represents the number of grid-point accesses made by the color signal of the input image in relation to the static extension rate. As it goes toward the left side (0%) of the graph, the graph shows that the color is a mapping color that has a small available extra extension margin and involves degeneracy when an importance is placed on gradation property. As it goes toward the right side (100%) of the graph, the graph shows that the color is a mapping color that has a large available extra extension margin and thus can place an importance on a color impression match. That is, in a case of frequent accesses to grid points of a static extension rate of 0% only, it means that the target colors that constitute the image are importance-on-gradation-property mapping colors that already use the printer color gamut up to the limit and thus there is no more available extra extension margin. In a case of frequent accesses to grid points of a static extension rate of 100% only, it means that all of the target colors that constitute the image are reproducible colors that are within the printer color gamut and thus there is no need for degeneracy to importance-on-gradation-property mapping colors.

In the present embodiment, the static extension rate has been calculated in advance on a grid-point-by-grid-point basis so that, just by using information on accesses to the grid points in accordance with the image, it is possible to generate a frequency distribution of the input image in relation to the static extension rate illustrated in FIG. 16 at a high speed. However, the method of generating the frequency distribution of the input image in relation to the static extension rate is not limited to this example. For example, for an RGB signal of each pixel of an input image, a target color, a color obtained by applying importance-on-gradation-property mapping to the target color, and a color obtained by applying importance-on-color-impression-match mapping to the target color are calculated using three 3DLUTs. By this means, an extension rate may be calculated for each pixel, and a frequency distribution of the input image in relation to an extension rate may be generated.

In S1404, based on the grid-point access distribution of the input image in relation to the static extension rate generated in S1403, the color profile generation unit 305 determines a dynamic extension rate. In the present embodiment, the static extension rate indicated by the minimum value of the grid-point access distribution of the image is taken as the dynamic extension rate; however, this does not imply any limitation. For example, a median value in the grid-point access distribution may be taken, or a percentile value of the distribution of the dynamic extension rate may be determined based on the distance a and the distance b.

For example, the maximum value of the distance a that is referred to on the basis of the image represents a not-within-printer-gamut color that is most difficult to be reproduced. The greater the maximum value of the distance a is, the greater the risk of occurrence of gradation loss is when an importance is placed on color matching. The maximum value of the distance b that is referred to on the basis of the image represents a color obtained by applying degeneracy most intensely, meaning that there is an available extra extension margin. The greater the maximum value of the distance b is, the less the risk of occurrence of gradation loss even when an importance is placed on color matching.

Based on a non-illustrated screen setting value or the like, a percentile value of a distribution taken as a dynamic extension rate may be configured to be settable, or a one-dimensional conversion table for adjusting the calculated dynamic extension rate may be configured to be settable. The dynamic extension rate may be configured to be adjustable according to the attribute information. Since an object included in a natural image and the like contains much noise components, it is possible to increase a color match impression within a range in which a decrease in gradation property is not conspicuous even when a percentile value that tends to make a dynamic extension rate high is used. However, if a percentile value that tends to make a dynamic extension rate high is used for an object that contains little noise components such as a gradation, gradation loss is likely to be conspicuous. As described here, in the present embodiment, it is possible to adopt a configuration in which parameters used for calculating a dynamic extension rate are adjustable or the calculated dynamic extension rate is adjustable on a block-by-block basis.

In the example illustrated in FIG. 16, the minimum extension rate is 72%; therefore, the dynamic extension rate is a vector OA+an extension rate (0.72)×a vector AB. This minimum extension rate means that even a color having the small available extra extension margin has a margin for extension of 72%. If extension is performed at an extension rate that is greater than this minimum value, for example, at 90%, it follows that the extension is performed in excess of the available extra extension margin at grid points whose extension rate (available extra extension margin) is less than 90%, resulting in extending to the outside of the printer color gamut. For this reason, fine adjustments by gamut mapping from the outside of the color gamut to the inside of the color gamut using a post-processing output profile are needed.

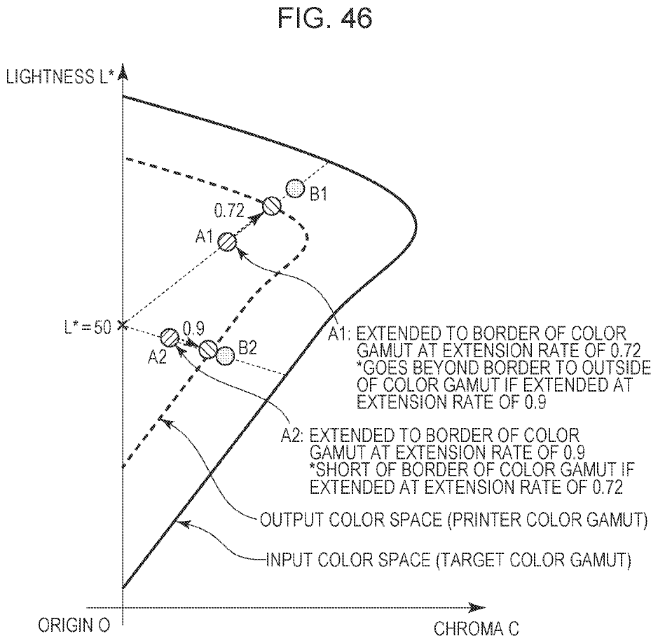

By using the example illustrated in FIG. 46, a supplementary explanation of the above description will be given below. The available extra extension margin of a point A1 for extension up to the border of the color gamut is an extension rate 0.72 for a vector A1B1. The available extra extension margin of a point A2 for extension up to the border of the color gamut is an extension rate 0.9 for a vector A2B2. For example, in a case where the minimum value, 0.72, is taken as the dynamic extension rate, the color at the point A1 is extended up to the border of the color gamut, and it is thus possible to enhance color matching while making the maximum use of the printer color gamut within a range of not sacrificing gradation property. The color at the point A2 is extended toward the point B2 to enhance color matching; however, since there is an available extra extension margin of 0.9 thereat, the extension is up to an inner point short of the border of the color gamut. If, for example, 0.9, which is greater than 0.72, is taken as the dynamic extension rate, the color at the point A1 is extended beyond the border to the outside of the printer color gamut because of the extension exceeding its available extra extension margin 0.72. For this reason, fine adjustments by gamut mapping from the outside of the color gamut to the inside of the color gamut using a post-processing output profile are needed. Alternatively, a limitation is imposed on the available extension rate 0.72 at the point A1 to avoid the extension beyond the border to the outside of the printer color gamut. As a result of this, though it is possible to enhance color matching at the point A1, in a case where there are surrounding colors, the colors of the extension destination cling to the border of the color gamut, resulting in a slight decrease in gradation property. The color at the point A2 is extended up to the border of the color gamut, and it is thus possible to enhance color matching while making the maximum use of the printer color gamut within a range of not sacrificing gradation property. In a case where the dynamic extension rate is determined at the minimum value or the maximum value, etc. as in the present embodiment, a frequency distribution is unnecessary and, therefore, S1403 may be skipped.

In S1405, based on the extension vector of each grid point calculated in S1401 and based on the dynamic extension rate determined in S1404, the color profile generation unit 305 extends the importance-on-gradation-property mapping color of each grid point and generates an extension LUT.

$$\vec{OC} = \vec{OA} + \vec{AC} = \vec{OA} + dynamite extension rate \times \vec{AB} \qquad ( 10 )$$

In the above formula, O denotes the coordinate origin, A denotes the importance-on-gradation-property mapping color of each grid point, B denotes the target color of each grid point, and C denotes the importance-on-color-impression-match mapping color of each grid point. Depending on the dynamic extension rate used in the formula (10) and depending on the grid point, there is a case where the extension is performed up to the outside of the printer color gamut; therefore, in a case where the dynamic extension rate>the static extension rate of the grid point, a limitation may be imposed by the static extension rate of the grid point. In a case where the dynamic extension rate>the static extension rate of the grid point, the limitation is imposed such that the dynamic extension rate of the grid point=the static extension rate of the grid point. In other cases, the dynamic extension rate of the grid point=the dynamic extension rate.

As shown in the formula (11) below, the importance-on-color-impression-match mapping color point C may be calculated through internally-dividing-point calculation of two points.

$$( 11 )$$

$$\vec{OC} = ( 1. - dynamic extension rate ) \times \vec{OA} + dynamic extension rate \times \vec{OB}$$

As explained above, an information processing apparatus according to the present embodiment suppresses an amount of color degeneracy in accordance with an input content gamut. By this means, it is possible to generate a dynamic mapping table that achieves both color matching and gradation property of colors that are continuous from the outside of a color gamut to the inside of the color gamut.

### Fourth Embodiment

In the third embodiment described above, as illustrated in FIG. 15, it is assumed that the importance-on-gradation-property mapping color point A, the target-color point B, and the importance-on-color-impression-match mapping color point C lie on the same vector. In a case where these points lie on the same vector, an equation of the vector AB=the distance a+the distance b holds; therefore, an equation of the vector AC=the extension rate×the vector AB, which underlies the formula (8) in S1401, and an equation of the vector AC=the dynamic extension rate×the vector AB, which underlies the formula (10) in S1405, hold. By this means, it is possible to calculate the importance-on-color-impression-match mapping color point C within the printer color gamut by adding the extension rate×the vector AB or the dynamic extension rate×the vector AB to the point A of the degenerated color.

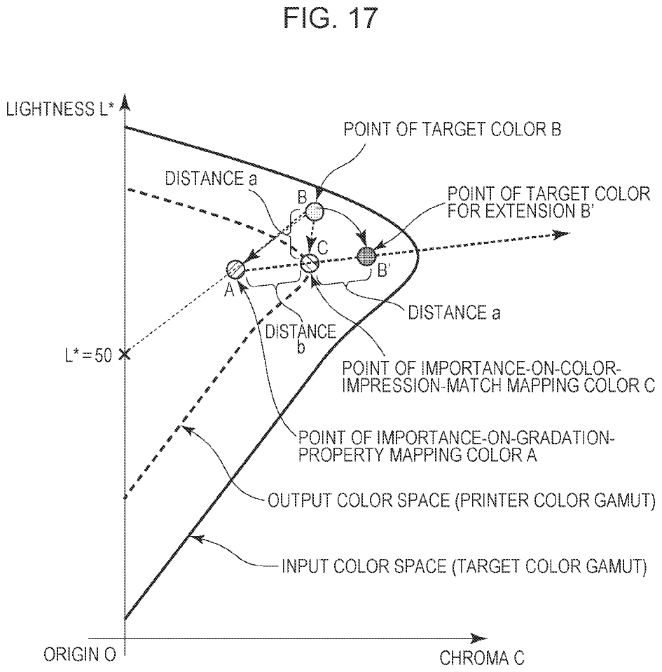

However, in a case where the points A, B, and C lie on different vectors as illustrated in FIG. 17, the vector AB≠the distance a+the distance b; therefore, the vector AC≠the extension rate×the vector AB.

If the calculation expressed by the formula (8) and the formula (10) is performed under this condition, the point A of the degenerated color will be extended in a direction of the vector AC and to a point that is not the point C placing the greatest importance on an impression match in colors.

In view of the above, the present embodiment makes it possible to calculate appropriate static extension information also in a case where the importance-on-gradation-property mapping color point A, the target-color point B, and the importance-on-color-impression-match mapping color point C lie on different vectors. The hardware configuration and functional configuration of an information processing apparatus according to the present embodiment are the same as those of the first embodiment; therefore, an explanation thereof is omitted. Differences between the present embodiment and the first embodiment will be mainly described below. The same reference signs will be assigned to the same components as those of the first embodiment in the description below.

### Color Profile Generation Processing

FIG. 17 illustrates an LC plane at a certain hue in an LCH space. The vertical axis of the graph represents lightness L*, and the horizontal axis thereof represents chroma C. For the importance-on-color-impression-match mapping color point C, in FIG. 15 described earlier, the mapping destination is determined in a direction toward L*=50. In FIG. 17, for example, the mapping is performed to a point that minimizes the color difference ΔE from the target-color point B within the printer color gamut. In this case, since the direction of the vector AB is different from the direction of the vector AC, it is impossible to calculate the vector AC by multiplying the vector AB by the extension rate as expressed by the following formula (12).

$$\vec{OC} \neq \vec{OA} + \vec{AC} = \vec{OA} + extension rate \times \vec{AB} \qquad ( 12 )$$

Therefore, in the present embodiment, in S1401, the color profile generation unit 305 generates a target-color point for extension B′ along the vector AC while keeping the distance a, which is the size of a vector BC, unchanged for the target-color point B, and generates an extension vector AB′. The generation of the extension vector AB′ is performed using the following formulas (13), (14), and (15).

$$\vec{{OB}^{′}} = \vec{OA} + \vec{{AB}^{′}} = \vec{OA} + gain rate \times \vec{AC} \qquad ( 13 )$$

$$Gain rate = ( distance a + distance b ) / distance b \qquad ( 14 )$$

$$\vec{{AB}^{′}} = \vec{{OB}^{′}} - \vec{OA} \qquad ( 15 )$$

“Distance a=0 and distance b #0” represents a mapping color that is, though within the printer color gamut, degenerated while taking mapping of a color that is not within the printer color gamut in importance-on-gradation-property mapping into consideration, and its gain is 1.0 according to the formula (14). The target-color point for extension B′ may be calculated by performing externally-dividing-point calculation of two points that are the importance-on-gradation-property mapping color point A and the importance-on-color-impression-match mapping color point C. The externally-dividing-point calculation is performed using the following formula (16).

$$\vec{{OB}^{′}} = ( - distance b \times \vec{OA} + ( distance a + distance b ) \times \vec{OC} ) / distance b \qquad ( 16 )$$

“Distance b=0” means that, in addition to being zero division, the color is already an importance-on-color-impression-match mapping color, and thus there is no more available extra extension margin, and it is treated as an exception. Specifically, when the distance b=0, the importance-on-gradation-property mapping color point A is identical to the importance-on-color-impression-match mapping color point C and, therefore, the vector AC does not exist; accordingly, in this case, the target-color point for extension B′ is not generated.

In the exception processing of the distance b=0, a case of the distance a>0 (not within the printer color gamut) and a case of the distance a=0 (within the printer color gamut) are treated as different exceptions. In the present embodiment, in S1401, in a case where the distance b=0, irrespective of the value of the distance a, the color profile generation unit 305 deems that the color is already an importance-on-color-impression-match mapping color and the extension rate is thus 1.0; however, this does not imply any limitation. In one of embodiments to be described later, the case where the distance a=0 and the distance b=0 is excluded from the scope of calculation of the extension rate, whereas the extension rate is deemed as 1.0 in a case where the distance a>0 and the distance b=0.

As explained above, in the present embodiment, in S1401, in a case where there is an available extra extension margin (the distance b>0), the color profile generation unit 305 generates the target-color point for extension B′ in a direction of the vector AB′ that is in alignment with the vector AC while maintaining the extension rate. In addition, the color profile generation unit 305 calculates the vector AC by multiplying the vector AB′ by the extension rate as expressed by the formula (17).

$$\vec{OC} = \vec{OA} + \vec{{AB}^{′}} = \vec{OA} + extension rate \times \vec{{AB}^{′}} \qquad ( 17 )$$

The importance-on-color-impression-match mapping color point C may be calculated through internally-dividing-point calculation of two points by using the formula (18).

$$\vec{OC} = ( 1. - extension rate ) \times \vec{OA} + extension rate \times \vec{{OB}^{′}} \qquad ( 18 )$$

In S1405, based on the extension vector of each grid point calculated in S1401 and based on the dynamic extension rate determined in S1404, the color profile generation unit 305 extends the importance-on-gradation-property mapping color of each grid point and generates an extension LUT. The generation of the extension LUT is performed using the formula (19).

$$\vec{OC} = \vec{OA} + \vec{AC} = \vec{OA} + dynamic extension rate \times \vec{{AB}^{′}} \qquad ( 19 )$$

In the above formula, O denotes the coordinate origin, A denotes the importance-on-gradation-property mapping color of each grid point, B′ denotes the target color for extension of each grid point, and C denotes the importance-on-color-impression-match mapping color of each grid point. Depending on the dynamic extension rate used in the formula (19) and depending on the grid point, there is a case where the extension is performed up to the outside of the printer color gamut; therefore, in a case where the dynamic extension rate>the static extension rate of the grid point, a limitation may be imposed by the static extension rate of the grid point. In a case where the dynamic extension rate>the static extension rate of the grid point, the limitation is imposed such that the dynamic extension rate of the grid point=the static extension rate of the grid point. In other cases, the dynamic extension rate of the grid point=the dynamic extension rate.

As shown in the formula (20), the importance-on-color-impression-match mapping color point C may be calculated through internally-dividing-point calculation of two points.

$$( 20 )$$

$$\vec{OC} = ( 1. - dynamic extension rate ) \times \vec{OA} + dynamic extension rate \times \vec{{OB}^{′}}$$

By this means, it is possible to extend the importance-on-gradation-property mapping color point A to the importance-on-color-impression-match mapping color point C.

Since the limitation that the mapping color point A, the target-color point B, and the mapping color point C lie on the same vector is eliminated here, the mapping color point A is not limited to an importance-on-gradation-property mapping color point but may be an importance-on-chroma mapping color point or a relative-color-difference-minimizing mapping color point. Therefore, for example, the following configuration may be adopted. In a case where “Perceptual” is set in the color intent area 455, the mapping color point A is set as an importance-on-gradation-property mapping color point, and it is aimed to achieve both placing an importance on gradation property and placing an importance on an absolute impression match in colors in accordance with the content. In a case where “Saturation” is set in the color intent area 455, the mapping color point A is set as an importance-on-chroma mapping color point, and it is aimed to achieve both placing an importance on chroma and placing an importance on an absolute impression match in colors in accordance with the content. In a case where “Colorimetric” is set in the color intent area 455, the mapping color point A is set as an importance-on-relative-color-match mapping color point, and it is aimed to achieve both placing an importance on a relative color match and placing an importance on an absolute impression match in colors in accordance with the content.

As explained above, an information processing apparatus according to the present embodiment suppresses an amount of color degeneracy in accordance with an input content gamut. By this means, it is possible to generate a dynamic mapping table that achieves both the designated intent feature and color matching.

### Fifth Embodiment

The color profile generation unit 305 according to the third embodiment determines a single dynamic extension rate for content and generates an extension LUT. As described earlier, usually, an input color space and an output color space are not spheres, and an amount of color degeneracy differs depending on a coordinate position in the color space because mapping according to hue, lightness, and chroma is performed. In view of this, in the present embodiment, a color impression match according to content is realized by changing a dynamic extension rate depending on a position in a color space.

The hardware configuration and functional configuration of an information processing apparatus according to the present embodiment are the same as those of the first embodiment; therefore, an explanation thereof is omitted. Differences between the present embodiment and the first embodiment will be mainly described below. The same reference signs will be assigned to the same components as those of the first embodiment in the description below.

### Color Profile Generation Processing

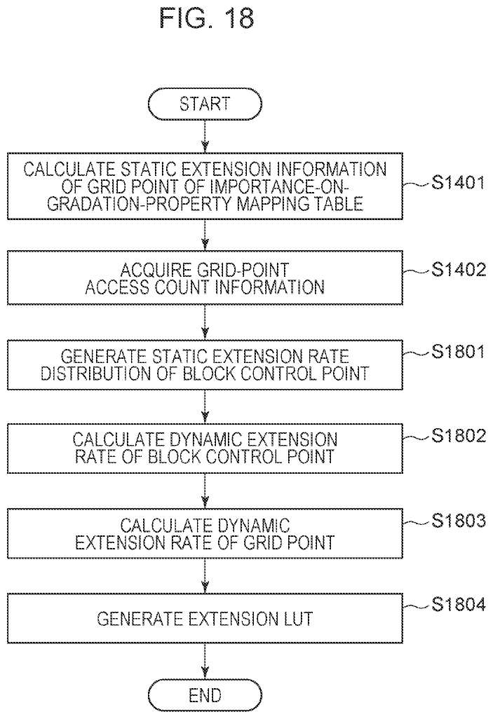

FIG. 18 is a flowchart illustrating the flow of dynamic generation processing of a 3DLUT according to the present embodiment. The processing illustrated in FIG. 18 is implemented by reading a program out of the ROM 102 into the RAM 103 and running the read program by the CPU 101. Since the processing in S1401 and S1402 is the same as that of the third embodiment, an explanation thereof is omitted. In S1801, the color profile generation unit 305 performs block division of a color space and sets block control points. In addition, the color profile generation unit 305 acquires a block number of a block to which each grid point belongs. Though it is assumed in the present embodiment that an input RGB color space is block-divided, this does not imply any limitation. The color space that is block-divided may be a L*a*b* color space of a target color or a color space in which an L*a*b* value is converted into LCH, HLS, or the like using a known calculation formula. A specific method of the block division will be described later. Then, based on the block number of each grid point, based on the static extension rate of the grid points calculated in S1401, and based on the grid-point access count information acquired in S1402, the color profile generation unit 305 generates a grid-point access distribution for each block.

In the present embodiment, as described earlier with reference to FIGS. 15 and 17, the case of the distance a=0 (within the printer color gamut) and the distance b=0 (no more available extra extension margin) in mapping at a grid point is excluded from the scope of extension rate calculation because it means that the target color is maintained (reproduced). In the case of the distance a>0 (not within the printer color gamut) and the distance b=0 (no more available extra extension margin), the target color is already an importance-on-color-impression-match mapping color, though not reproducible within the printer color gamut. Therefore, it is impossible to increase a degree of color impression match any more; accordingly, this case is treated as a case of an extension rate of 1.0.

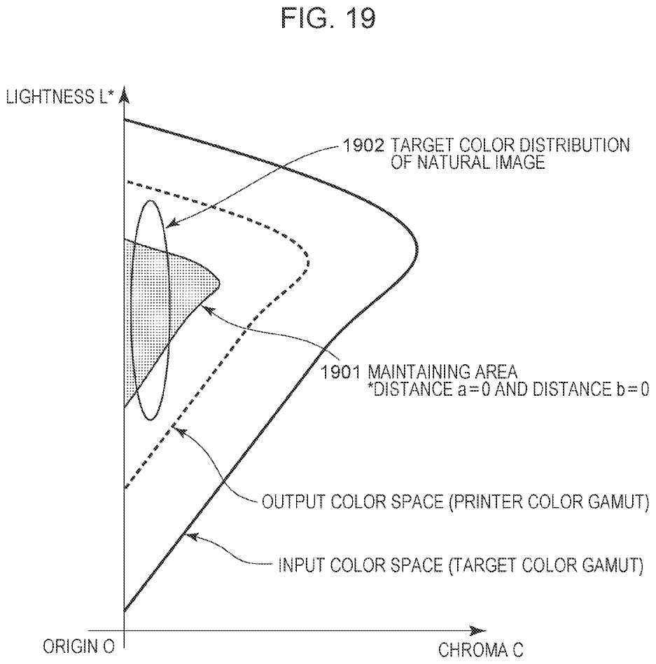

With reference to FIG. 19, a supplementary explanation will be given below of excluding the case of the distance a=0 (within the printer color gamut) and the distance b=0 (no more available extra extension margin) from the scope of extension rate calculation. A color gamut such as a target color gamut or a printer color gamut is a space that spreads outward from the center of the color gamut. In gamut mapping, basically, a target color in an outside color gamut that is not reproducible by a printer is degenerated toward the center of the color gamut. When this color degeneracy is performed, if perceptual mapping is employed, as indicated by halftone-dot illustration in FIG. 19, in many cases, a maintaining area 1901 where the target color is maintained and outputted without being degenerated is provided near the center of the printer color gamut. As described here, even when the printer color gamut is narrow, by providing an area where the target color is maintained, color degeneracy is performed such that an entire color balance of a natural image is retained. The maintaining area according to the present embodiment is an area where the equation of the distance a=0 (within the printer color gamut) and the distance b=0 (no more available extra extension margin) holds. Since the maintaining area is an area without degeneracy, determining the dynamic extension rate while excluding the maintaining area 1901 makes it possible to further increase the degree of color impression match. For example, in a case where the target color distribution of a natural image is a distribution 1902, the dynamic extension rate for the natural image is determined solely using the color-degenerated color distribution outside the maintaining area 1901, with the maintaining area 1901 excluded.

In S1802, based on the distribution information of the static extension rate of each block generated in S1801, the color profile generation unit 305 determines the dynamic extension rate at the block control point of each block. In the present embodiment, the static extension rate indicated by the minimum value in the distribution of the static extension rate of the block is taken as the dynamic extension rate, but is not limited thereto. A median value may be taken, or, based on a non-illustrated screen setting value, a percentile value of the distribution in the block whose dynamic extension rate is determined may be set, or a one-dimensional conversion table for adjusting the dynamic extension rate of the block of calculation may be set for each block. The dynamic extension rate may be configured to be adjustable according to the attribute information.

Since a change in appearance when extension at the same rate is performed is perceived more intensely in a red hue than in a green hue and is perceived more intensely in white and black than in an intermediate brightness color, these adjustments may be configured to be variable from one division block to another. Moreover, the maximum distance a (the maximum not-within-gamut distance) of accessed grid points and the maximum distance b (the maximum available extra extension margin) thereof may be calculated for each block, and the adjustments may be performed on the basis of the maximum distance a and the maximum distance b for the following reasons. The longer the not-within-gamut distance is, the greater the need for placing an importance on gradation property by increasing the degeneracy rate and decreasing the degree of color match is at the block. The greater the available extra extension margin is, the less likely the gradation property will deteriorate at the block even when the extension rate is increased to increase the degree of color match. As described here, in the present embodiment, it is possible to adjust parameters used for calculating the dynamic extension rate or adjust the calculated dynamic extension rate on a block-by-block basis.

In S1803, based on the coordinates of the block control points generated in S1801 and based on the dynamic extension rate calculated in S1802, the color profile generation unit 305 calculates the dynamic extension rate at each grid point through interpolation calculation from the block control points. In S1804, based on the extension vector of each grid point calculated in S1401 and based on the dynamic extension rate at each grid point calculated in S1803, the color profile generation unit 305 extends the importance-on-gradation-property mapping color of each grid point and generates an extension LUT. The generation of the extension LUT is performed using the formula (21).

$$( 21 )$$

$$\vec{OC} = \vec{OA} + \vec{AC} = \vec{OA} + dynamic extension rate at each grid point \times \vec{AB}$$

In the above formula, O denotes the coordinate origin, A denotes the importance-on-gradation-property mapping color of each grid point, B denotes the target color of each grid point, and C denotes the importance-on-color-impression-match mapping color of each grid point. The importance-on-color-impression-match mapping color point C may be calculated through internally-dividing-point calculation of two points by using the formula (22).

$$\vec{OC} = ( 1. - dynamic extension rate at each grid point ) \times \vec{OA} + dynamic extension rate at each grid point \times \vec{OB} \qquad ( 22 )$$

### Block Division Processing

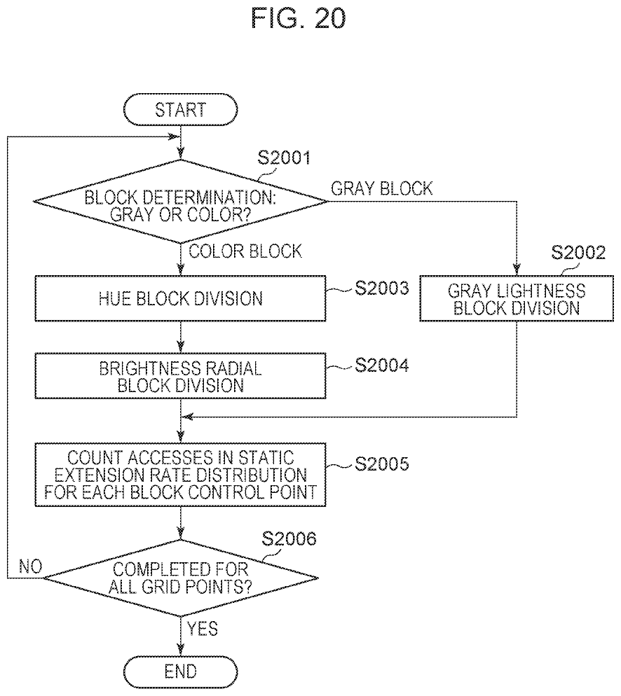

The color space block division performed by the color profile generation unit 305 in S1801 will now be described in detail while referring to the flowchart of FIG. 20. In gamut mapping, basically, degeneracy is performed from the outside of a printer color gamut toward the center of the printer color gamut. Therefore, in the present embodiment, to make it easier to obtain an extension effect, the division is performed in a block shape that takes a degeneracy direction (extension direction) into consideration. Moreover, in the present embodiment, the division is performed in a radial direction outward from the center of the color gamut.

The size, shape, white point, and black point of a printer color gamut change in various ways depending on the color material used and the medium used. In addition, since color degeneracy is performed in gamut mapping, various target colors L*a*b* exist depending on use cases. In order to perform block division while taking a degeneracy direction (extension direction) into consideration in an L*a*b* color space, there is a need to change L*a*b* division coordinates depending on the degeneracy direction (extension direction) changing according to the target color gamut and the printer color gamut. This is complex. In view of this, in the present embodiment, the block division is performed while taking the center coordinates in an RGB color space as the degeneracy direction. An RGB color space is, for example, a color space having a value range of 8-bit signals from 0 to 255 and is not a color gamut; therefore, it is possible to determine block division coordinates without being influenced by the target color gamut and the printer color gamut. The target color L*a*b* to which a signal in the RGB color space corresponds and the mapping color L*a*b* onto the printer color gamut change according to the target color gamut and the printer color gamut. Performing the block division while taking the center coordinates in the RGB signal space as the degeneracy direction achieves the block division taking the degeneracy direction (extension direction) changing according to the target color gamut and the printer color gamut into consideration as viewed in an L*a*b* color space corresponding to the RGB coordinates.

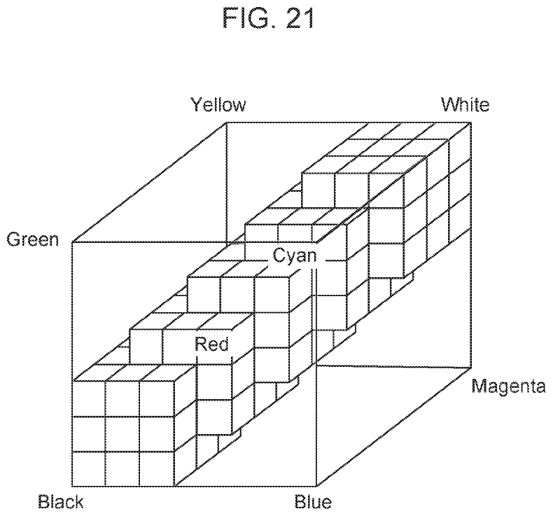

The processing illustrated in FIG. 20 is implemented by reading a program out of the ROM 102 into the RAM 103 and running the read program by the CPU 101. In S2001, the color profile generation unit 305 determines whether the grid point is a grid point of a gray block or a grid point of a color block. In a case where the grid point of interest is determined to be a grid point of a gray block, the process proceeds to S2002. In a case where the grid point of interest is determined to be a grid point of a color block, the process proceeds to S2003. In the present embodiment, as illustrated in FIG. 21, grid points on a gray axis where R=G=B, and grid points located adjacent thereto, are determined each as a grid point of a gray block. However, this does not imply any limitation.

In S2002, the color profile generation unit 305 performs block division of a gray block in a lightness direction and sets gray lightness block control points. Then, the color profile generation unit 305 identifies a gray lightness block to which the grid point determined as a grid point of a gray block in S2001 belongs. In a gray block, for the purpose of performing interpolation calculation based on control points to be described later, there is a need to generate two gray lightness block control points (white block and black block) at a white point (255, 255, 255) and a black point (0, 0, 0). Therefore, the division is performed on at least two gray lightness blocks.

In the present embodiment, the block is determined as a white block if the G signal of the grid point is greater than 127.5, or as a black block if not. Then, the process proceeds to S2005. Though the gray block has only block information of a gray lightness block in the present embodiment, the process may proceed to S2003 to have block information of a hue block and block information of a brightness radial block to be described later.

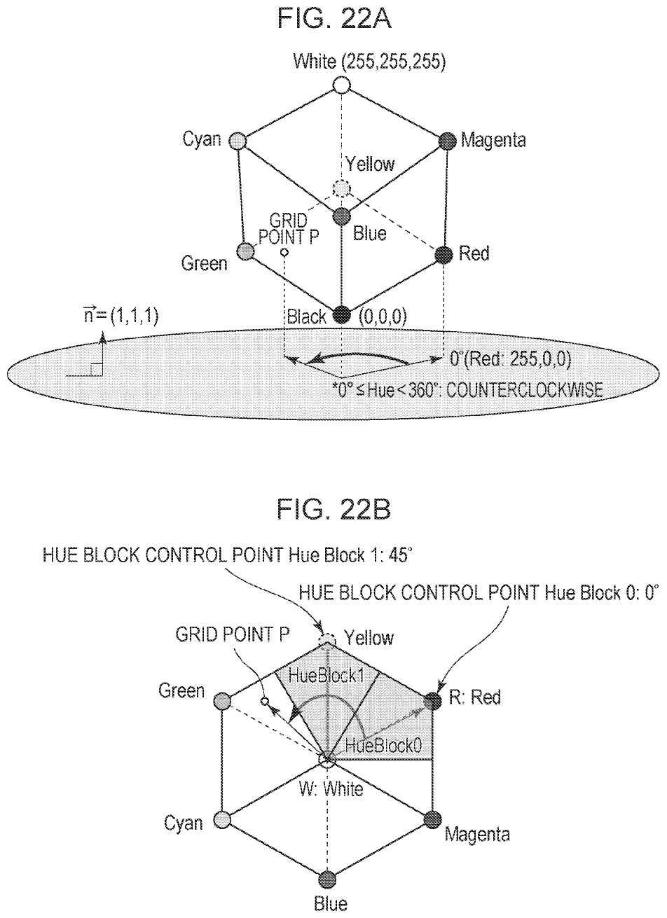

In S2003, the color profile generation unit 305 performs block division of a color block in a hue direction and sets hue block control points. Then, the color profile generation unit 305 identifies a hue block to which the grid point determined as a grid point of a color block in S2001 belongs. The color profile generation unit 305 transforms a cube that represents RGB color space coordinates illustrated in FIG. 22A into a hue plane illustrated in FIG. 22B by performing projection from White (255, 255, 255) toward Black (0, 0, 0) indicating the lightness direction. In the present embodiment, a vector WR connecting the white point to the red point is defined as a hue angle 0°, and an angle formed by two vectors, specifically, a vector WP connecting the white point to a grid point P and the vector WR, is defined as a hue angle (0°≤hue angle<360°).

For the purpose of controlling the degeneracy rate (extension rate) for the primary colors (R/G/B/C/M/Y) of the RGB color space, the RGB color space is divided into sixths such that the primary colors lie at the centers of the hue block control points. In the present embodiment, for division into sixths in the hue direction, the block division is performed at angular intervals of 60° (360°/6), and a hue block control point is set at a position shifted by 30°, which is a half of the block pitch, from the start angle position of each block. In the present embodiment, the hue block whose hue block control point lies at the hue angle 0° is defined as Hue Block 0.

A color material other than C, M, Y, and K is used in some instances, and, accordingly, the printer color gamut may be further divided in order to trace a shape that has an available extra extension margin. The number of segments in the division is an integer multiple of six in order to control the degeneracy rate (extension rate) for the primary colors, but is not limited thereto. Since the angular range of each hue block and the hue angle of the grid point P are known by performing the above processing, it is possible to identify the block number of the hue block to which the grid point P belongs.

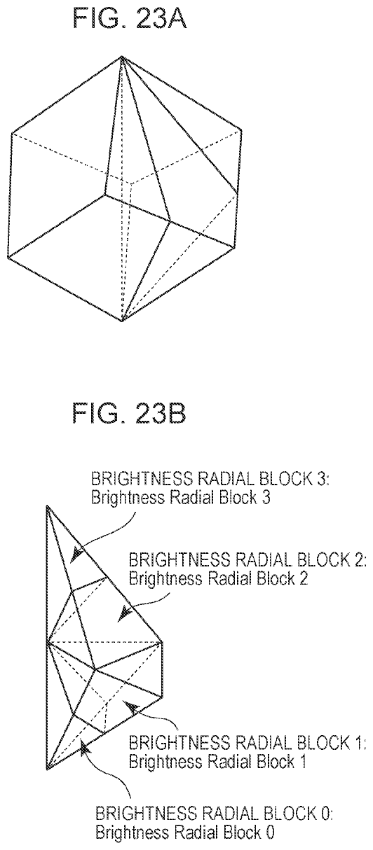

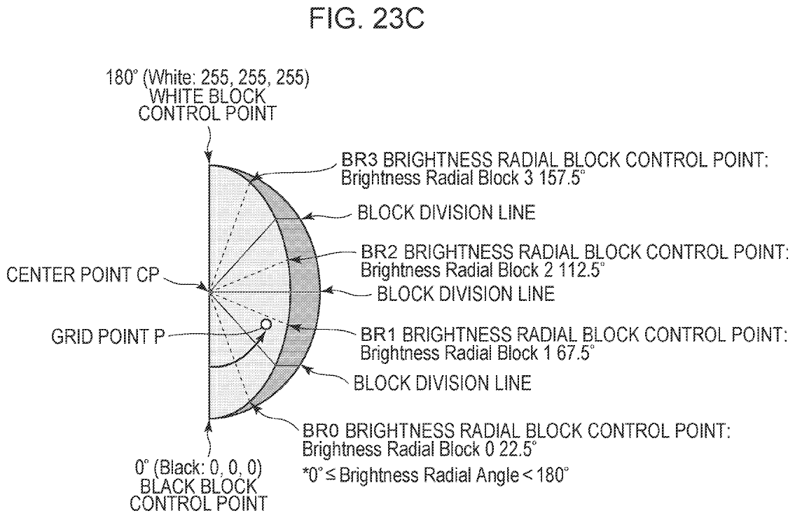

In S2004, the color profile generation unit 305 further performs block division of each hue block in a brightness radial direction and sets brightness radial block control points. Then, the color profile generation unit 305 identifies a brightness radial block to which the grid point determined as a grid point of a color block in S2001 belongs. FIG. 23A illustrates a cube that represents RGB color space coordinates. A hue block obtained by dividing the cube in the hue direction is illustrated in FIG. 23B. Block division is performed on the hue block illustrated in FIG. 23B in a brightness radial direction. In this example, the hue block whose hue block control point lies at the hue angle 0°, namely, Hue Block 0, is extracted, and the block division is performed on this Hue Block 0 in the brightness radial direction. In the present embodiment, the number of segments in the block division in the brightness radial direction is four, but is not limited thereto.

Without a simplification of the three-dimensional shape illustrated in FIG. 23B, it would not be easy to understand the positions of brightness block division lines and control points. Accordingly, a description will be given while assuming that a round hue block illustrated schematically in FIG. 23C is block-divided in the brightness radial direction. In the present embodiment, a vector CP Black connecting the center point CP (127.5, 127.5, 127.5) and Black (0, 0, 0) is defined at a brightness radial angle 0°. A vector CP White connecting the center point CP (127.5, 127.5, 127.5) and White (255, 255, 255) is defined at a brightness radial angle 180°. An angle formed by two vectors, specifically, a vector CPP connecting the center point CP (127.5, 127.5, 127.5) to a grid point P and the vector CP Black, is defined as a brightness radial angle (0°≤brightness radial angle <180°).

The highlight side and the dark side are areas of small color-gamut size, and, if the dynamic extension rate is controlled by setting hue-by-hue control points, there is a possibility of disrupting a color balance significantly. Therefore, for the 0-degree point and the 180-degree point of the brightness radial angle, the white block control point and the black block control point calculated in S2002, not the control point for each hue block, are used. In the present embodiment, for division into quarters in the brightness radial direction, the block division is performed at angular intervals of 45° (180°/4), and a brightness radial block control point is set at a position shifted by 22.5°, which is a half of the block pitch, from the start angle position of each block. In the present embodiment, the brightness radial block whose brightness radial block control point lies at the brightness radial angle 22.5° is defined as Brightness Radial Block 0. As explained above, since the angular range of each brightness radial block and the brightness radial angle of the grid point P are known, it is possible to identify the block number of the brightness radial block to which the grid point P belongs.

Through the process/ing in S2002, S2003, and S2004 described above, the block to which the grid point belongs is determined. If the block is a gray block, it is either one of the white block and the black block. If the block is a color block, two block numbers, namely, the hue block number and the brightness radial block number, are determined. In S2005, the color profile generation unit 305 performs access counting for the static extension rate on a block-by-block basis. Specifically, at the block to which the grid point belongs, based on the static extension rate of the grid point calculated in S1401, and based on the grid-point access count information acquired in S1402, the color profile generation unit 305 performs access counting for the static extension rate of the block.

In S2006, the color profile generation unit 305 determines whether or not the processing from S2001 to S2005 has been performed for all of the grid points that constitute the RGB color space. If there is any yet-to-be-processed grid point, the process returns to S2001 to perform the processing. In a case where the processing has finished for all of the grid points, the access distribution of the input image for the static extension rate distribution of the block control points of all of the blocks is determined, and the frequency distribution illustrated in FIG. 16 is generated for each of the blocks.

### Interpolation Method Using Block Control Points

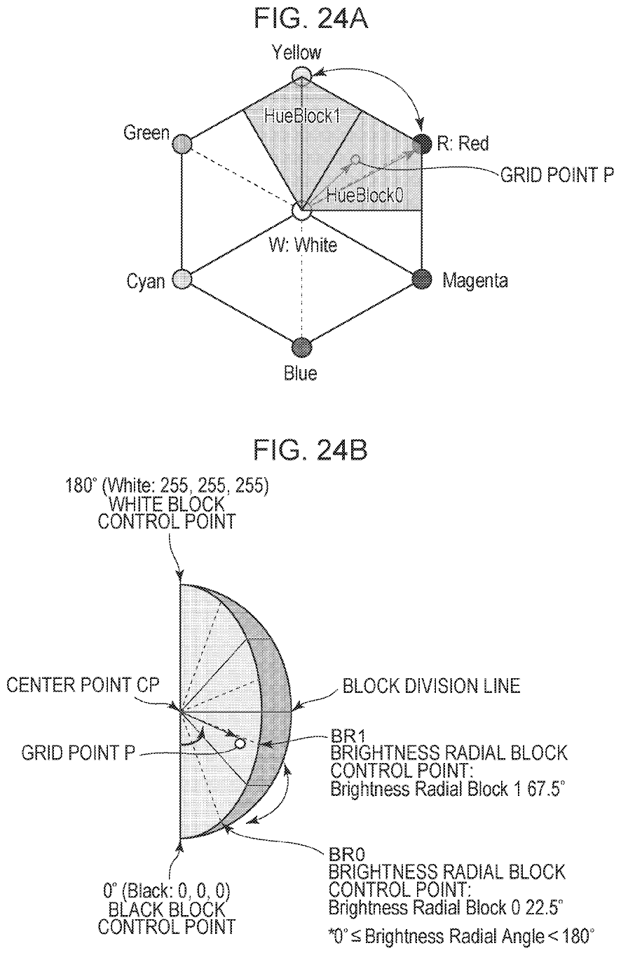

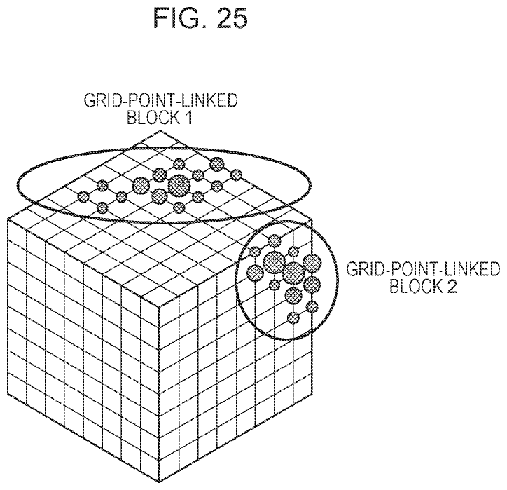

With reference to FIG. 24, a detailed description will now be given of a method for interpolation performed by the color profile generation unit 305 in S2005 by using block control points for calculating a dynamic extension rate of a grid point. A grid point P illustrated in FIG. 24A has a hue angle between a hue block control point Yellow and a hue block control point Red, and, as illustrated in FIG. 24B, has a brightness radial angle between a brightness radial block control point BR0 and a brightness radial block control point BR1. Therefore, after interpolation is performed in the hue direction as illustrated in FIG. 24A, interpolation is performed in the brightness radial direction as illustrated in FIG. 24B, thereby calculating a grid-point dynamic extension rate at the grid point P.

First, the color profile generation unit 305 calculates a dynamic extension rate of a hue angle of the grid point P at the brightness radial angle BR0. Specifically, the color profile generation unit 305 calculates the dynamic extension rate of the hue angle of the grid point P at the brightness radial angle BR0 through interpolation processing using the dynamic extension rate held at hue block control point Yellow and the dynamic extension rate held at hue block control point Red. The ratio in the interpolation processing is set on the basis of the difference in hue angle between the grid point P and the hue block control point. Using the same method, the color profile generation unit 305 calculates a dynamic extension rate of a hue angle of the grid point P at the brightness radial angle BR1. Then, the color profile generation unit 305 calculates the dynamic extension rate at the grid point P through interpolation processing using the calculated dynamic extension rate at the brightness radial angle BR0 and the calculated dynamic extension rate at the brightness radial angle BR1.

As explained above, an information processing apparatus according to the present embodiment calculates a dynamic extension rate depending on a position in a color space. By this means, it is possible to generate a dynamic mapping table that realizes a further enhanced color impression match according to content.

### Variation Example

In the present embodiment, a further enhanced color impression match is realized by performing block division of a color space and calculating a dynamic extension rate for each block. However, the method of calculating a dynamic extension rate depending on a position in a color space is not limited to block division. As illustrated in FIG. 25, in a case where neighboring grid points are access grid points, grid-point linkage may be performed to generate grid-point-linked blocks, and a further enhanced color impression match may be realized by calculating a dynamic extension rate for each grid-point-linked block.

### Sixth Embodiment

In the first embodiment described earlier, based on attribute information generated by the attribute information generation unit 307 and based on color setting for each attribute information, an importance-on-color-impression-match color profile is generated. In the present embodiment, depending on attribute information, it is switched whether to treat each individual object as an independent object or to treat the objects as one object group. By this means, it is possible to generate an importance-on-color-impression-match color profile that is optimal as a page or a job. The hardware configuration and functional configuration of an information processing apparatus according to the present embodiment are the same as those of the first embodiment; therefore, an explanation thereof is omitted. Differences between the present embodiment and the first embodiment will be mainly described below. The same reference signs will be assigned to the same components as those of the first embodiment in the description below.

### Color Profile Generation Processing

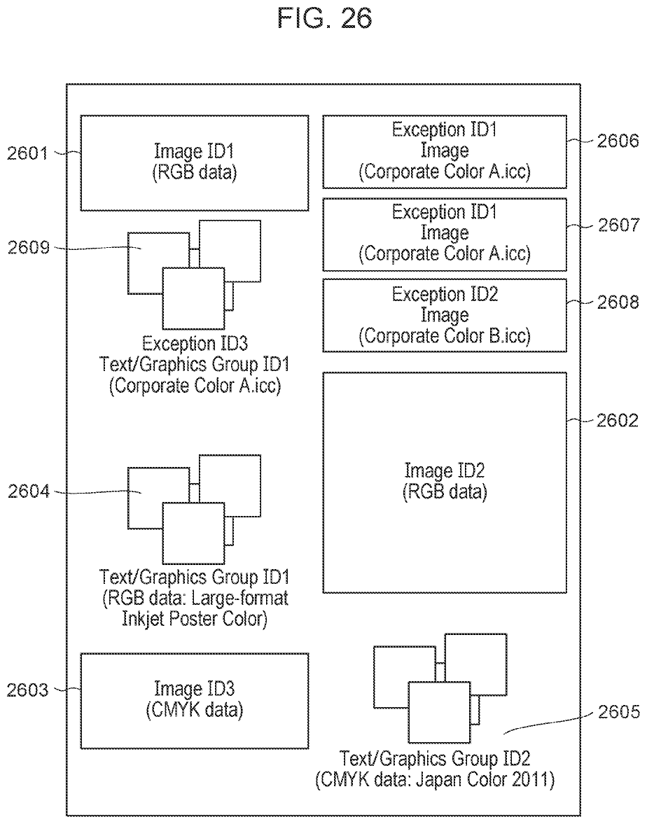

With reference to FIG. 26, processing will now be described in detail. An image ID number is assigned to each of image objects 2601, 2602, and 2603. For each image ID number, the color profile generation unit 305 generates an importance-on-color-impression-match color profile corresponding to the color gamut of the object. By this means, it is possible to optimize gradation property and color impression matching for each image object.

Text/Graphics objects, if their target color is identical in pages or a job, are grouped as text/graphics object groups 2604 and 2605, to each of which a text/graphics group ID number is assigned. For each text/graphics group ID number, the color profile generation unit 305 generates an importance-on-color-impression-match color profile corresponding to the colors of the object group. By this means, it is possible to optimize color discriminability and color impression matching about colors among the text/graphics objects having the same target color in the page or the job.

With regard to settings at the exception embedded profile area 458, a description is given below separately for a case of an exception image object and a case of an exception text/graphics object. As for exception image objects 2606, 2607, and 2608, an exception ID number is assigned to each designated embedded profile. For each exception ID number of the exception image objects, the color profile generation unit 305 generates an importance-on-color-impression-match color profile corresponding to the color gamut of the object. In a case where there is a plurality of exception image objects having the same exception ID number, the importance-on-color-impression-match color profile is generated for the first one of these exception image objects, and the same importance-on-color-impression-match color profile is looked up for the second and subsequent execution. The exception image objects having the same exception ID number may be grouped as one exception image object group, and the importance-on-color-impression-match color profile may be generated correspondingly to the color gamut of the object group.

Text/Graphics objects are grouped as an exception text/graphics object group 2609 in pages or a job for each designated embedded profile, and an exception ID number is assigned thereto. For each exception ID number of the exception text/graphics object groups, the color profile generation unit 305 generates an importance-on-color-impression-match color profile corresponding to the colors of the object group. The importance-on-color-impression-match color profile is generated for the text/graphics object group on the first page, and, if there is the same ID number on the second and subsequent pages, the same importance-on-color-impression-match color profile is looked up.

In the present embodiment, different ID numbers are assigned to the exception image object 2606, 2607 and the exception text/graphics group object 2609 even with the same exceptional embedded profile. However, the method of assigning ID numbers is not limited to this example. For example, in a case of the same embedded profile, grouping into one ID number may be performed so as to enhance color matching, irrespective of object attributes. By this means, for an enterprise logo, etc. that includes a corporate color for which color matching among pages and/or among objects is used, it is possible to optimize color impression matching about exception objects while maintaining color matching among the pages and/or among the objects.

As explained above, an information processing apparatus according to the present embodiment is configured to, depending on attribute information, switch whether to treat each individual object as an independent object or to treat the objects as one object group. By this means, it is possible to generate an importance-on-color-impression-match color profile that is optimal as a page or a job.

### Variation Example

The method of generating an importance-on-color-impression-match color profile depending on attribute information may be any one of methods described in other embodiments or a combination of two or more thereof. The method of generating an importance-on-color-impression-match color profile may be switchable depending on attribute information.

### Seventh Embodiment

A typical example of a method for mapping a not-within-gamut color into the color gamut is replacement with a color that minimizes a color difference CIE76 defined by a Euclidean distance in a CIE-L*a*b* color space. However, it is known that a color-difference-minimizing point according to related-art color-difference formulae is not necessarily optimal as the destination of the mapping. It is known that, as one of the reasons for this, there is a tendency that it is difficult to distinguish a difference in chroma for a high-chroma color in a CIE-L*a*b* color space. Moreover, it is also known that, even when the same color difference is given, a color with a change in hue tends to be more likely to be recognized as a different color in terms of color impression than with a change in chroma or with a change in lightness.

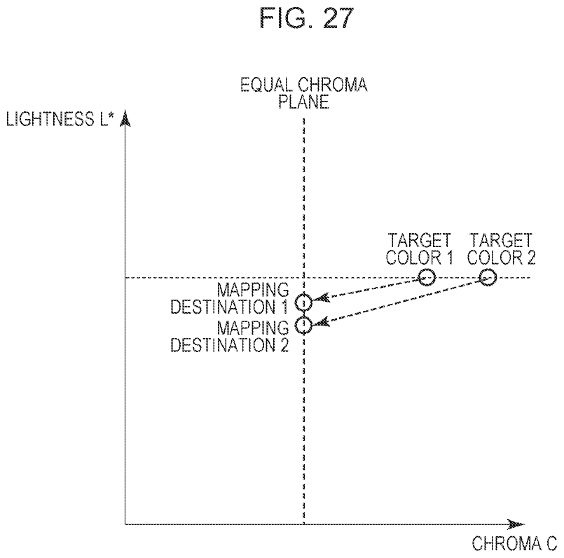

Furthermore, as a result of a subjective evaluation experiment, the inventors of this patent application newly discovered that a color with slightly lower lightness tends to be more likely to be perceived as a color that is close to the target color than a color whose lightness is equal to that of the target color when the color is mapped into a lower-chroma color gamut. FIG. 27 is a schematic view illustrating a relationship between target colors and mapping destinations. For each of two target colors having equal lightness and equal hue, each subject of the experiment was asked to choose a color that is close to the target color in terms of impression from among those in a color patch group of equal chroma. In this case, as illustrated in FIG. 27, it was found that lower lightness tends to be chosen for the target color having higher chroma. When color patches with equal lightness and different chroma are compared with each other, the patch with lower chroma looks paler in a color-diluted manner. For this reason, it is inferred that, by slightly lowering the lightness of the patch with lower chroma in a direction of looking deeper, or in other words, by compensating for a decrease in chroma by means of lightness, the two patches are perceived to be of approximately the same color depth.

In the present embodiment, processing of mapping onto a color that is close to the target color in terms of impression is performed while taking the above tendency into consideration. The hardware configuration and functional configuration of an information processing apparatus according to the present embodiment are the same as those of the first embodiment; therefore, an explanation thereof is omitted. Differences between the present embodiment and the first embodiment will be mainly described below. The same reference signs will be assigned to the same components as those of the first embodiment in the description below.

### Color Profile Generation Processing

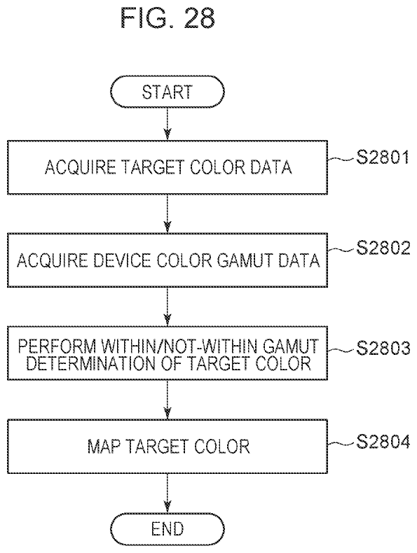

FIG. 28 is a flowchart illustrating the flow of dynamic generation processing of a 3DLUT according to the present embodiment. The processing illustrated in FIG. 28 is implemented by reading a program out of the ROM 102 into the RAM 103 and running the read program by the CPU 101. The mapping table generated in the present embodiment is a mapping table for performing colorimetric mapping.

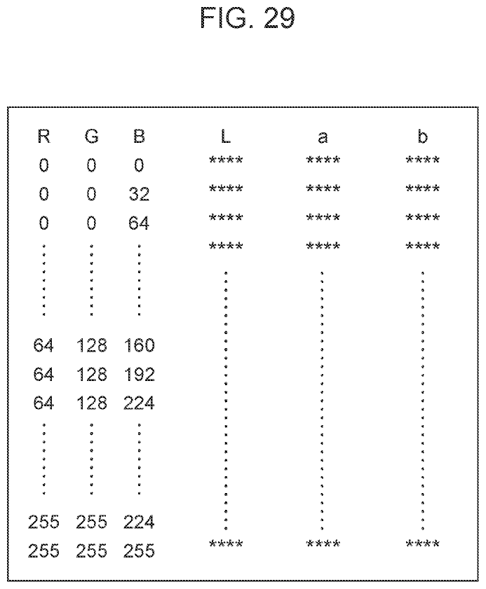

In S2801, the color profile generation unit 305 acquires target color data L*a*b*target. The target color data L*a*b*target is data that represents a corresponding relationship between RGB values defined in a sRGB color space and L*a*b* values. FIG. 29 is a diagram illustrating an example of a data format of target color data. The target color data is data that describes RGB values of grid points obtained by 9-slicing the range of 0≤R, G, B≤255 and target L*a*b* values corresponding to the RGB values, as illustrated in FIG. 29.

In S2802, the color profile generation unit 305 acquires device color gamut data L*a*b*dev. The device color gamut data L*a*b*dev is data that represents L*a*b* values expressed by an output device correspondingly to grid-point data of input signal values RGB. The data format of the device color gamut data is the same as that of the target color data illustrated in FIG. 29. Specifically, the device color gamut data is data that describes RGB values of grid points obtained by 9-slicing the range of 0≤R, G, B≤255 and colorimetric values obtained by inputting the RGB values into the output device. That is, the device color gamut data is data obtained from the colorimetric result of a printed matter outputted by the output device by supplying RGB values of grid points to the output device as patch data.

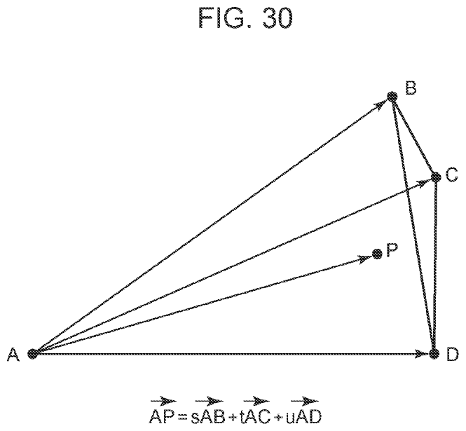

In S2803, for each color of the target color data L*a*b*target, the color profile generation unit 305 determines whether or not it is within the color gamut of the output device. The color gamut of the output device is expressed using 729 grid points, that is, 512 hexahedrons. Therefore, the within/not-within color-gamut determination can be performed by determining whether or not the value of the target color data L*a*b*target is included in any of the 512 hexahedrons formed by the device color gamut data L*a*b*dev. In the present embodiment, the hexahedron is further divided into six tetrahedrons, and the within/not-within color-gamut determination is performed using these tetrahedrons. FIG. 30 is a diagram for explaining within/not-within color-gamut determination using a tetrahedron. As illustrated in FIG. 30, vertices of the tetrahedron are defined as A, B, C, and D, and an input value is defined as P. Given these definitions, a relationship among these points can be expressed by the following formula (23).

$$\vec{AP} = s \vec{AB} + t \vec{AC} + u \vec{AD} \qquad ( 23 )$$

When the point P is included in the tetrahedron ABCD, the following formulas (24) and (25) hold.

$$s + t + u \leq 1 \qquad ( 24 )$$

$$s \geq 0 , t \geq 0 , u \geq 0 \qquad ( 25 )$$

Therefore, in a case where the formulas (24) and (25) hold, the color profile generation unit 305 determines that the point P is included in the tetrahedron ABCD. By performing the above tetrahedral within/not-within color-gamut determination for six tetrahedrons, it is possible to perform within/not-within color-gamut determination for a certain hexahedron. Then, by performing the above hexahedral within/not-within color-gamut determination for 512 hexahedrons, the within/not-within determination of the output color gamut for each value of the target color data L*a*b*target finishes.

In S2804, the color profile generation unit 305 calculates a mapping destination L*a*b*mapped of the value of the target color data L*a*b*target determined to be not within the color gamut in the within/not-within determination in S2803. The value of the target color data L*a*b*target is directly substituted into the mapping destination of the value of the target color data L*a*b*target determined to be within the color gamut, and no mapping is performed in substance for it. For the mapping destination L*a*b*mapped, the value of L*a*b*surface that minimizes the color difference from the target color data L*a*b*target by the color-difference formulae according to the present embodiment is selected out of surface L*a*b* data corresponding to the surface of the device color gamut data.

### Surface L*a*b* Data

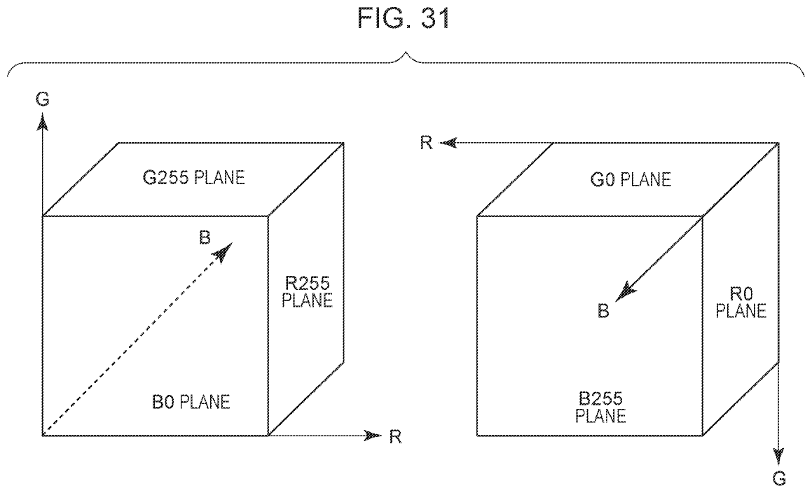

Data corresponding to the surface of an output color gamut has a value of 0 or 255 at any one of RGB. That is, the surface is classified into six surfaces, which are, as illustrated in FIG. 31, a surface of R=255 (R255 plane), a surface of G=255 (G255 plane), a surface of B=255 (B255 plane), a surface of R=0 (R0 plane), a surface of G=0 (G0 plane), and a surface of B=0 (B0 plane). Each plane is made up of 81 grid points, that is, 128 triangle patches. The color profile generation unit 305 acquires values of L*a*b*surface corresponding to vertices of the triangle patches.

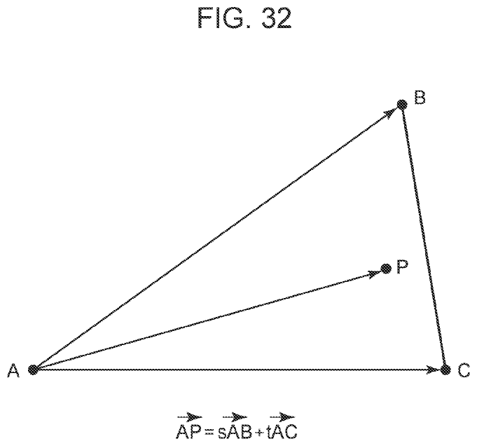

Furthermore, as illustrated in FIG. 32, the vertices of each triangle patch are defined as A, B, and C, and surface L*a*b* data of P interpolated according to predetermined search accuracy are generated. In this case, the following formulas (26), (27), and (28) hold. For example, by division of each of s and t into tenths, it is possible to search for a color-difference-minimizing point from among one hundred points per two triangle patches.

$$\vec{AP} = s \vec{AB} + t \vec{AC} \qquad ( 26 )$$

$$s + t \leq 1 \qquad ( 27 )$$

$$s \geq 0 , t \geq 0 \qquad ( 28 )$$

### Color-Difference Formulae

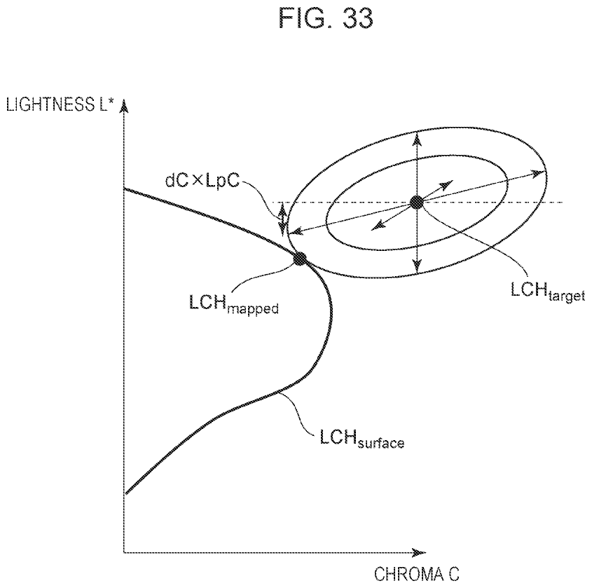

FIG. 33 is a diagram for explaining color-difference formulae according to the present embodiment. Even when at an equal distance from the target color in a CIE-L*a*b* color space, that is, even with the same color difference CIE76, an impression distance perceived by a human differs depending on in which direction of lightness, chroma, and hue the color is away therefrom. In the color-difference formulae according to the present embodiment, a color difference is calculated using an ellipsoid with a sensitivity adjustment in each direction of LCH. The ellipsoid is inclined with shearing applied in the lightness direction, thereby mimicking characteristics that slightly low lightness is preferred for low chroma.

The color profile generation unit 305 calculates a color difference between the value of target color L*a*b*target and the value of surface L*a*b* data that is the target of the search. Specifically, first, the color profile generation unit 305 converts the value of the target color L*a*b*target and the value of the surface L*a*b* data from an orthogonal coordinate system into LCH values in a cylindrical coordinate system. The conversion into the LCH values is performed in accordance with the following formulas (29) and (30).

$$C = \sqrt{{a}^{* 2} + {b}^{* 2}} \qquad ( 29 )$$

$$H = {tan}^{- 1} \frac{{b}^{*}}{{a}^{*}}$$

Next, the color profile generation unit 305 calculates sensitivity rL, IC, rH in each direction of LCH in the neighborhood of the value of the target color LCHtarget and a lightness correction coefficient LpC through interpolation processing using a pre-stored parameter table. FIG. 34 is a diagram illustrating an example of the parameter table. In the parameter table, the parameters rL, rC, rH, and LpC corresponding to the hue Htarget and the chroma Ctarget of the target color LCHtarget are stored.

The color profile generation unit 305 calculates a color difference dE on the basis of the following formulas (31), (32), (33), and (34).

$$dC = Ctarget - Csurface \qquad ( 31 )$$

$$dH = Htarget - Hsurface \qquad ( 32 )$$

$$dL = ( Ltarget - Lsurface ) + dC \times LpC \qquad ( 33 )$$

$$dE = \sqrt{{( \frac{dL}{rL} )}^{2} ⋆ {( \frac{dC}{rC} )}^{2} + {( \frac{dH}{rH} )}^{2}} \qquad ( 34 )$$

With reference to FIG. 33, a relationship among L*a*b*target, L*a*b*surface, and the parameters rL, rC, rH, and LpC will now be described. Among the points of the surface L*a*b* data, the point L*a*b*mapped, which minimizes the color difference in the color-difference formulae described above, is the surface L*a*b* data that becomes tangential to the ellipsoid first when the diameter of the ellipsoid whose center lies at the target color L*a*b*target is increased. The ellipsoid has its center at the target color L*a*b*target and a diameter ratio specified by the parameters rL, rC, and rH in the respective directions of LCH. In addition, the ellipsoid has an inclination specified by the parameter LpC. The parameters rL, rC, and rH correspond to numerically-expressed obtuseness in sensitivity in each direction. The ellipsoid has its major axis in the direction of obtuseness in sensitivity. In other words, the surface of the ellipsoid can be treated as a surface of an equal impression distance from the target color.

Through the above processing, it is possible to generate, as a mapping table (color profile), information that specifies a relation between an input RGB value and the value of the mapping destination L*a*b*mapped for the input RGB value. The colorimetric table generated in the present embodiment can be used as a colorimetric table in other embodiments. Though a linear inclination is applied to a chroma difference in the lightness direction in the color-difference formulae for an ellipsoidal shape in the present embodiment, other functions that represent a curve in such a way as to adjust a lightness correction amount according to an amount of a chroma difference may be used. An inclination in the direction of hue H may be applied according to a hue curve in a CIE-L*a*b* color space.

As explained above, an information processing apparatus according to the present embodiment generates a colorimetric table configured to, when a not-within-gamut color is mapped into the color gamut, map the color having relatively high chroma onto a relatively low lightness destination. By this means, it is possible to perform processing of mapping onto a color that is close to the target color in terms of impression.

### Eighth Embodiment

In the seventh embodiment described above, a colorimetric table for mapping the target color that is not within the color gamut of a device onto a point of a better impression match is generated. On the other hand, for a perceptual table, a method of performing compression with setting of a convergence point is often used; although gradation property and color discriminability are guaranteed, in related art, it could happen that the target color that is not within the color gamut of a device is not mapped onto a point that is close thereto in terms of impression. In the present embodiment, in view of this, a perceptual table that achieves an improved color impression matching for a color that is not within the color gamut is generated. The hardware configuration and functional configuration of an information processing apparatus according to the present embodiment are the same as those of the first embodiment; therefore, an explanation thereof is omitted. Differences between the present embodiment and the first embodiment will be mainly described below. The same reference signs will be assigned to the same components as those of the first embodiment in the description below.

### Color Profile Generation Processing

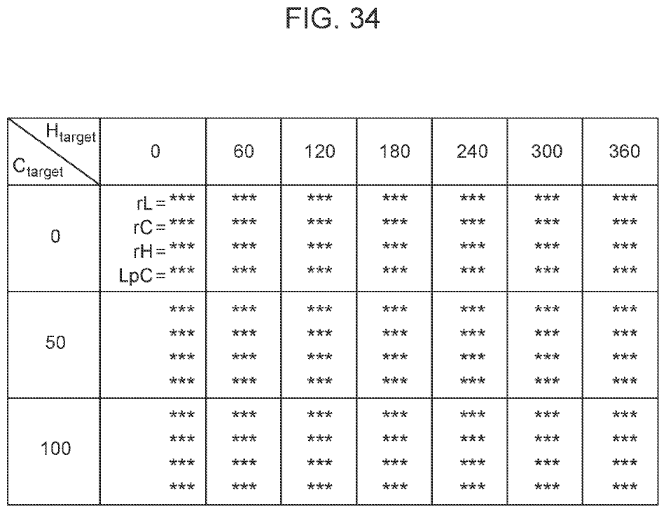

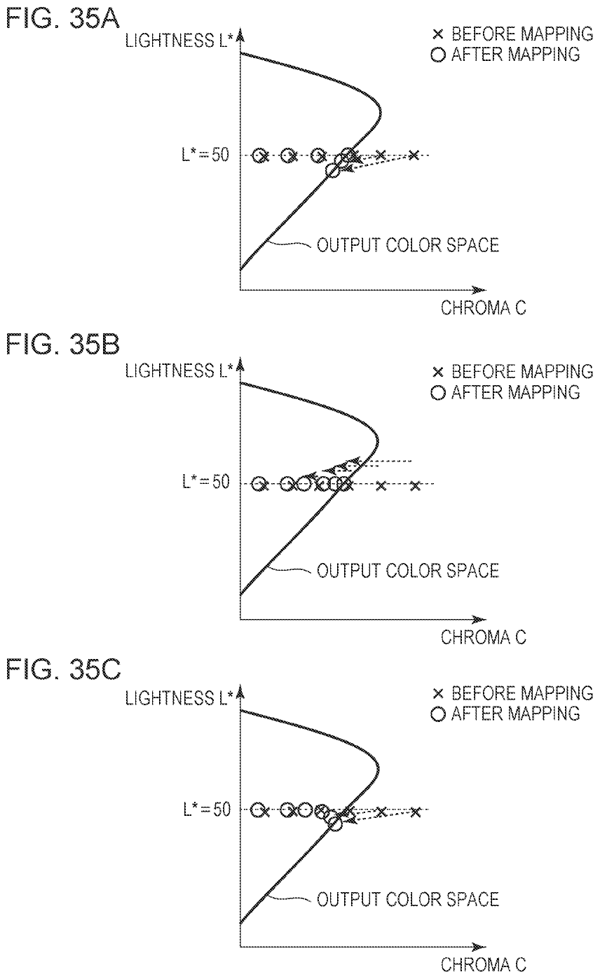

FIGS. 35A, 35B, and 35C are schematic views illustrating the features of a mapping table generated in the present embodiment. FIG. 35A illustrates the colorimetric table described above in the seventh embodiment. FIG. 35B illustrates a perceptual table according to which a convergence point is set at L*=50, a*=0, and b*=0. As described above, the colorimetric table illustrated in FIG. 35A increases the degree of color impression match by performing mapping onto a destination of relatively low lightness as it goes away from the target color. When the convergence-type perceptual table illustrated in FIG. 35B is employed, mapping is performed onto a destination that lies on a line connecting the target color and the convergence point; therefore, the degree of color impression match with the target color having high chroma is sometimes insufficient.

In view of this, the color profile generation unit 305 synthesizes the two tables illustrated in FIGS. 35A and 35B, thereby generating a perceptual table that achieves both gradation property and impression matching for a not-within-gamut color. The perceptual table generated in the present embodiment is illustrated in FIG. 35C. Specifically, in accordance with the following formulas (35), the color profile generation unit 305 generates the perceptual table by using the L*a*b* value of each grid point of the two tables.

$$L *= ( 1 - R ) \times L * colorimetric + R \times L * perceptual \qquad ( 35 )$$

$$a *= ( 1 - R ) \times a * colorimetric + R \times a * perceptual$$

$$b *= ( 1 - R ) \times b * colorimetric + R \times b * perceptual$$

In the above formulas, R denotes a blend ratio, which can be set arbitrarily depending on desired gradation property, desired color discriminability, and the like.

As explained above, an information processing apparatus according to the present embodiment synthesizes the colorimetric table described in the seventh embodiment with the perceptual table according to which a convergence point is set. By this means, it is possible to generate a mapping table that achieves all of not-within-gamut-color impression matching, gradation property, and color discriminability. The perceptual table generated in the present embodiment can be used as a perceptual table in other embodiments.

### Ninth Embodiment

Depending on an observation environment, it could happen that a color of a printed matter perceived by an observer does not agree with a colorimetric value measured using a colorimeter. First, the reason why a colorimetric value measured using a general colorimeter differs from an appearance of a color in an actual observation environment will now be described.

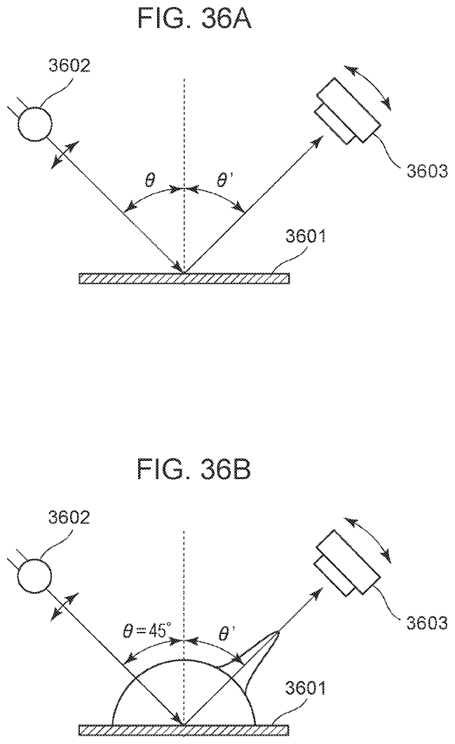

FIGS. 36A and 36B illustrate measurement of gonio-photometric reflection characteristics. As information that represents gonio-photometric reflection characteristics of an object, BRDF (Bidirectional Reflectance Distribution Function) is known. BRDF is a function that specifies intensity of reflected light in relation to an emission angle (reflection angle) when light is applied at a certain angle. The measurement of gonio-photometric reflection characteristics is performed by, as illustrated in FIG. 36A, emitting light from an illuminating light source 3602 disposed at a light-emitting angle θ toward a printed matter 3601 and measuring the intensity of reflected light coming from the printed matter 3601 by using a light receiver 3603 disposed at a light-receiving angle θ′. In the measurement of gonio-photometric reflection characteristics, multi-angle measurement of reflection intensity can be performed by making the light-emitting angle θ and the light-receiving angle θ′ variable.

FIG. 36B illustrates the measurement of gonio-photometric reflection characteristics of a sheet of general gloss paper. The measurement of reflection intensity performed while varying the light-receiving angle θ′ from −90° to +90°, with the light-emitting angle θ fixed at 45°, is illustrated in FIG. 36B. The light coming from the illuminating light source 3602 is reflected off the printed matter 3601, indicating high reflection intensity in a specular reflection direction. The reflection intensity in the specular reflection direction will be hereinafter referred to as specular reflection intensity. On the other hand, in directions other than the specular reflection direction, the printed matter 3601 exhibits reflection intensity that is less than the specular reflection intensity. The reflection intensity in directions other than the specular reflection direction will be hereinafter referred to as diffused reflection intensity.

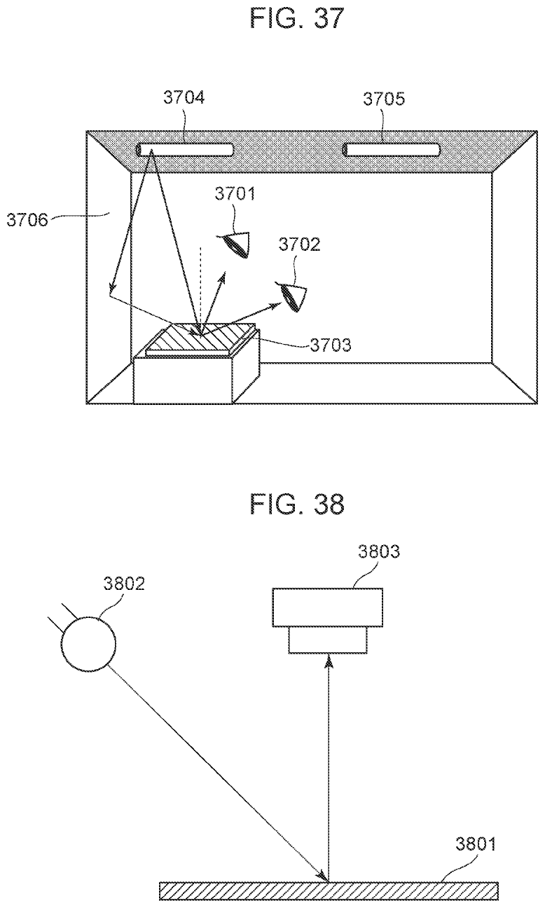

With reference to FIG. 37, light received by an eye(s) of an observer from a printed matter placed in a general observation environment will now be described. In FIG. 37, an observation position 3701 is located in the specular reflection direction of a ceiling light 3704, and light with an illumination image on a printed matter 3703 (specular reflection light) comes to the eye of the observer.

The observer cannot recognize the color of the printed matter 3703 if the specular reflection light is too intense. Therefore, the observer moves to an observation position 3702, at which the specular reflection light does not enter the eye, from the observation position 3701, and then sees the printed matter 3703.

There is a wall 3706 at a specular-reflection-direction position corresponding to a positional relationship between the observation position 3702 and the printed matter 3703. The light coming from the ceiling light 3704 is diffusion-reflected off the wall 3706 and then reaches the printed matter 3703. The diffused reflection light coming from the wall 3706 is reflected off the printed matter 3703 and is then received by the eye of the observer as specular reflection light in accordance with its specular reflection characteristics. However, the diffused reflection light coming from the wall 3706 is less intense than light that comes directly from the ceiling light 3704 to the printed matter 3703 and thus does not make it impossible to recognize the color of the printed matter 3703 at the observation position 3702. On the other hand, light coming from various directions other than the specular reflection direction, for example, light coming from another ceiling light 3705, also reaches the printed matter 3703. The light coming from these other directions is reflected off the printed matter 3703 and is then received by the eye of the observer as diffused reflection light in accordance with its diffused reflection characteristics.

That is, the light received by the eye of the observer includes the specular reflection light that is a reflection of the light coming from the specular reflection direction and being reflected off the printed matter 3703 in accordance with its specular reflection characteristics and the diffused reflection light that is a reflection of the light coming from directions other than the specular reflection direction and being reflected off the printed matter 3703 in accordance with its diffused reflection characteristics. Therefore, the appearance of the color of the printed matter 3703 depends on the diffused reflection light and the specular reflection light that are received by the eye of the observer, and is significantly influenced by the light coming from the wall located at the specular-reflection-direction position and the non-specular-reflection-direction light. However, since diffuse reflectivity of a dark area of an image is far less than a bright area of the image, the influence of the light coming from the wall located at the specular-reflection-direction position is dominant thereat.

FIG. 38 illustrates measurement of spectral reflectivity. As illustrated in FIG. 38, in a colorimeter, an illuminating light source 3802 is disposed in a direction of an incidence angle of 45° with respect to a printed matter 3801, and light emitted from the illuminating light source 3802 and then reflected off the printed matter 3801 is received by a light receiver 3803 disposed in a direction of a reflection angle of 0°. The light received by the light receiver 3803 of a general colorimeter is diffused reflection light only of the printed matter 3801, meaning that specular reflection light in accordance with the specular reflection characteristics of the printed matter 3801 is not measured. Consequently, it could happen that a color represented by a colorimetric value of a general colorimeter does not agree with the color of the printed matter 3801 perceived actually by an observer.

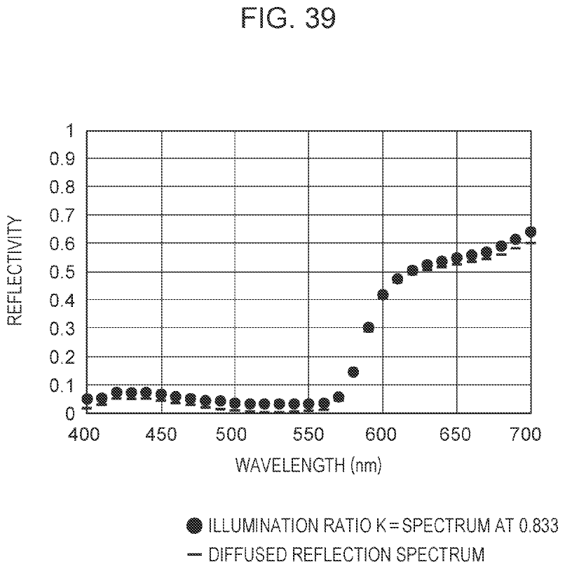

FIG. 39 illustrates an example of a diffused reflection spectrum and an appearance spectrum including specular reflection light. The horizontal axis of the graph represents wavelength, and the vertical axis thereof represents reflectivity. In the graph, the short-bar-like sign denotes an example of a diffused reflection spectrum, and the black-circle-like sign denotes an example of an appearance spectrum including specular reflection light. The data illustrated in FIG. 39 is corrected data whose reflectivity is corrected using a reference board of perfect diffusion white. In the data illustrated in FIG. 39, a specular-versus-diffused illumination ratio K to be described later, which indicates a ratio between specular reflection light and diffused reflection light, is K=0.833. As can be seen from FIG. 39, the lightness is high because the reflectivity is high, that is, it looks light. In addition, one can see from calculating L*a*b* values using visibility characteristics on this spectrum that the chroma is low and that not only the degree of lightness but also color reproducibility change.

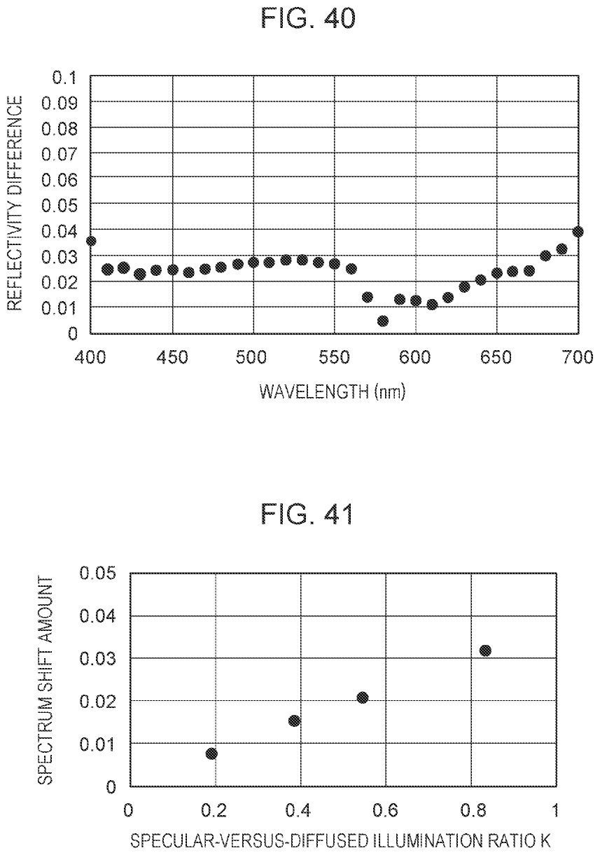

FIG. 40 illustrates a difference between an appearance spectrum and a diffused reflection spectrum. This difference data shows the influence of specular reflection light on the appearance spectrum. In actual measurement data, the difference tends to be large at a border portion between an absorption wavelength band and a non-absorption wavelength band. Since stable data can be obtained when a comparison is made in an absorption wavelength band, it is better to use difference data of reflectivity in the absorption wavelength band. Illustrated in FIG. 41 is a visualized result of measurement of the difference data of reflectivity conducted under several environment conditions of the specular-versus-diffused illumination ratio K in this case. As the specular-versus-diffused illumination ratio K increases, so does a spectrum shift amount. A coefficient that represents a slope of a spectrum shift amount will be hereinafter referred to as “spectrum shift coefficient”. Though a difference in hue of a color material is unlikely to cause a difference in this slope, a difference in glossiness of paper in an ink-jet recording scheme is likely to cause a difference in this slope. Moreover, a difference arises if the recording scheme used is a scheme in which glossiness changes due to a change in type and/or amount of a color material used according to hue. Furthermore, in an electrophotographic recording scheme, also in a case where glossiness changes due to a difference in recording process speed, a difference in slope of a spectrum shift amount arises.

Therefore, spectrum shift amounts in relation to the specular-versus-diffused illumination ratio K will be close to each other in a case of similar glossiness conditions, whereas, in a case where glossiness conditions are different from each other, spectrum shift amounts corresponding thereto respectively in relation to the specular-versus-diffused illumination ratio K will be obtained. That is, if the diffused reflection spectrum, the glossiness condition, and the specular-versus-diffused illumination ratio K are known, it is possible to predict the appearance spectrum of perception by the observer and thus to calculate the L*a*b* value of appearance.

In the present embodiment, processing is performed for, based on specular reflection characteristics and diffused reflection characteristics of a printed matter and based on lighting characteristics of an observation environment, predicting the color of the printed matter perceived by an observer, thereby forming the printed matter that is suited for the observation environment. The hardware configuration of an information processing apparatus according to the present embodiment is the same as that of the first embodiment; therefore, an explanation thereof is omitted. Differences between the present embodiment and the first embodiment will be mainly described below. The same reference signs will be assigned to the same components as those of the first embodiment in the description below.

### Functional Configuration of Control Apparatus

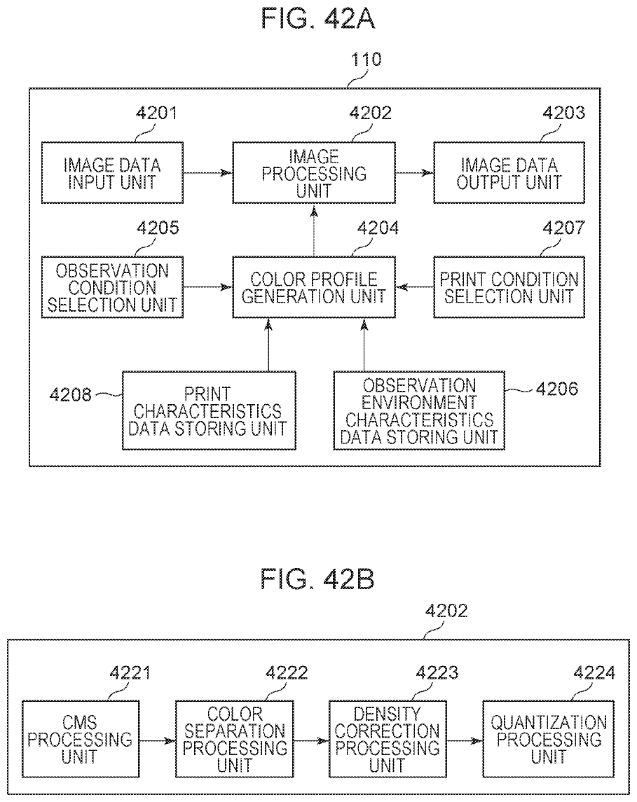

A functional configuration of the control apparatus 110 will now be described. FIG. 42A is a block diagram illustrating a functional configuration of the control apparatus 110 according to the present embodiment. The control apparatus 110 includes an image data input unit 4201, an image processing unit 4202, an image data output unit 4203, and a color profile generation unit 4204. The control apparatus 110 further includes an observation condition selection unit 4205, an observation environment characteristics data storing unit 4206, a print condition selection unit 4207, and a print characteristics data storing unit 4208.

The image data input unit 4201 inputs image data that is to be processed. The image processing unit 4202 performs image processing on the inputted image data. A functional configuration of the image processing unit 4202 is illustrated in FIG. 42B. The image processing unit 4202 includes a CMS processing unit 4221, a color separation processing unit 4222, a density correction processing unit 4223, and a quantization processing unit 4224. The CMS processing unit 4221 is a color management system (CMS) processing unit, and performs color matching processing on image data stored in a buffer while looking up a color profile. The CMS processing unit 4221 uses the color profile generated on the basis of an observation condition, diffused reflection characteristics data, and observation environment characteristics data by the color profile generation unit 4204. The color separation processing unit 4222 performs color separation processing on the color-matched image data while looking up a color separation table having been generated in advance. For example, if six-color recording materials of C, M, Y, K, Lc, and Lm are on the printer, RGB image data is color-separated into these six color types of recording-material data each indicating an amount of the corresponding recording material of C, M, Y, K, Lc, and Lm.

The density correction processing unit 4223 performs density correction processing on each recording-material data by using a correction table that is a one-dimensional lookup table (1DLUT). In the density correction processing, density correction is performed in such a way as to make the output characteristics of an image formed by each recording material linear in terms of density or linear in terms of lightness, for example, from paper white to the maximum density of each recording material. The quantization processing unit 4224 performs binarization of each density-corrected recording-material data by using binary processing such as an error diffusion method or a dither method.

The image data output unit 4203 outputs binary data for printing to the printer. Based on the observation condition selected by the observation condition selection unit 4205 and based on the print condition selected by the print condition selection unit 4207, the color profile generation unit 4204 generates a color profile.

Based on user instructions, the observation condition selection unit 4205 selects the observation environment of the printed matter. Specifically, in order to make the selection of the observation environment easier, easy-to-understand options such as “a windowless meeting room”, “an office environment”, “a bright table near a window” are presented to the user via a UI screen, thereby prompting the user to choose the observation environment. In order to realize high precision in color conversion, the observation condition may be configured to be settable on the basis of a measurement value of observation environment light. Other observation conditions (light-source type setting, color temperature setting, and the like) may be configured to be selectable so that the waveform-dependent components of specular reflection light can be calculated. Metamerism by light sources may be calculated on the basis of light-source spectrum information and a diffused reflection spectrum so that correction can be performed. The observation environment characteristics data storing unit 4206 stores plural types of light-source spectrum information and the specular-versus-diffused illumination ratio K in association with observation condition. The data stored by the observation environment characteristics data storing unit 4206 is read out by the color profile generation unit 4204 on the basis of the observation condition selected by the observation condition selection unit 4205 and is used for generating the color profile.

Based on user instructions, the print condition selection unit 4207 selects the print condition. The print condition is, for example, a printer type, a medium type, a process speed, etc. The print characteristics data storing unit 4208 stores diffused reflection characteristics data of a printed matter printed under a plurality of print conditions.

The diffused reflection characteristics data has been generated in advance by measuring the printed matter by using a known colorimeter. The diffused reflection characteristics of the printed matter are measured in such a manner that specular reflection light does not enter the light-receiving element. In general, the diffused reflection characteristics are measured at a light-emitting angle of 45° and a light-receiving angle of 0°, with the direction perpendicular to the sheet face defined as 0°. In a case where a measurement system is affected by specular reflection light due to surface irregularities of the sheet face though the system performs measurement at a light-emitting angle of 45° and a light-receiving angle of 0°, the specular reflection light may be weakened by using a polarizing filter (so-called M3) or the like. The print characteristics data storing unit 4208 stores a spectrum shift coefficient k for each print condition. The data stored by the print characteristics data storing unit 4208 is read out by the color profile generation unit 4204 on the basis of the print condition selected by the print condition selection unit 4207 and is used for generating the color profile.

### Color Profile Generation Processing

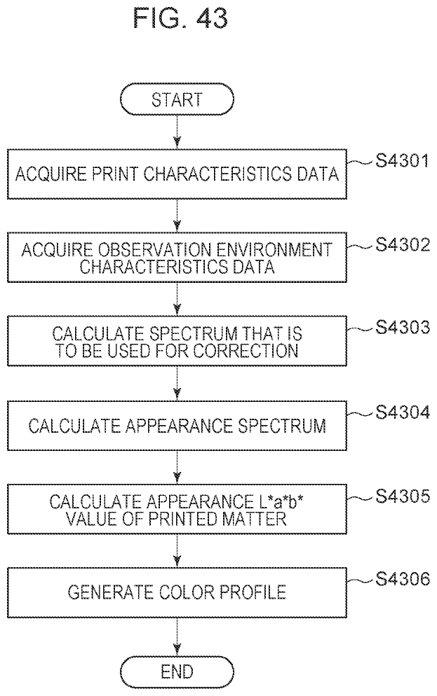

FIG. 43 is a flowchart illustrating the flow of dynamic generation processing of a 3DLUT according to the present embodiment. The processing illustrated in FIG. 43 is implemented by reading a program out of the ROM 102 into the RAM 103 and running the read program by the CPU 101.

In S4301, based on user instructions, the print condition selection unit 4207 selects the print condition. Based on the selected print condition, the color profile generation unit 4204 acquires the diffused reflection characteristics data of the printed matter and the spectrum shift coefficient k thereof from the print characteristics data storing unit 4208. The diffused reflection characteristics data represents a diffused reflection spectrum obtained by measuring the printed matter that includes patches of a plurality of colors (for example, 729 colors) by using the system with a light-emitting angle of 45° and a light-receiving angle of 0°. The measurement of the printed matter may be performed for the patches of all colors; alternatively, after the measurement is performed in a discrete manner, interpolation processing may be performed to acquire data of non-measured patch colors. The measurement of the printed matter may be performed for each combination of a color material and paper or may be performed for each combination of recording characteristics such as the process speed of the printer.

In S4302, based on user instructions, the observation condition selection unit 4205 selects the observation condition. Based on the selected observation condition, the color profile generation unit 4204 acquires the light-source spectrum information and the specular-versus-diffused illumination ratio K from the observation environment characteristics data storing unit 4206. The specular-versus-diffused illumination ratio K has been calculated in advance as a ratio of illumination intensity Y1 of diffused reflection light coming from the printed matter under the observation illumination conditions to illumination intensity Y2 of specular reflection light coming from the printed matter under the observation illumination conditions (Y1/Y2). In a case where the spectral characteristics of the diffused reflection light and the specular reflection light are negligible, it is possible to simplify the measurement and the arithmetic operation by using white light as the light source and using luminous intensity of the illumination as the intensity. A perfect diffuser panel, which reflects a very small amount of specular reflection components of light, may be preferably used for measuring the illumination intensity Y1 of the diffused reflection light. A mirror, which reflects a large amount of specular reflection components of light, may be preferably used for measuring the illumination intensity Y2 of the specular reflection light. The color profile generation unit 4204 may calculate the specular-versus-diffused illumination ratio K on the basis of the illumination intensity Y1 of the diffused reflection light and the illumination intensity Y2 of the specular reflection light. The specular-versus-diffused illumination ratio K depends on the intensity of illumination light coming from the ceiling of the observation environment, the intensity of illumination reflection from a wall surface, the luminous intensity of light coming from a window, and the like. Numerical examples of the specular-versus-diffused illumination ratio K are: 0.23 for a windowless meeting room, 0.40 for an office environment, and 0.29 for a table near a window. To support color-rendering properties of a known illuminating light source, the light-source spectrum may have been measured in advance.

In S4303, the color profile generation unit 4204 calculates a correcting spectrum that is to be used for correction and is to be added to the diffused reflection spectrum. Specifically, first, the color profile generation unit 4204 calculates a spectrum shift amount by using the spectrum shift coefficient k and the specular-versus-diffused illumination ratio K. Then, the color profile generation unit 4204 calculates the correcting spectrum by multiplying the light-source spectrum by the spectrum shift amount.

In S4304, the color profile generation unit 4204 calculates the appearance spectrum by adding the correcting spectrum to the diffused reflection spectrum. The calculation of the appearance spectrum is performed for each patch color. In S4305, the color profile generation unit 4204 calculates the L*a*b* value of appearance on the basis of the appearance spectrum by using a known method. In S4306, the color profile generation unit 4204 generates a color profile in which the RGB value of each patch is associated with the L*a*b* value of appearance.

The color profile generated by the color profile generation unit 4204 is stored by the control apparatus 110 and is used for color conversion of an input image. Specifically, the image data input unit 4201 acquires input image data that is the target of printing, and the image processing unit 4202 performs color conversion of an image represented by the input image data by using the generated color profile. The image data output unit 4203 outputs, to an output device such as a printer, data generated on the basis of the color-converted image.

As explained above, an information processing apparatus according to the present embodiment generates a color profile while taking the color of a printed matter perceived by an observer into consideration. By this means, it is possible to perform color conversion with a reduced difference in appearance between printed matters different from each other in terms of glossiness.

### Tenth Embodiment

When color setting for printing is performed or when printing is performed, in many cases, information about a detailed mapping rule (convergence vector components, etc.) having been used for generating a color profile is lost. For this reason, in related art, the user, when performing color setting for printing or when performing printing, cannot designate a color mapped with an importance placed on an impression match with the target color while maintaining affinity in tint with a color mapped by means of existing importance-on-gradation-property mapping. Since a general importance-on-color-impression-match table for matching with the target color specifies a mapping color that minimizes a color difference according to a color-difference evaluation formula, affinity with a color mapped with an importance placed on gradation property on the basis of a convergence vector of a different rule is low. In view of this, the present embodiment discloses a method of generating an importance-on-color-impression-match table for matching with the target color on the basis of an existing color profile used in an existing general printing system.

When an importance-on-color-impression-match table is generated at the time of performing color setting for printing or at the time of performing printing, a tolerable waiting time is short and, therefore, there is a need to shorten the time taken for generating the table as much as possible.

Moreover, a reduction in an amount of calculation is also needed. To generate an importance-on-color-impression-match table, determination as to whether or not the target color is within the output color gamut is performed. An amount of calculation for the within/not-within color-gamut determination described earlier in the seventh embodiment increases as the number of grid points (the cube of the number of slices of the range of 0≤R, G, B≤255) constituting the table increases. If the number of slices is denoted as N, the color gamut of an output device includes grid points the number of which is denoted as N3. The number of hexahedrons is (N−1)³. Since each hexahedron is divided into six tetrahedrons, the number of tetrahedrons is (N−1)³×6. Since a positional relationship between the coordinates of a point (target color) and each plane of the tetrahedron is determined, the number of times of calculation of the coordinates of the point and the planes is (N−1)³×6×4.

For example, in the case of 9-slicing, the number of times of calculation is: 512×24=12,288. Furthermore, there is a need to repeat this processing plural times the number of which corresponds to the number of the target colors.

In view of this, the present embodiment takes advantage of a feature that an output color of an existing mapping table is a color mapped already into an output color gamut. Based on the presence or absence of an intersection of a vector between the target color and the existing mapping color with the surface of the output color gamut, the within/not-within color-gamut determination for the target color is performed. By this means, it is possible to reduce an amount of calculation for the within/not-within color-gamut determination needed for generating the importance-on-color-impression-match table. Specifically, the number of triangle polygon planes of the surface of the color gamut is (N−1)²×6×2.

For example, in the case of 9-slicing, the number of times of calculation of intersecting of the vector and the triangle polygon planes for one target color is: 64×12=768. Even just in the within/not-within color-gamut determination for one target color, it is possible to reduce an amount of calculation about the planes by a reduction that is in excess of ten thousand times of execution.

The hardware configuration and functional configuration of an information processing apparatus according to the present embodiment are the same as those of the first embodiment; therefore, an explanation thereof is omitted. Differences between the present embodiment and the first embodiment will be mainly described below. The same reference signs will be assigned to the same components as those of the first embodiment in the description below.

### Color Profile Generation Processing

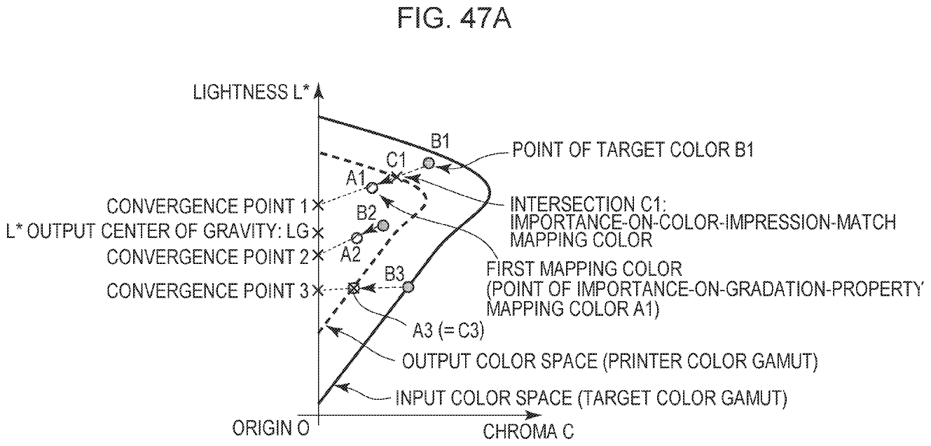

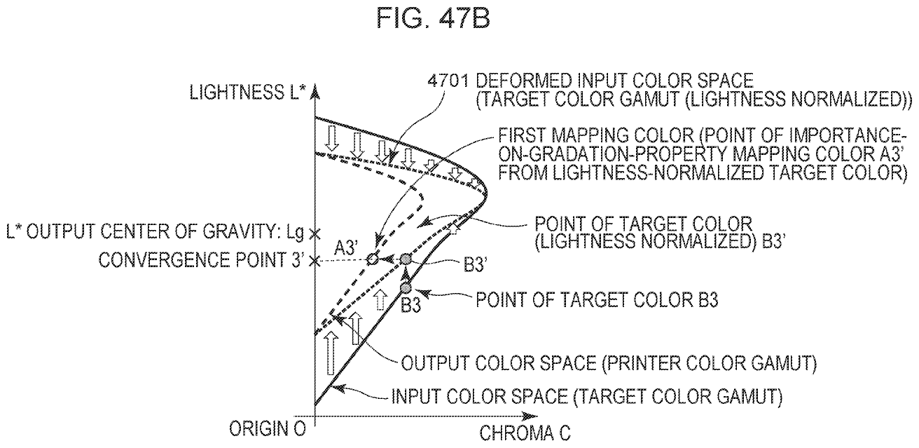

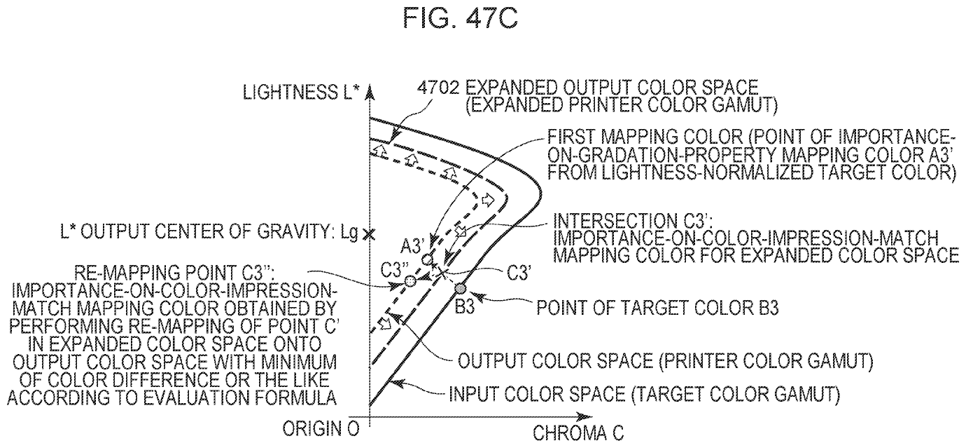

With reference to FIG. 47A, an overview of a method of generating an importance-on-color-impression-match table for matching with the target color on the basis of an existing color profile will now be presented. FIG. 47A illustrates an LC plane corresponding to a certain hue in an LCH space. The vertical axis of the graph represents lightness L*, and the horizontal axis thereof represents chroma C. For three target colors B, mapping colors A mapped using an existing first mapping table are illustrated. A vector B1A1 is a mapping vector from the outside of the printer color gamut to the inside of the printer color gamut. The vector B1A1 has an intersection with the surface of the printer color gamut. Since the intersection CI lies at the surface of the printer color gamut on the existing mapping vector B1A1, an importance is placed on an impression match with the target color thereat while maintaining affinity in tint with the existing mapping color. A vector B2A2 is a mapping vector that causes color degeneracy within the printer color gamut. The vector B2A2 does not have an intersection with the surface of the printer color gamut. When there is no intersection, the target color is a color that is reproducible within the printer color gamut, and it is possible to obtain an importance-on-color-impression-match color by not performing color degeneracy. A vector B3A3 is a mapping vector from the outside of the printer color gamut to the inside of the printer color gamut. The vector B3A3 has an intersection with the surface of the printer color gamut. However, the intersection C3 is A3, meaning that the existing first mapping color is already a color mapped with an importance placed on an impression match with the target color. As described here, by using information about the intersection of the existing mapping vector BA and the surface of the printer color gamut, it is possible to derive, at a low cost, a color that places an importance on an impression match with the target color while maintaining affinity in tint with the existing mapping color A.

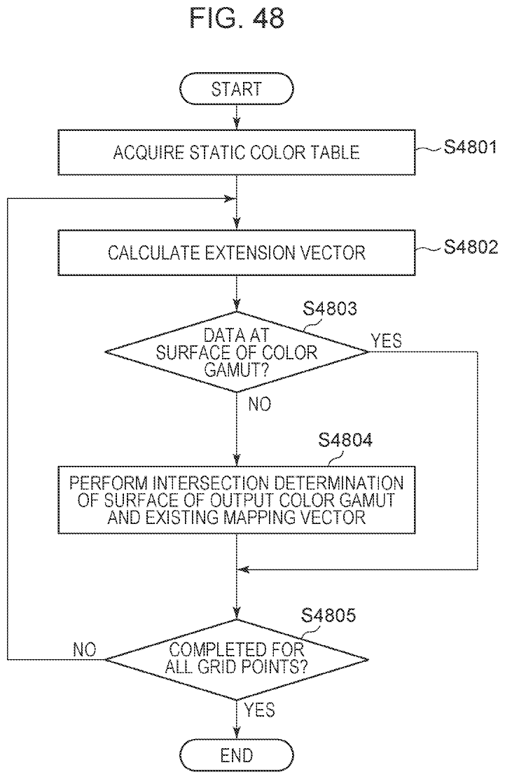

FIG. 48 is a flowchart illustrating the flow of generation processing of a 3DLUT according to the present embodiment. The processing illustrated in FIG. 48 is implemented by reading a program out of the ROM 102 into the RAM 103 and running the read program by the CPU 101. Since the processing illustrated in FIG. 48 does not require processing according to content, it may be performed either before or after job issuance according to content. For example, this processing may be performed at the time of color setting in the processing illustrated in FIG. 5 or at the time of generating an importance-on-color-impression-match color profile after job issuance according to content.

In S4801, the color profile generation unit 305 acquires, as an existing static color table, a target color table and a first mapping table. In S4802, the color profile generation unit 305 calculates a mapping vector BA connecting the target color and the first mapping color. In S4803, the color profile generation unit 305 determines whether or not a grid point of the color table acquired in S4801 corresponds to the surface of the color gamut. As described earlier in the seventh embodiment while referring to FIG. 31, a grid point corresponding to the surface of the color gamut has a value of 0 or 255 at any one of RGB. In a case where the grid point is a grid point corresponding to the surface of the color gamut, the first mapping color is set as a color mapped with an importance placed on an impression match with the target color, and the process proceeds to S4805. In a case where the grid point is not a grid point corresponding to the surface of the color gamut, the process proceeds to S4804.

In S4804, the color profile generation unit 305 performs intersection determination of the surface of the output color gamut and the existing mapping vector. For the intersection determination, intersection determination of a known straight line and a triangle polygon is used. The triangle polygon of the surface of the output color gamut is, for example, configured as follows.

The color profile is configured as a 3DLUT as described earlier with reference to FIG. 7, etc., and triangle polygons are generated by dividing a quadrangle that connects four grid points constituting its surface into two. Since the grid points illustrated in FIG. 7 are grid points in an input RGB space, to determine the presence or absence of an intersection with a triangle polygon in the output color gamut, conversion into an output color space is performed by using a color profile of the first mapping table, etc., and the intersection determination is performed by using triangle polygon coordinates in the output color space.

In a case where there is an intersection with any of the triangle polygons that constitute the surface of the output color gamut, the coordinates of the intersection are set as a color that places an importance on an impression match with the target color. If no intersection is found, the target color lies within the output color gamut and is thus reproducible; therefore, in this case, the target color itself is set as a color that places an importance on an impression match with the target color.

In S4805, the color profile generation unit 305 determines whether or not a color that places an importance on an impression match with the target color while maintaining affinity in tint with the existing mapping color A has been calculated for all of the grid points. If the processing has not been completed yet for all of the grid points, the process returns to S4802. The process ends if the processing has been completed for all of the grid points.

As explained above, an information processing apparatus according to the present embodiment generates, at a high speed, a table that places an importance on an impression match with the target color on the basis of an existing color profile. By this means, also when color setting for printing is performed or when printing is performed, it is possible to generate, at a high speed, a mapping table that places an importance on an impression match with the target color while maintaining affinity in tint with the mapping color of the existing mapping table.

### Variation Example

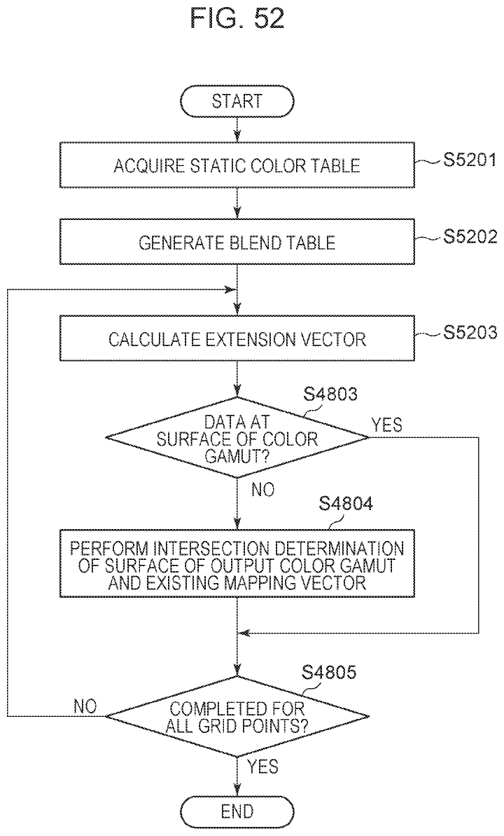

When the method described above is used, a color impression match with the target color could be sometimes insufficient because data at the surface of the color gamut cannot be changed from the color of an existing mapping table. For a solution, in this variation example, the eighth embodiment is combined with the tenth embodiment. As explained earlier in the eighth embodiment, color matching has been improved in advance with inclusion of data at the surface of the color gamut by blending the existing color with an importance placed on a match with the target color (colorimetric table) with the perceptual table together. An importance-on-color-impression-match table for matching with the target color is generated for this blend table. FIG. 52 is a flowchart illustrating the flow of generation processing of a 3DLUT according to this variation example. The processing illustrated in FIG. 52 is implemented by reading a program out of the ROM 102 into the RAM 103 and running the read program by the CPU 101. Since the processing in S4803 to S4805 is the same as that of the foregoing description, an explanation thereof is omitted.

In S5201, the color profile generation unit 305 acquires, as an existing static color table, a target color table, a first mapping table, and a second mapping table. In S5202, the color profile generation unit 305 generates a blend table by blending the first mapping table and the second mapping table in accordance with a predetermined blend amount. In S5203, the color profile generation unit 305 calculates a mapping vector BA′ connecting the target color B and a blend table mapping color A′.

Through the above processing, an information processing apparatus according to this variation example is capable of generating a mapping table that places an importance on an impression match with the target color on the basis of the colors of an existing mapping table even for data at the surface of the color gamut.

### Variation Example

This variation example is another variation example for addressing an issue that a color impression match with the target color could be sometimes insufficient because data at the surface of the color gamut cannot be changed from the color of an existing mapping table. Described in this variation example is a method of performing re-mapping onto a further importance-on-color-impression-match color for data at the surface of the color gamut.

FIGS. 47B and 47C illustrate an LC plane corresponding to a certain hue in an LCH space. The vertical axis of the graph represents lightness L*, and the horizontal axis thereof represents chroma C. FIG. 47B illustrates that a deformed input color space 4701 is generated by deforming an input color space through normalization in accordance with a dynamic range of the lightness L* of an output color space, and then mapping into the output color space is performed. The target color B moves to a target color B′ due to the deformation of the color space, and is mapped into an output color space A3′. In a case where mapping is performed with deformation of an input color space as in this example, even a color mapped onto the surface of the color gamut could have an insufficient color impression match with the original target color B.

In view of this, in this variation example, as illustrated in FIG. 47C, an expanded output color space 4702 is generated by expanding the output color space, and a color that places an importance on an impression match with the target color is derived in the expanded output color space 4702. After that, re-mapping into the output color space is performed. When this is performed, the target color B is re-mapped onto an importance-on-color-impression-match color C″ in the output color space by way of an importance-on-color-impression-match color C′ in the expanded output color space 4702.

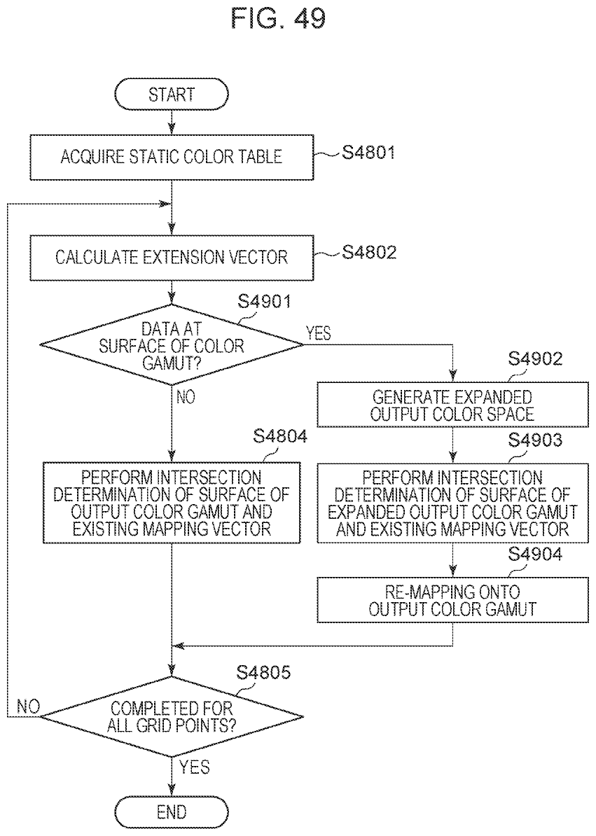

FIG. 49 is a flowchart illustrating the flow of generation processing of a 3DLUT according to this variation example. The processing illustrated in FIG. 49 is implemented by reading a program out of the ROM 102 into the RAM 103 and running the read program by the CPU 101. Since the processing in S4801, S4802, S4804, and S4805 is the same as that of the foregoing description, an explanation thereof is omitted. In S4901, the color profile generation unit 305 determines whether or not a grid point of the color table acquired in S4801 corresponds to the surface of the color gamut. As described earlier in the seventh embodiment while referring to FIG. 31, a grid point corresponding to the surface of the color gamut has a value of 0 or 255 at any one of RGB. In a case where the grid point is a grid point corresponding to the surface of the color gamut, the process proceeds to S4902. In a case where the grid point is not a grid point corresponding to the surface of the color gamut, the process proceeds to S4804.

In S4902, the color profile generation unit 305 generates the expanded output color space 4702 by expanding the output color space. For example, the expanded output color space 4702 is generated by deriving L* output center of gravity Lg on the basis of an average of the lightness L* of white and black of the output color space and then expanding the color at the surface to the outside of the color gamut by a pre-specified gain for an expansion vector going from the output center of gravity Lg to the mapping color at the surface of the output color space. In S4903, the color profile generation unit 305 performs intersection determination of the surface of the expanded output color gamut and the existing mapping vector. For the intersection determination, intersection determination of a known straight line and a triangle polygon is used. In a case where there is an intersection with any of the triangle polygons that constitute the surface of the output color gamut, the coordinates of the intersection are set as a color that places an importance on an impression match with the target color. If no intersection is found, the target color lies within the expanded output color gamut and is thus reproducible; therefore, in this case, the target color itself is set as a color that places an importance on an impression match with the target color.

In S4904, for the color derived with an importance placed on an impression match with the target color in the expanded output color gamut in S4903, the color profile generation unit 305 performs re-mapping into the output color gamut. Specifically, the color profile generation unit 305 performs re-mapping by using a known color-difference evaluation formula, the color-difference evaluation formula described earlier in the seventh embodiment, or the like. As explained above, an information processing apparatus according to this variation example is capable of generating a mapping table that places an importance on an impression match with the target color on the basis of the colors of an existing mapping table even for data at the surface of the color gamut.

Color-gamut expansion processing and re-mapping processing normally involve long processing time because the number of times of looping is large, although the data processed is data at the surface of the color gamut only. In view of this, for the data at the surface of the color gamut only, as explained earlier in the eighth embodiment, color matching may be improved by blending the existing color with an importance placed on a match with the target color (colorimetric table) with the perceptual table together. In this case, according to the importance-on-color-impression-match table generated in this variation example, re-mapping onto C″ is performed by using the color-difference evaluation formula for the data at the surface of the color gamut only. For this reason, it could happen that C″ does not exist on the mapping vector BA connecting the target color and the first mapping color. For example, in a case where the dynamic extension LUT according to the third embodiment or the fifth embodiment is generated by using the importance-on-color-impression-match table generated in this variation example, there is a need to perform processing for vector alignment as in the fourth embodiment for the data at the surface of the color gamut only.

In the tenth embodiment, the target color B is taken as the color with which an impression match is wanted, and the extension of the first mapping color A toward the target color B is performed. However, depending on an intended use, a relative color corresponding to paper may be set as the target, and the first mapping color A may be extended toward it. In this case, for example, the first mapping color A is extended toward a deformed target color B′ of the deformed input color space 4701 generated by deforming the input color space through normalization in accordance with the dynamic range of the lightness L* of the output color space. That is, the color profile generation unit 305 calculates a mapping vector B′A connecting the deformed target color B′ and the first mapping color A.

### Eleventh Embodiment

The color profile generation unit 305 according to the third to fifth embodiments determines the dynamic extension rate on the basis of the static extension rate used according to the content, and generates the extension LUT. However, as described earlier, the size, shape, white point, and black point of a printer color gamut change in various ways depending on the color material used and the medium used. For this reason, if the dynamic extension rate is determined on the basis of the static extension rate, when an importance is placed on an impression match with the target color, color loss (overexposure/blown-out highlights, underexposure/blocked-up shadows, and the like) that is not tolerable could happen at a portion where there is a large size difference between the input color gamut and the output color gamut.

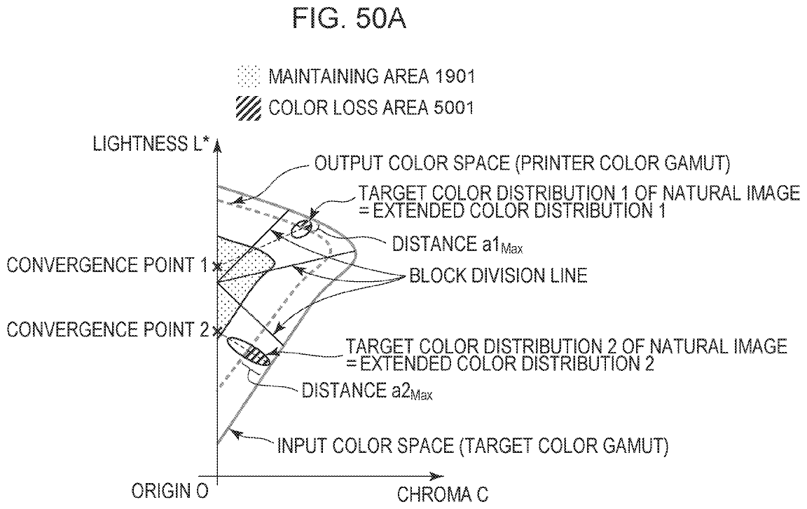

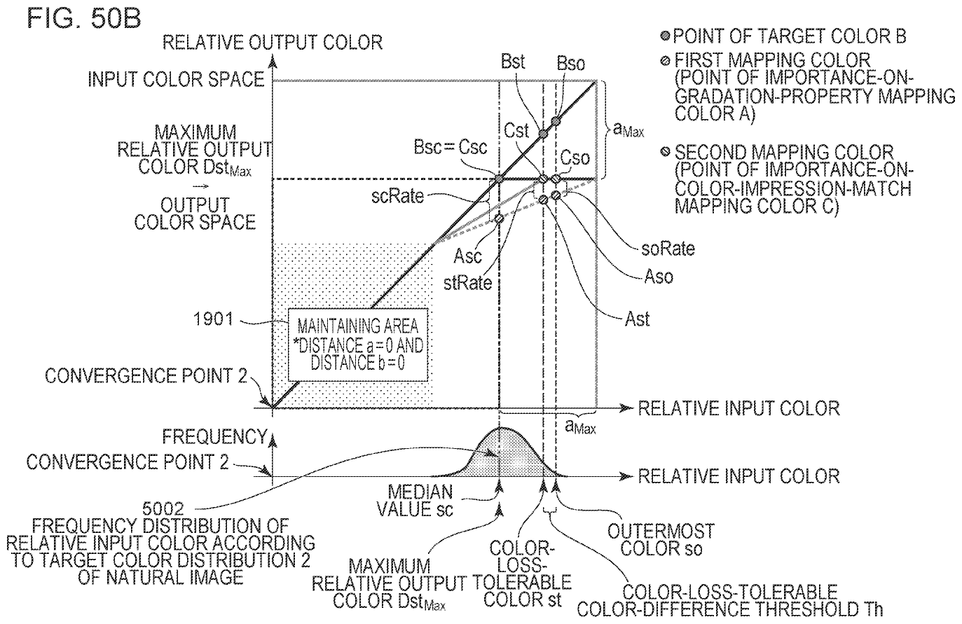

FIG. 50A illustrates an example of a case where dynamic extension is performed until a target color distribution of a natural image and an extended color distribution with extension of a non-illustrated importance-on-gradation-property color become equal to each other. FIG. 50A illustrates an LC plane corresponding to a certain hue in an LCH space. The vertical axis of the graph represents lightness L*, and the horizontal axis thereof represents chroma C. In this example, since the non-illustrated importance-on-gradation-property color is extended to the target color distribution, the color of a hatched area (color loss area 5001) outside the output color space is lost. In the example illustrated in FIG. 50A, though a target color distribution 1 and a target color distribution 2 of a natural image lie at different block areas, with a block division line extending therebetween, it is assumed that dynamic extension rates of the respective blocks are at the same rate. That is, it can be seen therefrom that, even with the same dynamic extension rate, the size of the color loss area 5001 in the target color distribution 1 of the natural image is significantly different from that in the target color distribution 2 thereof because the maximum size difference between the input color gamut and the output color gamut of each block differs between a distance a1_{MAX} and a distance a2_{MAX}.

In view of this, in the present embodiment, by using the maximum size difference between the input color gamut and the output color gamut and by using parameters regarding tolerable color loss, the determination of the dynamic extension rate with an importance placed on an impression match with the target color is performed under conditions in which color loss is tolerated within a pre-specified range. The hardware configuration and functional configuration of an information processing apparatus according to the present embodiment are the same as those of the first embodiment; therefore, an explanation thereof is omitted. Differences between the present embodiment and the first embodiment will be mainly described below. The same reference signs will be assigned to the same components as those of the first embodiment in the description below.

### Color Profile Generation Processing

With reference to FIG. 50B, an overview of a method of generating the importance-on-color-impression-match table according to the present embodiment will now be presented. FIG. 50B illustrates, for the target color distribution 2 of the natural image illustrated in FIG. 50A, colors on a mapping vector that goes through a convergence point 2 indicating a mapping direction of mapping from the target color to the non-illustrated importance-on-gradation-property mapping color. First, the upper part of FIG. 50B will now be described in detail. The upper part of FIG. 50B illustrates correspondences between relative input color (horizontal axis) and relative output color (vertical axis) with the convergence point 2 taken as the reference (origin). Mapping can be performed with the highest degree of matching with the target color, which means an ideal state, in a case where the relative output color is mapped such that the relative input color (target color) and the relative output color become equal to each other. In a case where the output color space is smaller than the input color space as in this example, there exist input colors that cannot be reproduced in the output color space. The maximum relative output color that can be reproduced in the output color space is denoted as relative maximum output color Dst_{Max} here. Relative input colors that are in excess of the relative maximum output color Dst_{Max} and thus cannot be reproduced in the output color space are clipped, with the relative maximum output color Dst_{Max} serving as the upper-limit color, before a final output from the output device.

The sign a_{MAX} denotes the maximum color difference between the relative input colors and the relative output colors, indicating the maximum input/output gamut difference.

The point A of the relative output color on the graph represents the first mapping color (importance-on-gradation-property mapping color). In the importance-on-gradation-property mapping, the relative output color is mapped in such a way as to reproduce the relative input color up to the relative input color of the maintaining area 1901, whereas, for the relative input color that is greater than the maintaining area 1901, mapping onto the point A is performed to have gradation property up to the maximum relative output color so as to avoid color loss from occurring. The point B of the relative output color represents the target color and represents a case where the relative output color is mapped such that the relative input color (target color) and the relative output color are equal to each other. The point C of the relative output color represents the second mapping color (importance-on-color-impression-match mapping color). In the importance-on-color-impression-match mapping, the relative output color is mapped in such a way as to reproduce the relative input color up to the relative input color that is equal to the relative maximum output color Dst_{Max} that is reproducible in the output color space. Relative input colors that are in excess of the relative maximum output color Dst_{Max} are clipped, with the relative maximum output color Dst_{Max} serving as the upper-limit color.

Next, the lower part of FIG. 50B will now be described in detail. The lower part of FIG. 50B illustrates a frequency distribution 5002 of the relative input color (target color) according to the target color distribution 2 of the natural image with the convergence point 2 taken as the reference. In the frequency distribution 5002 of the relative input color, so denotes an outermost color, sc denotes a median-value color, and st denotes a color-loss-tolerable color where color loss is tolerable from the outermost color so; and each of them is an example of extension-rate control point. In this example, the color sc of the median value is equal to the relative maximum output color Dst_{Max} that is reproducible in the output color space. The frequency distribution 5002 of the relative input color illustrated in the lower part of FIG. 50B is a conceptual diagram for making it easier to understand the present embodiment. Since the gamut size and the convergence point differ depending on the position of the color gamut, if the relative input color is calculated on the basis of the convergence point to obtain the frequency distribution, complex processing will be used. In view of this, actually, as described earlier in the third embodiment with reference to FIG. 16, the frequency distribution of rate information (static extension rate) is used. For example, in the frequency distribution of the static extension rate illustrated in FIG. 16, the minimum value of the static extension rate corresponds to the outermost color so of the relative input color of the natural image.

The minimum value of the static extension rate in FIG. 50B is a rate soRate, where an extension vector AsoBso is a unit vector, as expressed by the formula (36).

$$soRate ‖ AsoCso ‖ / ‖ AsoBso ‖ \qquad ( 36 )$$

Based on an importance-on-gradation-property mapping color Aso of the outermost color so, it is possible to calculate a color Cso that places an importance on an impression match with the target color through extension calculation in accordance with the following formula (37) within a range of being reproducible in the output color space.

$$\vec{Cso} = \vec{Aso} + soRate \times \vec{AsoBso} \qquad ( 37 )$$

In the frequency distribution of the static extension rate illustrated in FIG. 16, the median value of the static extension rate corresponds to the median-value color sc of the relative input color of the natural image. The median value of the static extension rate in FIG. 50B is a rate scRate, where an extension vector AscBsc is a unit vector, as expressed by the formula (38). In FIG. 50B, since Bsc coincides with Csc, scRate=1.0.

$$scRate ‖ AscCsc ‖ / ‖ AscBsc ‖ \qquad ( 38 )$$

Based on an importance-on-gradation-property mapping color Asc of the median-value color sc, it is possible to calculate a color Csc that places an importance on an impression match with the target color through extension calculation in accordance with the following formula (39) within a range of being reproducible in the output color space.

$$\vec{Csc} = \vec{Asc} + scRate \times \vec{AscBsc} \qquad ( 39 )$$

Next, the color-loss-tolerable color st where color loss is tolerable from the outermost color so will now be described. In the conceptual diagram illustrated in the lower part of FIG. 50B, the color-loss-tolerable color st is a color shifted from the outermost color so to be closer to the convergence point 2 by an amount corresponding to a pre-specified color-loss-tolerable color-difference threshold Th. Since, actually, the control is performed by using the rate information as described above, there is a need to normalize the color-loss-tolerable color-difference threshold Th defined in terms of magnitude and thereby replace it with the rate information (static extension rate). The state of a static extension rate of 100% placing the greatest importance on a color impression match with the target color is the maximum value of color loss, and the amount of the color loss is the maximum input/output gamut difference a_{MAX}.

Therefore, as expressed by the following formula (40), rate information Rate_{CLossT} is calculated by normalizing the color-loss-tolerable color-difference threshold Th by using the maximum input/output gamut difference a_{MAX}.

$${Rate}_{CLossT} = Th / {a}_{MAX} ( 0. \leq {Rate}_{CLossT} \leq 1. ) \qquad ( 40 )$$

For example, when the maximum input/output gamut difference a_{MAX} is 10 and the color-loss-tolerable color-difference threshold Th is 1, the rate information Rate_{CLossT} is 0.1. In a case where a_{MAX}=0, as an exception, Rate_{CLossT}=0.0 because of zero division of the formula (40). By this means, in accordance with the following formula (41), it is possible to calculate an extension rate stRate for extension from an importance-on-gradation-property mapping color Ast to an importance-on-impression-match mapping color Cst for matching with the target color at the color-loss-tolerable color st when an extension vector AstBst is a unit vector.

$$stRate = soRate + {Rate}_{CLossT} = soRate + Th / {a}_{MAX} ( 0. \leq {st Rate}_{CLossT} \leq 1. ) \qquad ( 41 )$$

Note that, in a case where the output color gamut>the input color gamut, the input color is reproducible, and no color loss due to extension occurs. Since the extension rate soRate of the outermost color so of the image is 1.0, stRate=1.0 because of clipping no matter which value Rate_{CLossT} may be. Therefore, based on an importance-on-gradation-property mapping color Ast of the color-loss-tolerable color st, it is possible to calculate a color Cst that places an importance on an impression match with the target color through extension calculation in accordance with the following formula (42) within a range of being reproducible in the output color space.

$$\vec{Cst} = \vec{Ast} + stRate \times \vec{AstBst} \qquad ( 42 )$$

Then, the extension rate soRate at the median-value color sc or the extension rate stRate at the color-loss-tolerable color st, whichever is less, is adopted as the dynamic extension rate.

$$dynamic extension rate = \{ \begin{matrix}scRate & scRate < stRate \\ stRate & scRate \geq stRate\end{matrix} \qquad ( 43 )$$

By this means, it is possible to enhance the effect of a color impression match within a range of not causing intolerable color loss. Moreover, since the specified tolerable range of color loss is not exceeded depending on the color distribution and/or the input/output gamut difference of a natural image, it is possible to enhance the color-match effect by extension to the importance-on-color-impression-match color for the median-value color of the natural image.

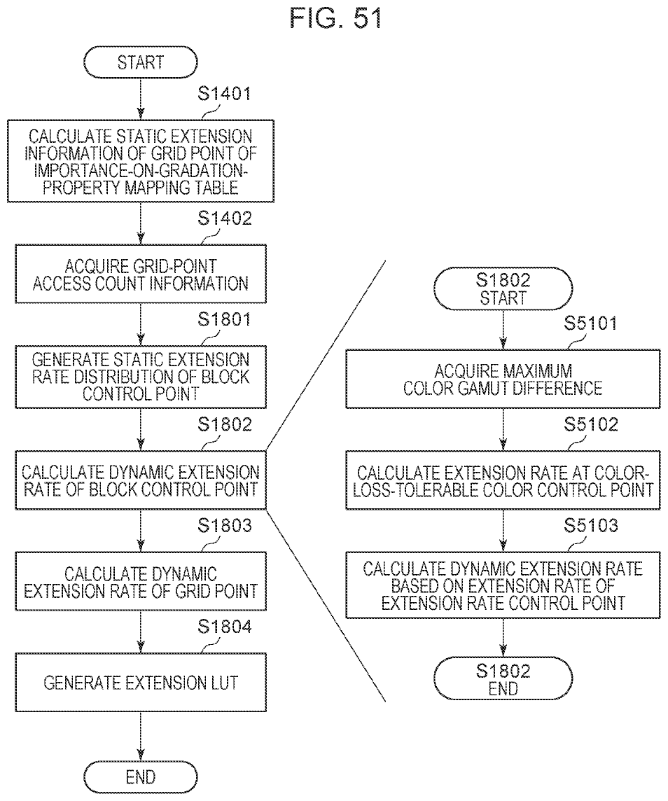

FIG. 51 is a flowchart illustrating the flow of generation processing of a 3DLUT according to the present embodiment. The processing illustrated in FIG. 51 is implemented by reading a program out of the ROM 102 into the RAM 103 and running the read program by the CPU 101. Since the processing in S1401 and S1402 is the same as that of the third embodiment, an explanation thereof is omitted. Since the processing in S1801 to S1804 is the same as that of the fifth embodiment, an explanation thereof is omitted. In the present embodiment, in the processing for calculating the dynamic extension rate at the block control points in S1802, processing in S5101 to S5103 is performed, unlike the foregoing content of the fifth embodiment.

In S5101, in order to obtain the rate information by normalizing the color-loss-tolerable color-difference threshold Th, the color profile generation unit 305 acquires the maximum value of the input/output gamut difference on a block-area-by-block-area basis.

It is assumed that different values of the color-loss-tolerable color-difference threshold Th for the respective block areas can be stored.

In S5102, the color profile generation unit 305 calculates, in accordance with the formula (41), the extension rate stRate for extension from the importance-on-gradation-property mapping color Ast to the importance-on-impression-match mapping color Cst for matching with the target color Bst at the color-loss-tolerable color st. In S5103, the color profile generation unit 305 determines the dynamic extension rate for the extension rate scRate and the extension rate stRate at extension rate control points of the median-value color sc and the color-loss-tolerable color st in accordance with the formula (43). After that, the processing in S1803 and S1804 described above is performed. Through the processing described above, by using the maximum size difference between the input color gamut and the output color gamut and by using parameters regarding tolerable color loss, the importance-on-color-impression-match table for matching with the target color is generated under conditions in which color loss is tolerated within the pre-specified range.

### Variation Example

In the example illustrated in FIG. 50B, at the interval from the extension-rate control point st to the extension-rate control point so, the dynamic extension rate is a rate at which a color loss occurs completely. However, the control may be performed such that, since there is a plurality of extension-rate control points, there is a slight change although the color loss is to a tolerable degree. For example, the extension rate may be suppressed by multiplying the extension rate scRate or the extension rate stRate by a pre-specified extension suppression gain Gr at the extension-rate control point sc or the extension-rate control point st. Then, the extension rate may be raised from the extension-rate control point sc or the extension-rate control point st toward the outermost extension-rate control point so in order to achieve the maximum output color in the output color space.

For example, let sxRate be the static extension rate of an input color x, and let Rate_{CLossDy} be a dynamic extension rate at which a color loss occurs completely in accordance with the formula (43) at the interval from the extension-rate control point sc or the extension-rate control point st to the outermost extension-rate control point so. When this definition is given, it is possible to calculate a dynamic extension rate at which a color loss does not occur completely in accordance with the formula (44). Though the dynamic extension rate between the extension-rate control points is constant or changes linearly in the formula (44), this does not imply any limitation; it may be non-linear.

$$Dynamic extension rate = \{ \begin{matrix}{Rate}_{CLossDy} \times Gr & sxRate > {Rate}_{CLossDy} \\ {Rate}_{CLossDy} \times Gr + ( 1. - {Rate}_{CLossDy} \times Gr ) \times & sxRate ≦ {Rate}_{CLossDy} \\ ( \frac{sxRate - soRate}{{Rate}_{ClossDy} - soRate} ) & \end{matrix} \qquad ( 44 )$$

Through the processing described above, an information processing apparatus according to this variation example is capable of generating an importance-on-color-impression-match table for matching with the target color while leaving a slight gradation change by controlling a dynamic extension rate by using a plurality of extension-rate control points.

### OTHER EMBODIMENTS

In the foregoing embodiments, a printing system that performs processing with an importance placed on an impression match in colors among a plurality of printers has been disclosed; however, processing in each embodiment can be used as processing for explaining a desired color on a single printer (output device).

In the foregoing embodiments, an electrophotographic printer is taken as an example of an output device. However, the output device is not limited to a printer. For example, the output device may be a display, a projector, or the like.

In the foregoing embodiments, an LUT is used as a color profile. However, it may be in any other format such as a matrix or a function.

With the disclosed technique, it is possible to express a desired color by using an output device.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors, circuitry, or combinations thereof (e.g., central processing unit (CPU), micro processing unit (MPU), or the like), and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-061725, filed Apr. 5, 2023, and Japanese Patent Application No. 2023-146163, filed Sep. 8, 2023, which are hereby incorporated by reference herein in their entirety.

What is claimed is:

1. An information processing apparatus, comprising:
one or more processors; and
one or more memories storing instructions executable by the one or more processors to cause the information processing apparatus to operate as:
an acquisition unit configured to acquire a first color profile for performing colorimetric color conversion, a second color profile for performing perceptual color conversion, and a parameter for increasing a distance between colors mapped through gamut mapping; and
a generation unit configured to, based on the first color profile and the second color profile and the parameter, generate a third color profile.

2. The information processing apparatus according to claim 1, wherein
the generation unit generates the third color profile by, based on the parameter, synthesizing the first color profile and the second color profile.

3. The information processing apparatus according to claim 1, the information processing apparatus being caused to further operate as:
a determination unit configured to determine whether to perform color conversion using the second color profile or to perform color conversion using the third color profile, wherein
the generation unit generates the third color profile when the determination unit determines to perform the color conversion using the third color profile.

4. The information processing apparatus according to claim 3, wherein
the generation unit does not generate the third color profile when the determination unit determines to perform the color conversion using the second color profile.

5. The information processing apparatus according to claim 3, wherein
based on gradation property of an input image, the determination unit determines whether to perform the color conversion using the second color profile or to perform the color conversion using the third color profile.

6. The information processing apparatus according to claim 1, wherein
the parameter is set based on a color difference between colors obtained by performing colorimetric gamut mapping on colors of an input image.

7. The information processing apparatus according to claim 1, wherein
based on the parameter at each of areas obtained by dividing a color space in a hue direction, the generation unit generates the third color profile.

8. The information processing apparatus according to claim 1, wherein
the third color profile is a color profile for converting color information in a first color space into color information in a second color space, and
the generation unit adds the third color profile and a fourth color profile to data of an input image, where the fourth color profile is a color profile for converting color information in a third color space of the input image into the color information in the first color space.

9. The information processing apparatus according to claim 8, wherein
the first color space is an RGB color space, the second color space is an L*a*b* color space, and the third color space is a CMYK color space.

10. The information processing apparatus according to claim 1, the information processing apparatus being caused to further operate as:
a setting unit configured to set whether to output white in an input image by using a color obtained by simulating white designated by a user or to output the white in the input image by using white of a print medium, wherein
based on settings made by the setting unit, the generation unit generates the third color profile.

11. The information processing apparatus according to claim 1, wherein
based on an object in an input image or attribute information of each pixel, the generation unit generates the third color profile.

12. The information processing apparatus according to claim 1, wherein
the generation unit generates the third color profile for each object in an input image.

13. The information processing apparatus according to claim 12, wherein
the generation unit generates the third color profile such that the third color profile generated for an image object in the input image is different from the third color profile generated for a text/graphics object in the input image.

14. The information processing apparatus according to claim 12, wherein
the generation unit groups a plurality objects in the input image into one object group and generates the third color profile for the object group.

15. An information processing method, comprising:
acquiring a first color profile for performing colorimetric color conversion, a second color profile for performing perceptual color conversion, and a parameter for increasing a distance between colors mapped through gamut mapping; and
generating, based on the first color profile and the second color profile and the parameter, a third color profile.

16. A non-transitory computer-readable storage medium storing instructions that, when executed by a computer, cause the computer to perform an information processing method, the information processing method comprising:
acquiring a first color profile for performing colorimetric color conversion, a second color profile for performing perceptual color conversion, and a parameter for increasing a distance between colors mapped through gamut mapping; and
generating, based on the first color profile and the second color profile and the parameter, a third color profile.
